(19) United States
(12) Patent Application Publication
(10) Pub. No.: US 2024/0356675 A1
(43) Pub. Date: Oct. 24, 2024

(54) TRANSMISSION METHOD, COMMUNICATION DEVICE AND STORAGE MEDIUM

(71) Applicant: SHENZHEN TRANSSION HOLDINGS CO., LTD., Guangdong (CN)

(72) Inventors: Rongchang ZHU, Guangdong (CN); Wei HUANG, Guangdong (CN); Junwei HUANG, Guangdong (CN)

(73) Assignee: SHENZHEN TRANSSION HOLDINGS CO., LTD., Guangdong (CN)

(21) Appl. No.: 18/749,661

(22) Filed: Jun. 21, 2024

Related U.S. Application Data
(63) Continuation of application No. PCT/CN2021/140635, filed on Dec. 22, 2021.

(51) Int. Cl. H04L 1/08; H04W 72/044; H04W 72/232

(52) U.S. Cl. CPC H04L 1/08; H04W 72/044; H04W 72/232

(57) ABSTRACT

The present application provides a transmission method, a communication device, and a storage medium. The method includes: determining a transmission mode of a transport block; and receiving or transmitting the transport block on carrier according to the transmission mode. When the number of carriers is one, the transport block can be received or transmitted on the carrier in a complete transmission mode; when the number of carriers is at least two, and at least two carriers are carriers in the same logical cell, the transmission of the transport block on the carrier can be achieved by receiving or transmitting the transport block with different or the same redundancy versions on the carriers in a complete transmission mode or a distributed transmission mode

### CROSS-REFERENCE TO RELATED APPLICATION

This application is a continuation of International Application No. PCT/CN2021/140635, filed on Dec. 22, 2021. The disclosure of the aforementioned application is hereby incorporated by reference in its entirety.

### TECHNICAL FIELD

The present application relates to communication technology and, in particular, to a transmission method, a communication device and a storage medium.

### BACKGROUND

In some implementations, a network device may transmit a transport block (TB) to a terminal device by sending a physical downlink shared channel (PDSCH) on carrier, or, the terminal device may transmit a physical uplink shared channel (PUSCH) on the carrier.

In the conception and realization of the present application, the inventors have found at least the following problems: since the solution of transmitting the transport block through the PDSCH or the PUSCH is implemented based on one carrier of one cell, for a scenario where at least one carrier constitutes one logical cell, there is no specific solution as to how a network device or terminal device performs transmission and/or reception in this scenario.

The foregoing description is provided for general background information and does not necessarily constitute prior art.

### SUMMARY

The present application provides a transmission method, a communication device, and a storage medium to solve the above-mentioned technical problem.

In a first aspect, the present application provides a transmission method applicable to a terminal device, the method including the following steps:
S1: determining a transmission mode of a transport block;
S2: transmitting the transport block on carrier according to the transmission mode.

In a possible implementation, the S1 step includes:
determining the transmission mode in response to the carrier satisfying a preset condition.

In a possible implementation, the preset condition includes:
the number of carriers being at least two; and/or,
carriers being carries in the same logical cell.

In a possible implementation, the S2 step includes:
determining a redundancy version of the transport block for transmission on at least one of the carriers; and
transmitting the transport block on the carriers according to the redundancy version, the transmission mode and/or the number of consecutive retransmissions of the transport block.

In a possible implementation, the determining a redundancy version of the transport block for transmission on at least one of the carriers includes:
acquiring a redundancy version identifier of a first carrier of the at least one of the carriers, and determining the redundancy version for transmission on the at least one of the carriers according to the redundancy version identifier of the first carrier, the number of consecutive retransmissions and the transmission mode; and/or,
acquiring a redundancy version identifier of the at least one of the carriers, and determining the redundancy version for transmission on the at least one of the carriers according to the redundancy version identifier of the at least one of the carriers.

In a possible implementation, the acquiring a redundancy version identifier of a first carrier of the at least one of the carriers includes: receiving first downlink resource control information on the first carrier, and acquiring the redundancy version identifier of the first carrier according to the first downlink resource control information; and/or,
acquiring a redundancy version identifier of the at least one of the carriers includes: receiving second downlink resource control information on the at least one of the carriers, and acquiring the redundancy version identifier of the at least one of the carriers according to the second downlink resource control information.

In a possible implementation, for any transmission slot, the redundancy version satisfies at least one of:
the transmission mode being a complete transmission mode, the number of consecutive retransmissions being 1, and redundancy versions of the transport block for transmission on the at least one of the carriers being different;
the transmission mode being the complete transmission mode, the number of consecutive retransmissions being 1, and the redundancy versions of the transport block for transmission on the at least one of the carriers being the same;
the transmission mode being the complete transmission mode, the number of consecutive retransmissions being greater than 1, and the redundancy versions of the transport block for transmission on the at least one of the carriers being different; and
the transmission mode being a distributed transmission mode, and the redundancy versions of the transport block for transmission on the at least one of the carriers being the same.

In a possible implementation, the transmission mode is the complete transmission mode, the number of consecutive retransmissions is 1, and the redundancy version of the transport block for transmission on the at least one of the carriers satisfies a first preset condition.

In a possible implementation, the first preset condition includes at least one of:
rv_{id}=0, if n mod 4=0, then rv1 is 0; if n mod 4=1, then the rv1 is 2; if n mod 4=2, then the rv1 is 3, and if n mod 4=3, then the rv1 is 1;
rv_{id}=2, if n mod 4=0, then the rv1 is 2; if n mod 4=1, then the rv1 is 3; if n mod 4=2, then the rv1 is 1, and if n mod 4=3, then the rv1 is 0;
rv_{id}=3, if n mod 4=0, then the rv1 is 3; if n mod 4=1, then the rv1 is 1; if n mod 4=2, then the rv1 is 0, and if n mod 4=3, then the rv1 is 2; and
rv_{id}=1, if n mod 4=0, then the rv1 is 1; if n mod 4=1, then the rv1 is 0; if n mod 4=2, then the rv1 is 2, and if n mod 4=3, then the rv1 is 3;
where rv_{id} is a redundancy version identifier of a first carrier of the at least one of the carriers, mod is a modulo operation, n is an integer greater than or equal to 0 and less than or equal to N−1, N is the number of the carriers, and rv1 is a redundancy version of the transport block for transmission on carrier n.

In a possible implementation, the first preset condition may also be that redundancy versions for transmission on the at least one of the carriers are the same.

In a possible implementation, transmitting the transport block on the carriers according to the redundancy version, the transmission mode and/or the number of consecutive retransmissions of the transport block includes:
transmitting the transport block on each carrier according to the redundancy version of the transport block for transmission on the at least one of the carriers.

In a possible implementation, the transmission mode is the complete transmission mode, the number of consecutive retransmissions K is greater than 1, and the number of the carriers N is greater than or equal to K; the redundancy version of the transport block for transmission on the at least one of the carriers satisfies a second preset condition.

In a possible implementation, the second preset condition includes at least one of
rv_{id}=0, if (n mod K) mod 4=0, then rv2 is 0; if (n mod K) mod 4=1, then rv2 is 2; if (n mod K) mod 4=2, then the rv2 is 3, and (n mod K) mod 4=3, then the rv2 is 1;
rv_{id}=2, if (n mod K) mod 4=0, then the rv2 is 2; if (n mod K) mod 4=1, then rv2 is 3; if (n mod K) mod 4=2, then the rv2 is 1, and if (n mod K) mod 4=3, then the rv2 is 0;
rv_{id}=3, if (n mod K) mod 4=0, then the rv2 is 3; if (n mod K) mod 4=1, then rv2 is 1; if (n mod K) mod 4=2, then the rv2 is 0, and if (n mod K) mod 4=3, then the rv2 is 2; and
rv_{id}=1, if (n mod K) mod 4=0, then the rv2 is 1; if (n mod K) mod 4=1, then rv2 is 0; if (n mod K) mod 4=2, then the rv2 is 2, and if (n mod K) mod 4, then the rv2 is 3;
where rv_{id} is a redundancy version identifier of a first carrier of the at least one of the carriers, mod is a modulo operation, and rv2 is a redundancy version of the transport block for transmission on carrier n;
n is an integer greater than or equal to 0 and less than or equal to N−1, or n is an integer greater than or equal to 0 and less than or equal to K−1.

In a possible implementation, transmitting the transport block on the carriers according to the redundancy version, the transmission mode and/or the number of consecutive retransmissions of the transport block includes:
transmitting the transport block on first K carriers according to redundancy versions of the transport block for transmission on the first K carriers; or,
transmitting the transport block on the N carriers according to redundancy versions of the transport block for transmission on the N carriers.

In a possible implementation, the transmission mode is the complete transmission mode, the number of consecutive retransmissions K is greater than 1, the number of the carriers N is less than K, and the redundancy version of the transport block for transmission on the at least one of the carriers and a transmission slot i satisfy a third preset condition.

In a possible implementation, the third preset condition includes at least one of.
rv_{id}=0, if (n+i*N) mod 4=0, then rv3 is 0; if (n+i*N) mod 4=1, then the rv3 is 2; if (n+i*N) mod 4=2, then the rv3 is 3, and (n+i*N) mod 4=3, then the rv3 is 1;
rv_{id}=2, if (n+i*N) mod 4=0, then the rv3 is 2; if (n+i*N) mod 4=1, then rv3 is 3; if (n+i*N) mod 4=2, then the rv3 is 1, and if (n+i*N) mod 4=3, then the rv3 is 0;
rv_{id}=3, if (n+i*N) mod 4=0, then rv3 is 3; if (n+i*N) mod 4=1, then the rv3 is 1; if (n+i*N) mod 4=2, then the rv3 is 0, and if (n+i*N) mod 4=3, then the rv3 is 2; and
rv_{id}=1, if (n+i*N) mod 4=0, then the rv3 is 1; if (n+i*N) mod 4=1, then rv3 is 0; if (n+i*N) mod 4=2, then the rv3 is 2, and if n (n+i*N) mod 4=3, then the rv3 is 3;
where rv_{id} is a redundancy version identifier of a first carrier of the at least one of the carriers, mod is a modulo operation, n is an integer greater than or equal to 0 and less than or equal to N−1, N is the number of the carriers, and rv3 is a redundancy version of the transport block for transmission on carrier n in a transmission slot i;
when i is greater than or equal to 0 and less than or equal to (([K/N]−1), n is an integer greater than or equal to 0 and less than or equal to N−1; when i is equal to [K/N], n is an integer greater than or equal to 0 and less than or equal to N−1, or n is an integer greater than or equal to 0 and less than or equal to (K−[K/N]*N−1), [K/N] represents a ceil of K/N, [K/N]represents a floor of K/N.

In a possible implementation, transmitting the transport block on the carriers according to the redundancy version, the transmission mode and/or the number of consecutive retransmissions of the transport block includes:
for any one of [K/N] transmission slots, transmitting the transport block on the N carriers according to the redundancy version of the transport block for transmission on the at least one of the carriers in the transmission slot; or,
for any one of first ([K/N]−1 transmission slots, transmitting the transport block on the N carriers according to the redundancy version of the transport block for transmission on the at least one of the carriers in the transmission slot; for a ([K/N])-th transmission slot, transmitting the transport block on first (K−[K/N]*N) carriers according to redundancy versions of the transport block for transmission on the first (K−[K/N]*N) carriers in the transmission slot.

In a possible implementation, the transmission mode is the distributed transmission mode; the redundancy version of the transport block for transmission on the at least one of the carriers and a transmission slot i satisfy a fourth preset condition.

In a possible implementation, the fourth preset condition includes at least one of:
rv_{id}=0, if i mod 4=0, then rv4 is 0; if i mod 4=1, then the rv4 is 2; if i mod 4=2, then the rv4 is 3, and if i mod 4=3, then the rv4 is 1;
rv_{id}=2, if i mod 4=0, then the rv4 is 2; if i mod 4=1, then the rv4 is 3; if i mod 4=2, then the rv4 is 1, and if i mod 4=3, then the rv4 is 0;
rv_{id}=3, if i mod 4=0, then the rv4 is 3; if i mod 4=1, then the rv4 is 1; if i mod 4=2, then the rv4 is 0, and if i mod 4=3, then the rv4 is 2; and
rv_{id}=1, if i mod 4=0, then the rv4 is 1; if i mod 4=1, then the rv4 is 0; if i mod 4=2, then the rv4 is 2, and if i mod 4=3, then the rv4 is 3;
where rv_{id} is a redundancy version identifier of a first carrier of the at least one of the carriers, mod is a modulo operation, i is an integer greater than or equal to 0 and less than or equal to (K−1), K is the number of consecutive retransmissions, and rv4 is a redundancy version of a transport block for transmission on the at least one of the carriers on a transmission slot i.

In a possible implementation, transmitting the transport block on the carriers according to the redundancy version, the transmission mode and/or the number of consecutive retransmissions of the transport block includes:
determining an index of a code block group for transmission on the at least one of the carriers according to the number of code block groups included in the transport block and the number of the carriers;
for any one of K transmission slots, transmitting at least one code block group of the transport block on the at least one of the carriers according to the redundancy version of the transport block for transmission on the at least one of the carriers and the index of the code block group.

In a possible implementation, the number of code block groups included in the transport block is a smaller one of a real number of code blocks in the transport block and a maximum number of code block groups in the transport block permitted by a protocol.

In a possible implementation, the index of the code block group for transmission on the at least one of the carriers satisfies a fifth preset condition.

In a possible implementation, the fifth preset condition includes at least one of:
when M is greater than N, n∈{0, 1, . . . , T₁−1}, an index of a code block group for transmission on carrier n is (n*N₁+k₁), k₁=0, 1, . . . , N₁−1; when n∈{T₁, T₁+1, . . . , N−1}, an index of a code block group for transmission on carrier n is (T₁*N₁+(n−T₁)N₂+k₂), k₂=0, 1, . . . , N₂−1, where n is greater than or equal to 0 and less than or equal to N−1; and/or, when M is less than or equal to the N, the index of the code block group transmitted on carrier n is n, and n is greater than or equal to 0 and less than M;
where M is the number of code block groups included in the transport block, M is a positive integer greater than or equal to 1, N is the number of the carriers, and N is a positive integer greater than or equal to 2, T₁=M mod N, N₁=[M/N], N₂=[M/N], [M/N] represents a ceil of M/N, and [M/N] represents a floor of M/N.

In a possible implementation, the S1 step includes:
receiving a transmission mode indication parameter;
determining the transmission mode according to the transmission mode indication parameter.

In a possible implementation,
the transmission mode indication parameter is carried in a system message; and/or,
the transmission mode indication parameter is carried in first radio resource control signaling.

In a possible implementation, the method further includes:
receiving second radio resource control signaling; and
acquiring the number of consecutive retransmissions according to the second radio resource control signaling.

In a possible implementation, the second radio resource control signaling includes an aggregation factor, and the number of consecutive retransmissions is the number of times indicated by the aggregation factor; and/or,
the second radio resource control signaling does not include the aggregation factor, and the number of consecutive retransmissions is 1.

In a second aspect, the present application provides a transmission method applicable to a terminal device, the method including:
S10: in response to a transmission mode of a transport block being a complete transmission mode and/or a carrier satisfying a preset condition, transmitting the transport block on the carrier according to the complete transmission mode; and/or,
S20: in response to a transmission mode of a transport block being a distributed transmission mode and/or a carrier satisfying a preset condition, transmitting the transport block on the carrier according to the distributed transmission mode.

In a possible implementation, the preset condition includes:
the number of carriers being at least two; and/or,
carriers being carries in the same logical cell.

In a possible implementation, the step S10 includes:
transmitting the transport block on the carrier according to the complete transmission mode, a redundancy version of the transport block for transmission on at least one of the carriers and/or the number of consecutive retransmissions of the transport block.

In a possible implementation, for any transmission slot, a redundancy version of the transport block for transmission on the at least one of the carriers satisfies at least one of:
the number of consecutive retransmissions being 1, and redundancy versions of the transport block for transmission on the at least one of the carriers being different;
the number of consecutive retransmissions being 1, and the redundancy versions of the transport block for transmission on the at least one of the carriers being the same; and
the number of consecutive retransmissions being greater than 1, and the redundancy versions of the transport block for transmission on the at least one of the carriers being different.

In a possible implementation, the number of consecutive retransmissions is 1, and the redundancy version of the transport block for transmission on the at least one of the carriers satisfies a first preset condition.

In a possible implementation, the first preset condition includes at least one of:
rv_{id}=0, if n mod 4=0, then rv1 is 0; if n mod 4=1, then the rv1 is 2; if n mod 4=2, then the rv1 is 3, and if n mod 4=3, then the rv1 is 1;
rv_{id}=2, if n mod 4=0, then the rv1 is 2; if n mod 4=1, then the rv1 is 3; if n mod 4=2, then the rv1 is 1, and if n mod 4=3, then the rv1 is 0;
rv_{id}=3, if n mod 4=0, then the rv1 is 3; if n mod 4=1, then the rv1 is 1; if n mod 4=2, then the rv1 is 0, and if n mod 4=3, then the rv1 is 2; and
rv_{id}=1, if n mod 4=0, then the rv1 is 1; if n mod 4=1, then the rv1 is 0; if n mod 4=2, then the rv1 is 2, and if n mod 4=3, then the rv1 is 3;
where rv_{id} is a redundancy version identifier of a first carrier of the at least one of the carriers, mod is a modulo operation, n is an integer greater than or equal to 0 and less than or equal to N−1, N is the number of the carriers, and the rv1 is a redundancy version of the transport block for transmission on carrier n.

In a possible implementation, the first preset condition may also be that redundancy versions for transmission on the at least one of the carriers are the same.

In a possible implementation, transmitting the transport block on the carrier according to the complete transmission mode, a redundancy version of the transport block for transmission on the at least one of the carriers and/or the number of consecutive retransmissions of the transport block includes:
transmitting the transport block on each carrier according to the redundancy version of the transport block for transmission on the at least one of the carriers.

In a possible implementation, the number of consecutive retransmissions K is greater than 1, and the number of the carriers N is greater than or equal to K; the redundancy version of the transport block for transmission on the at least one of the carriers satisfies a second preset condition.

In a possible implementation, the second preset condition includes at least one of.
rv_{id}=0, if (n mod K) mod 4=0, then rv2 is 0; if (n mod K) mod 4=1, then rv2 is 2; if (n mod K) mod 4=2, then the rv2 is 3, and (n mod K) mod 4=3, then the rv2 is 1;
rv_{id}=2, if (n mod K) mod 4=0, then the rv2 is 2; if (n mod K) mod 4=1, then rv2 is 3; if (n mod K) mod 4=2, then the rv2 is 1, and if (n mod K) mod 4=3, then the rv2 is 0;
rv_{id}=3, if (n mod K) mod 4=0, then the rv2 is 3; if (n mod K) mod 4=1, then rv2 is 1; if (n mod K) mod 4=2, then the rv2 is 0, and if (n mod K) mod 4=3, then the rv2 is 2; and
rv_{id}=1, if (n mod K) mod 4=0, then the rv2 is 1; if (n mod K) mod 4=1, then rv2 is 0; if (n mod K) mod 4=2, then the rv2 is 2, and if (n mod K) mod 4, then the rv2 is 3;
where rv_{id} is a redundancy version identifier of a first carrier of the at least one of the carriers, mod is a modulo operation, and the rv2 is a redundancy version of the transport block for transmission on carrier n;
n is an integer greater than or equal to 0 and less than or equal to N−1, or n is an integer greater than or equal to 0 and less than or equal to K−1.

In a possible implementation, transmitting the transport block on the carrier according to the complete transmission mode, a redundancy version of the transport block for transmission on the at least one of the carriers and/or the number of consecutive retransmissions of the transport block includes:
transmitting the transport block on first K carriers according to redundancy versions of the transport block for transmission on the first K carriers; or,
transmitting the transport block on the N carriers according to redundancy versions of the transport block for transmission on the N carriers.

In a possible implementation, the number of consecutive retransmissions K is greater than 1, the number of the carriers N is less than K; and the redundancy version of the transport block for transmission on the at least one of the carriers and a transmission slot i satisfy a third preset condition.

In a possible implementation, the third preset condition includes at least one of.
rv_{id}=0, if (n+i*N) mod 4=0, then rv3 is 0; if (n+i*N) mod 4=1, then the rv3 is 2; if (n+i*N) mod 4=2, then the rv3 is 3, and (n+i*N) mod 4=3, then the rv3 is 1;
rv_{id}=2, if (n+i*N) mod 4=0, then the rv3 is 2; if (n+i*N) mod 4=1, then rv3 is 3; if (n+i*N) mod 4=2, then the rv3 is 1, and if (n+i*N) mod 4=3, then the rv3 is 0;
rv_{id}=3, if (n+i*N) mod 4=0, then rv3 is 3; if (n+i*N) mod 4=1, then the rv3 is 1; if (n+i*N) mod 4=2, then the rv3 is 0, and if (n+i*N) mod 4=3, then the rv3 is 2; and
rv_{id}=1, if (n+i*N) mod 4=0, then the rv3 is 1; if (n+i*N) mod 4=1, then rv3 is 0; if (n+i*N) mod 4=2, then the rv3 is 2, and if n (n+i*N) mod 4=3, then the rv3 is 3;
where rv_{id} is a redundancy version identifier of a first carrier of the at least one of the carriers, mod is a modulo operation, n is an integer greater than or equal to 0 and less than or equal to N−1, N is the number of the carriers, and the rv3 is a redundancy version of the transport block for transmission on carrier n in a transmission slot i;
when i is greater than or equal to 0 and less than or equal to (([K/N]−1), n is an integer greater than or equal to 0 and less than or equal to N−1; when i is equal to [K/N], n is an integer greater than or equal to 0 and less than or equal to N−1, or n is an integer greater than or equal to 0 and less than or equal to (K−[K/N]*N−1), [K/N] represents a ceil of K/N, [K/N] represents a floor of K/N.

In a possible implementation, transmitting the transport block on the carrier according to the complete transmission mode, a redundancy version of the transport block for transmission on the at least one of the carriers and/or the number of consecutive retransmissions of the transport block includes:
for any one of [K/N] transmission slots, transmitting the transport block on the N carriers according to the redundancy version of the transport block for transmission on the at least one of the carriers in the transmission slot; or,
for any one of first ([K/N]−1 transmission slots, transmitting the transport block on the N carriers according to the redundancy version of the transport block for transmission on the at least one of the carriers in the transmission slot; for a ([K/N])-th transmission slot, transmitting the transport block on first (K−[K/N]*N) carriers according to redundancy versions of the transport block for the transmission on the first (K−[K/N]*N) carriers in the transmission slot.

In a possible implementation, the step S20 includes:
transmitting the transport block on the carrier according to the distributed transmission mode, a redundancy version of the transport block for transmission on the at least one of the carriers and/or the number of consecutive retransmissions of the transport block.

In a possible implementation, for any transmission slot, redundancy versions of the transport block for transmission on the at least one of the carriers are the same.

In a possible implementation, a redundancy version of the transport block for transmission on the at least one of the carriers in a transmission slot i satisfies a fourth preset condition.

In a possible implementation, the fourth preset condition includes at least one of:
rv_{id}=0, if i mod 4=0, then rv4 is 0; if i mod 4=1, then the rv4 is 2; if i mod 4=2, then the rv4 is 3, and if i mod 4=3, then the rv4 is 1;
rv_{id}=2, if i mod 4=0, then the rv4 is 2; if i mod 4=1, then the rv4 is 3; if i mod 4=2, then the rv4 is 1, and if i mod 4=3, then the rv4 is 0;
rv_{id}=3, if i mod 4=0, then the rv4 is 3; if i mod 4=1, then the rv4 is 1; if i mod 4=2, then the rv4 is 0, and if i mod 4=3, then the rv4 is 2; and
rv_{id}=1, if i mod 4=0, then the rv4 is 1; if i mod 4=1, then the rv4 is 0; if i mod 4=2, then the rv4 is 2, and if i mod 4=3, then the rv4 is 3;
where rv_{id} is a redundancy version identifier of a first carrier of the at least one of the carriers, mod is a modulo operation, i is an integer greater than or equal to 0 and less than or equal to (K−1), K is the number of consecutive retransmissions, and rv4 is a redundancy version of a transport block for transmission on the at least one of the carriers on a transmission slot i.

In a possible implementation, transmitting the transport block on the carrier according to the distributed transmission mode, a redundancy version of the transport block for transmission on the at least one of the carriers and/or the number of consecutive retransmissions of the transport block includes:
determining an index of a code block group for transmission on the at least one of the carriers according to the number of code block groups included in the transport block and the number of the carriers;
for any one of K transmission slots, transmitting at least one code block group of the transport block on the at least one of the carriers according to the redundancy version of the transport block for transmission on the at least one of the carriers and the index of the code block group.

In a possible implementation, the number of code block groups included in the transport block is a smaller one of a real number of code blocks in the transport block and a maximum number of code block groups in the transport block permitted by a protocol.

In a possible implementation, the index of the code block group for transmission on the at least one of the carriers satisfies a fifth preset condition.

In a possible implementation, the fifth preset condition includes at least one of:
when M is greater than N, n∈{0, 1, . . . , T₁−1}, an index of a code block group for transmission on carrier n is (n*N₁+k₁), k₁=0, 1, . . . , N₁−1; when n∈{T₁, T₁+1, . . . , N−1}, an index of a code block group for transmission on carrier n is (T₁*N₁+(n−T₁)N₂+k₂), k₂=0, 1, . . . , N₂−1, where n is greater than or equal to 0 and less than or equal to N−1; and/or,
when M is less than or equal to the N, the index of the code block group transmitted on carrier n is n, and n is greater than or equal to 0 and less than M;
where M is the number of code block groups included in the transport block, M is a positive integer greater than or equal to 1, N is the number of the carriers, and N is a positive integer greater than or equal to 2, T₁=M mod N, N₁=[M/N], N₂=[M/N], [M/N] represents a ceil of M/N, and [M/N] represents a floor of M/N.

In a possible implementation, the method further includes:
acquiring a redundancy version identifier corresponding to a first carrier of the at least one of the carriers, and determining the redundancy version of the transport block for transmission on the at least one of the carriers according to the redundancy version identifier corresponding to the first carrier, the number of consecutive retransmissions and the transmission mode; and/or,
acquiring a redundancy version identifier corresponding to the at least one of the carriers, and determining the redundancy version of the transport block for transmission on the at least one of the carriers according to the redundancy version identifier of the at least one of the carriers.

In a possible implementation, the acquiring a redundancy version identifier of a first carrier of the at least one of the carriers includes:
receiving first downlink resource control information on the first carrier, and acquiring the redundancy version identifier corresponding to the first carrier according to the first downlink resource control information;
the acquiring a redundancy version identifier corresponding to the at least one of the carriers includes:
receiving second downlink resource control information on the at least one of the carriers, and acquiring the redundancy version identifier corresponding to the at least one of the carriers according to the second downlink resource control information.

In a possible implementation, the method further includes:
receiving second radio resource control signaling; and
acquiring the number of consecutive retransmissions according to the second radio resource control signaling.

In a possible implementation, the second radio resource control signaling includes an aggregation factor, and the number of consecutive retransmissions is the number of times indicated by the aggregation factor; and/or,
the second radio resource control signaling does not include the aggregation factor, and the number of consecutive retransmissions is 1.

In a third aspect, the present application provides a transmission method applicable to a network device, the method including:
S3: in response to a carrier satisfying a preset condition, transmitting a transport block on the carrier according to a transmission mode of the transport block.

In a possible implementation, the preset condition includes:
the number of carriers being at least two; and/or,
carriers being carries in the same logical cell.

In a possible implementation, the S3 step includes:
transmitting the transport block on the carriers according to a redundancy version of the transport block for transmission on at least one of the carriers, the number of consecutive retransmissions of the transport block and the transmission mode.

In a possible implementation, for any transmission slot, the redundancy version satisfies at least one of:
the transmission mode being a complete transmission mode, the number of consecutive retransmissions being 1, and redundancy versions of the transport block for transmission on the at least one of the carriers being different;
the transmission mode being the complete transmission mode, the number of consecutive retransmissions being 1, and the redundancy versions of the transport block for transmission on the at least one of the carriers being the same;
the transmission mode being the complete transmission mode, the number of consecutive retransmissions being greater than 1, and the redundancy versions of the transport block for transmission on the at least one of the carriers being different; and
the transmission mode being a distributed transmission mode, and the redundancy versions of the transport block for transmission on the at least one of the carriers being the same.

In a possible implementation, the transmission mode is the complete transmission mode, the number of consecutive retransmissions is 1, and the redundancy version of the transport block for transmission on the at least one of the carriers satisfies a first preset condition.

In a possible implementation, the first preset condition includes at least one of:
rv_{id}=0, if n mod 4=0, then rv1 is 0; if n mod 4=1, then the rv1 is 2; if n mod 4=2, then the rv1 is 3, and if n mod 4=3, then the rv1 is 1;
rv_{id}=2, if n mod 4=0, then the rv1 is 2; if n mod 4=1, then the rv1 is 3; if n mod 4=2, then the rv1 is 1, and if n mod 4=3, then the rv1 is 0;
rv_{id}=3, if n mod 4=0, then the rv1 is 3; if n mod 4=1, then the rv1 is 1; if n mod 4=2, then the rv1 is 0, and if n mod 4=3, then the rv1 is 2; and
rv_{id}=1, if n mod 4=0, then the rv1 is 1; if n mod 4=1, then the rv1 is 0; if n mod 4=2, then the rv1 is 2, and if n mod 4=3, then the rv1 is 3;
where rv_{id} is a redundancy version identifier of a first carrier of the at least one of the carriers, mod is a modulo operation, n is an integer greater than or equal to 0 and less than or equal to N−1, N is the number of the carriers, and rv1 is a redundancy version of the transport block for transmission on carrier n.

In a possible implementation, the first preset condition may also be that redundancy versions for transmission on the at least one of the carriers are the same.

In a possible implementation, transmitting the transport block on the carriers according to a redundancy version of the transport block for transmission on at least one of the carriers, the number of consecutive retransmissions of the transport block and the transmission mode includes:
transmitting the transport block on each carrier according to the redundancy version of the transport block for transmission on the at least one of the carriers.

In a possible implementation, the transmission mode is the complete transmission mode, the number of consecutive retransmissions K is greater than 1, and the number of the carriers N is greater than or equal to K; the redundancy version of the transport block for transmission on the at least one of the carriers satisfies a second preset condition.

In a possible implementation, the second preset condition includes at least one of.
rv_{id}=0, if (n mod K) mod 4=0, then rv2 is 0; if (n mod K) mod 4=1, then rv2 is 2; if (n mod K) mod 4=2, then the rv2 is 3, and (n mod K) mod 4=3, then the rv2 is 1;
rv_{id}=2, if (n mod K) mod 4=0, then the rv2 is 2; if (n mod K) mod 4=1, then rv2 is 3; if (n mod K) mod 4=2, then the rv2 is 1, and if (n mod K) mod 4=3, then the rv2 is 0;
rv_{id}=3, if (n mod K) mod 4=0, then the rv2 is 3; if (n mod K) mod 4=1, then rv2 is 1; if (n mod K) mod 4=2, then the rv2 is 0, and if (n mod K) mod 4=3, then the rv2 is 2; and
rv_{id}=1, if (n mod K) mod 4=0, then the rv2 is 1; if (n mod K) mod 4=1, then rv2 is 0; if (n mod K) mod 4=2, then the rv2 is 2, and if (n mod K) mod 4, then the rv2 is 3;
where rv_{id} is a redundancy version identifier of a first carrier of the at least one of the carriers, mod is a modulo operation, and rv2 is a redundancy version of the transport block for transmission on carrier n;
n is an integer greater than or equal to 0 and less than or equal to N−1, or n is an integer greater than or equal to 0 and less than or equal to K−1.

In a possible implementation, transmitting the transport block on the carriers according to a redundancy version of the transport block for transmission on at least one of the carriers, the number of consecutive retransmissions of the transport block and the transmission mode includes:
transmitting the transport block on first K carriers according to redundancy versions of the transport block for transmission on the first K carriers; or,
transmitting the transport block on the N carriers according to redundancy versions of the transport block for transmission on the N carriers.

In a possible implementation, the transmission mode is the complete transmission mode, the number of consecutive retransmissions K is greater than 1, the number of the carriers N is less than K, and the redundancy version of the transport block for transmission on the at least one of the carriers and a transmission slot i satisfy a third preset condition.

In a possible implementation, the third preset condition includes at least one of:
rv_{id}=0, if (n+i*N) mod 4=0, then rv3 is 0; if (n+i*N) mod 4=1, then the rv3 is 2; if (n+i*N) mod 4=2, then the rv3 is 3, and (n+i*N) mod 4=3, then the rv3 is 1;
rv_{id}=2, if (n+i*N) mod 4=0, then the rv3 is 2; if (n+i*N) mod 4=1, then rv3 is 3; if (n+i*N) mod 4=2, then the rv3 is 1, and if (n+i*N) mod 4=3, then the rv3 is 0;
rv_{id}=3, if (n+i*N) mod 4=0, then rv3 is 3; if (n+i*N) mod 4=1, then the rv3 is 1; if (n+i*N) mod 4=2, then the rv3 is 0, and if (n+i*N) mod 4=3, then the rv3 is 2; and
rv_{id}=1, if (n+i*N) mod 4=0, then the rv3 is 1; if (n+i*N) mod 4=1, then rv3 is 0; if (n+i*N) mod 4=2, then the rv3 is 2, and if n (n+i*N) mod 4=3, then the rv3 is 3;
where rv_{id} is a redundancy version identifier of a first carrier of the at least one of the carriers, mod is a modulo operation, n is an integer greater than or equal to 0 and less than or equal to N−1, N is the number of the carriers, and rv3 is a redundancy version of the transport block for transmission on carrier n in a transmission slot i;
when i is greater than or equal to 0 and less than or equal to (([K/N]−1), n is an integer greater than or equal to 0 and less than or equal to N−1; when the i is equal to [K/N], n is an integer greater than or equal to 0 and less than or equal to N−1, or n is an integer greater than or equal to 0 and less than or equal to (K−[K/N]*N−1), [K/N] represents a ceil of K/N, [K/N] represents a floor of K/N.

In a possible implementation, transmitting the transport block on the carriers according to a redundancy version of the transport block for transmission on at least one of the carriers, the number of consecutive retransmissions of the transport block and the transmission mode includes:
for any one of [K/N] transmission slots, transmitting the transport block on the N carriers according to the redundancy version of the transport block for transmission on the at least one of the carriers in the transmission slot; or,
for any one of first ([K/N]−1 transmission slots, transmitting the transport block on the N carriers according to the redundancy version of the transport block for transmission on the at least one of the carriers in the transmission slot; for a ([K/N])-th transmission slot, transmitting the transport block on first (K−[K/N]*N) carriers according to redundancy versions of the transport block for the transmission on the first (K−[K/N]*N) carriers in the transmission slot.

In a possible implementation, the transmission mode is the distributed transmission mode; the redundancy version of the transport block for transmission on the at least one of the carriers and a transmission slot i satisfy a fourth preset condition.

In a possible implementation, the fourth preset condition includes at least one of:
rv_{id}=0, if i mod 4=0, then rv4 is 0; if i mod 4=1, then the rv4 is 2; if i mod 4=2, then the rv4 is 3, and if i mod 4=3, then the rv4 is 1;
rv_{id}=2, if i mod 4=0, then the rv4 is 2; if i mod 4=1, then the rv4 is 3; if i mod 4=2, then the rv4 is 1, and if i mod 4=3, then the rv4 is 0;
rv_{id}=3, if i mod 4=0, then the rv4 is 3; if i mod 4=1, then the rv4 is 1; if i mod 4=2, then the rv4 is 0, and if i mod 4=3, then the rv4 is 2; and
rv_{id}=1, if i mod 4=0, then the rv4 is 1; if i mod 4=1, then the rv4 is 0; if i mod 4=2, then the rv4 is 2, and if i mod 4=3, then the rv4 is 3;
where rv_{id} is a redundancy version identifier of a first carrier of the at least one of the carriers, mod is a modulo operation, i is an integer greater than or equal to 0 and less than or equal to (K−1), K is the number of consecutive retransmissions, and rv4 is a redundancy version of a transport block for transmission on the at least one of the carriers on a transmission slot i.

In a possible implementation, transmitting the transport block on at least one of the carriers according to the redundancy version, the number of consecutive retransmissions of the transport block and the transmission mode includes:
determining an index of a code block group for transmission on the at least one of the carriers according to the number of code block groups included in the transport block and the number of the carriers;
for any one of K transmission slots, transmitting at least one code block group of the transport block on the at least one of the carriers according to the redundancy version of the transport block for transmission on the at least one of the carriers and the index of the code block group.

In a possible implementation, the number of code block groups included in the transport block is a smaller one of a real number of code blocks in the transport block and a maximum number of code block groups in the transport block permitted by a protocol.

In a possible implementation, the index of the code block group for transmission on the at least one of the carriers satisfies a fifth preset condition.

In a possible implementation, the fifth preset condition includes at least one of:
when M is greater than N, n∈{0, 1, . . . , T₁−1}, an index of a code block group for transmission on carrier n is (n*N₁+k₁), k₁=0, 1, . . . , N₁−1; when n∈{T₁, T₁+1, . . . , N−1}, an index of a code block group for transmission on carrier n is (T₁*N₁+(n−T₁)N₂+k₂), k₂=0, 1, . . . , N₂−1, where n is greater than or equal to 0 and less than or equal to N−1; and/or,
when M is less than or equal to the N, the index of the code block group transmitted on carrier n is n, and the n is greater than or equal to 0 and less than M;
where M is the number of code block groups included in the transport block, M is a positive integer greater than or equal to 1, N is the number of the carriers, and N is a positive integer greater than or equal to 2, T₁=M mod N, N₁=[M/N], N₂=[M/N], [M/N] represents a ceil of M/N, and [M/N] represents a floor of M/N.

In a possible implementation, the method further includes:
transmitting a redundancy version identifier, where the redundancy version identifier is used for indicating the redundancy version.

In a possible implementation, the transmitting redundancy version identifier includes:
transmitting first downlink resource control information on a first carrier of the at least one of the carriers, where the first downlink resource control information includes a redundancy version identifier corresponding to the first carrier; and/or,
transmitting second downlink resource control information on the at least one of the carriers, where the second downlink resource control information includes a redundancy version identifier corresponding to the at least one of the carriers.

In a possible implementation, the method further includes:
transmitting a transmission mode indication parameter, where the transmission mode indication parameter is used for indicating the transmission mode.

In a possible implementation, the transmission mode indication parameter is carried in a system message; and/or,
the transmission mode indication parameter is carried in first radio resource control signaling.

In a possible implementation, the method further includes:
transmitting second radio resource control signaling.

In a possible implementation, the second radio resource control signaling includes an aggregation factor, and the number of consecutive retransmissions is the number of times indicated by the aggregation factor; and/or,
the second radio resource control signaling does not include the aggregation factor, and the number of consecutive retransmissions is 1.

The present application also provides a communication system including:
a terminal device for performing the method in any one of the first and second aspects; and
a network device for performing the method in the third aspect.

The present application also provides a communication device including: a memory and a processor;
where the memory is configured to store program instructions; and
the processor is configured to call the program instructions in the memory to perform the method of any one of the first to third aspects.

The present application also provides a computer-readable storage medium having a computer program stored thereon; when the computer program is executed, the method of any preceding aspects is implemented.

The present application also provides a computer program product including a computer program; when the computer program is executed, the method of any preceding aspects is implemented.

According to the transmission method, communication device and storage medium provided in the present application, firstly, a transmission mode of a transport block is determined, and then the transport block is transmitted on carrier according to the transmission mode. When the number of carriers is 1, the transport block can be transmitted on the carrier in a complete transmission mode; when the number of carriers is at least 2, and at least two carriers are carries in the same logical cell, the transport block can be transmitted on the carriers through a complete transmission mode or a distributed transmission mode, thereby achieving the transmission of the transport block on the carrier(s).

### BRIEF DESCRIPTION OF DRAWINGS

The accompanying drawings, which are incorporated in and constitute a part of the description, illustrate embodiments consistent with the present application and together with the description, serve to explain the principles of the present application. In order to illustrate the technical solutions of the embodiments of the present application more clearly, a brief description will be given below of the drawings which need to be used in the description of the embodiments, and it would be obvious for a person skilled in the art to obtain other drawings according to these drawings without paying any inventive effort.

FIG. 1 is a schematic structural diagram showing hardware of a terminal device provided by an embodiment of the present application.

FIG. 2 is a communication network system architecture diagram provided by an embodiment of the present application.

FIG. 3 is a schematic structural diagram showing hardware of a controller provided by an embodiment of the present application.

FIG. 4 is a schematic structural diagram showing hardware of a network node provided by an embodiment of the present application.

FIG. 5 is a schematic structural diagram showing hardware of a network node provided by an embodiment of the present application.

FIG. 6 is a schematic structural diagram showing hardware of a controller provided by an embodiment of the present application.

FIG. 7 is a schematic structural diagram showing hardware of a network node provided by an embodiment of the present application.

FIG. 8 is a first schematic diagram showing signaling of a transmission method provided by an embodiment of the present application.

FIG. 9 is a second schematic diagram showing signaling of a transmission method provided by an embodiment of the present application.

FIG. 10 is a first schematic diagram showing transmission of a transport block provided by an embodiment of the present application.

FIG. 11 is a second schematic diagram showing transmission of a transport block provided by an embodiment of the present application.

FIG. 12 is a third schematic diagram showing transmission of a transport block provided by an embodiment of the present application.

FIG. 13 is a fourth schematic diagram showing transmission of a transport block provided by an embodiment of the present application.

FIG. 14 is a fifth schematic diagram showing transmission of a transport block provided by an embodiment of the present application.

FIG. 15 is a sixth schematic diagram showing transmission of a transport block provided by an embodiment of the present application.

FIG. 16 is a seventh schematic diagram showing transmission of a transport block provided by an embodiment of the present application.

FIG. 17 is a third schematic diagram showing signaling of a transmission method provided by an embodiment of the present application.

FIG. 18 is a fourth schematic diagram showing signaling of a transmission method provided by an embodiment of the present application.

FIG. 19 is a fifth schematic diagram showing signaling of a transmission method provided by an embodiment of the present application.

FIG. 20 is a sixth schematic diagram showing signaling of a transmission method provided by an embodiment of the present application.

FIG. 21 is a schematic structural diagram showing a transmitting apparatus provided by an embodiment of the present application.

FIG. 22 is a schematic structural diagram showing a transmitting apparatus provided by an embodiment of the present application.

FIG. 23 is a schematic structural diagram showing a transmitting apparatus provided by an embodiment of the present application.

FIG. 24 is a schematic structural diagram showing a communication device provided by an embodiment of the present application.

The objectives, features and advantages of the present application will be further described with reference to the accompanying drawings in conjunction with the embodiments. Specific embodiments of the present application have been shown by the above drawings and will be described in greater detail hereinafter. The drawings and written description are not intended to limit the scope of the concepts of the present application in any way, but rather to illustrate the concepts of the present application to a person skilled in the art by reference to specific embodiments.

### DESCRIPTION OF EMBODIMENTS

Reference will now be made in detail to exemplary embodiments, examples of which are illustrated in the accompanying drawings. Where the following description refers to the accompanying drawings, like numbers in different drawings indicate the same or similar elements, unless otherwise indicated. The implementations described in the following illustrative examples do not represent all embodiments consistent with the present application. Rather, they are merely examples of apparatus and methods consistent with certain aspects of the present application, as detailed in the appended claims.

It should be noted that, the terms “include”, “include”, or any other variation thereof in the description are intended to cover a non-exclusive inclusion, such that processes, methods, objects, or apparatuses that include a list of elements do not include only those elements but may include other elements not expressly listed or inherent to such processes, methods, objectives, or apparatuses. Without further limitation, an element identified by the phrase “including an . . . .” does not exclude the presence of additional identical elements in processes, methods, articles, or apparatuses including the element, moreover, elements or features of different embodiments of the present application may have the same meaning as the similarly named elements, features, or elements, or may have different meanings, the specific meaning of which should be determined by its interpretation in the specific embodiment or further by its context in the specific embodiment.

It should be understood that, although the terms first, second, third and the like may be used herein to describe various information, such information should not be limited to these terms. These terms are only used to distinguish one type of information from another. For example, without departing from the scope herein, first information may also be referred to as second information, and similarly, second information may also be referred to as first information. Depending on the context, the word “if” as used herein may be interpreted as “when” or “while” or “in response to determining . . . .”. Furthermore, as used herein, the singular forms “a”, “an”, and “the” are intended to include the plural forms as well, unless the context clearly indicates otherwise. It will be further understood that the terms “includes” and/or “including” specify the presence of stated features, steps, operations, elements, components, items, categories, and/or groups, but do not preclude the presence, occurrence or addition of one or more other features, steps, operations, elements, components, items, categories, and/or groups. The terms “or”, “and/or”, “including at least one of”, and the like, as used herein, are to be interpreted inclusively, or mean either or any combination. For example, “including at least one of: A, B, C” means “any one of: A; B; C; A and B; A and C; B and C; A and B and C”, for another example, “A, B or C” or “A, B and/or C” means “any one of: A; B; C; A and B; A and C; B and C; A and B and C”. An exception to this definition occurs only if a combination of elements, functions, steps or operations is inherently mutually exclusive in some way.

It should be understood that, although the various steps in the flowcharts in the embodiments of the present application are shown successively as indicated by the arrows, these steps are not necessarily performed successively as indicated by the arrows. The steps are performed in no strict order unless explicitly stated herein, and may be performed in other orders. Furthermore, at least a part of the steps in the figures may include a plurality of sub-steps or phases, these sub-steps or phases may not necessarily be performed at the same time, but may be performed at different times, and the order of their execution may not necessarily be sequential, but may be performed in turn or in alternation with other steps or at least some of sub-steps or stages of other steps.

Depending on the context, the word “if”, “in case of”, as used herein, may be interpreted as “when” or “while” or “in response to determining . . . ” or “in response to detecting . . . ”. Similarly, depending on the context, the phrases “if it is determined that . . . ” or “if it is detected that . . . (a stated condition or event)” may be interpreted as “when it is determined that . . . ” or “in response to determining . . . ” or “when it is detected that . . . . (a stated condition or event)” or “in response to detecting . . . (a stated condition or event)”.

It should be noted that, in the present document, step codes such as S1 and S2 are used for the purpose of describing the corresponding contents in a more clear and concise manner, and do not constitute a substantial limitation on the order; in the specific implementation, a person skilled in the art would have performed S2 first and then S1 and the like, but these should be within the scope of the present application.

It should be noted that in the present application, a single capital letter such as M, N, K and the like by default means a positive integer greater than or equal to 1, unless otherwise specified.

It should be understood that the particular embodiments described herein are illustrative only and are not restrictive.

In the description that follows, suffixes to elements such as “modules”, “components”, or “units” are used merely to facilitate the description of the present application and are not intended to be specific in nature. Thus, “modules”, “components”, or “units” may be used in combination.

The terminal device in the present application can be an intelligent terminal, and the intelligent terminal can be implemented in various forms. For example, the smart terminals described in the present application may include smart terminals such as cell phones, tablet PCs, notebook computers, palmtops, personal digital assistants (PDA), portable media players (PMP), navigation apparatuses, wearable devices, smart bracelets, pedometers and the like and fixed terminals such as digital TVs, desktop computers and the like.

In the following description, reference will be made to a terminal device as an example, and it will be understood by a person skilled in the art that the construction according to the embodiments of the present application can also be applied to a fixed type of terminal, in addition to elements specifically intended for mobile purposes.

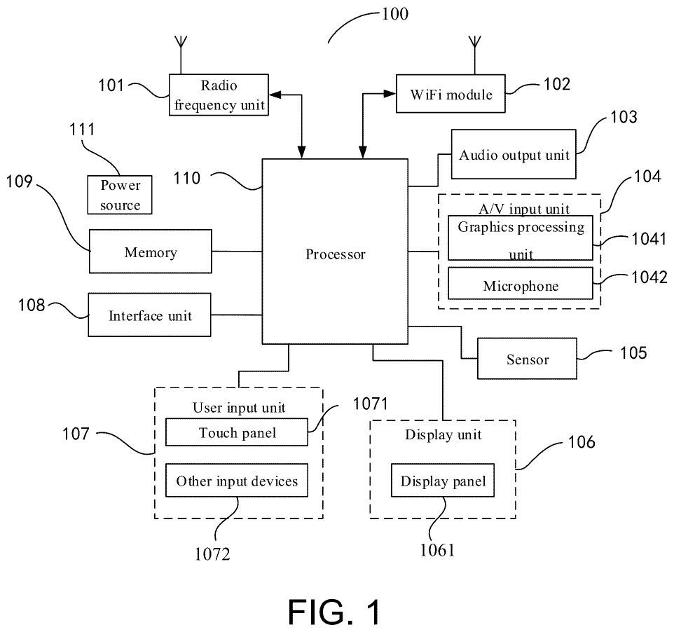

With reference to FIG. 1, which is a schematic structural diagram showing hardware of a terminal device implementing various embodiments of the present application, and the terminal device 100 may include: a radio frequency (Radio Frequency, RF) unit 101, a WiFi module 102, an audio output unit 103, an audio/video (A/V) input unit 104, a sensor 105, a display unit 106, a user input unit 107, an interface unit 108, a memory 109, a processor 110, and a power source 111 and the like. It will be understood by a person skilled in the art that the configuration of the terminal device shown in FIG. 1 does not constitute a limitation of the terminal device, and that the terminal device may include more or fewer components than those shown, or some components may be combined, or a different arrangement of components.

Each component of the terminal device is specifically described below with reference to FIG. 1.

A radio frequency unit 101 can be used for receiving and transmitting a signal in the process of receiving and transmitting information or a call, and in a possible implementation, receives downlink information from a base station and then passes the same to a processor 110 for processing; in addition, uplink data is transmitted to the base station. Generally, the radio frequency unit 101 includes, but is not limited to, an antenna, at least one amplifier, a transceiver, a coupler, a low noise amplifier, a duplexer and the like. Moreover, the radio frequency unit 101 may also communicate with networks and other devices via wireless communication. The wireless communication may use any communication standard or protocol, including, but not limited to GSM (Global System of Mobile Communication), GPRS (General Packet Radio Service), CDMA2000 (Code Division Multiple Access 2000), WCDMA (Wideband Code Division Multiple Access), TD-SCDMA (Time Division-Synchronous Code Division Multiple Access), FDD-LTE (Frequency Division Duplexing-Long Term Evolution), TDD-LTE (Time Division Duplexing-Long Term Evolution) and 5G and the like.

WiFi is a short-range wireless transmission technology, and a terminal device can help a user transmit and receive emails, browse web pages and access streaming media and the like via a WiFi module 102, which provides the user with wireless broadband Internet access. Although FIG. 1 shows the WiFi module 102, it will be understood that it does not belong to the necessary constitution of the terminal device, but may be omitted as necessary within the scope without changing the essence of the present application.

The audio output unit 103 may convert the audio data received by the radio frequency unit 101 or the WiFi module 102 or stored in the memory 109 into an audio signal and output as sound when the terminal device 100 is in a call signal receiving mode, a call mode, a recording mode, a voice recognition mode, a broadcast receiving mode and the like. Furthermore, the audio output unit 103 may provide audio output (e.g., call signal receiving sound, message receiving sound and the like) related to a specific function performed by the terminal device 100. The audio output unit 103 may include a speaker, a buzzer and the like.

The A/V input unit 104 is for receiving an audio or video signal. The A/V input unit 104 may include a graphics processing unit (GPU) 1041 that processes image data of a static picture or video obtained by an image capturing apparatus such as a camera in a video capturing mode or an image capturing mode, and a microphone 1042. The processed image frame may be displayed on the display unit 106. Image frames processed by the graphics processing unit 1041 may be stored in the memory 109 (or other storage medium) or transmitted via the radio frequency unit 101 or the WiFi module 102. The microphone 1042 can receive sound (audio data) via the microphone 1042 in a telephone call mode, a recording mode, a voice recognition mode, and the like, and can process such sound into audio data. The processed audio (voice) data can be converted into a format and then output in case of a telephone call mode, the format is suitable for being transmitted to the mobile communication base station via the radio frequency unit 101. The microphone 1042 may implement various types of noise cancellation (or suppression) algorithms to cancel (or suppress) noise or interference generated during the reception and transmission of audio signals.

The terminal device 100 also includes at least one sensor 105, such as a light sensor, a motion sensor, and other sensors. In a possible implementation, the light sensor includes an ambient light sensor and a proximity sensor, in a possible implementation, the ambient light sensor can adjust the brightness of the display panel 1061 according to the brightness of ambient light, and the proximity sensor can turn off the display panel 1061 and/or the backlight when the terminal device 100 moves to the ear. As one type of motion sensor, an accelerometer sensor can detect the magnitude of acceleration in various directions (generally three axes), and can detect the magnitude and direction of gravity when stationary, and can be used for applications which require identification of a mobile phone's gesture (such as landscape and portrait screen switching, relevant games, magnetometer gesture calibration), vibration identification related functions (such as pedometer, tapping) and the like; as to other sensors such as a fingerprint sensor, a pressure sensor, an iris sensor, a molecular sensor, a gyroscope, a barometer, a hygrometer, a thermometer, an infrared sensor and the like which can be further configured in the mobile phone, the description thereof will not be repeated here.

The display unit 106 is used for displaying information input by the user or information provided to the user. The display unit 106 may include a display panel 1061 which may be configured in the form of a liquid crystal display (Liquid Crystal Display, LCD), an organic light-emitting diode (Organic Light-Emitting Diode, OLED) and the like.

The user input unit 107 may be configured to receive inputted number or character information and generate key signal input related to user setting and function control of the terminal device. In a possible implementation, the user input unit 107 may include a touch panel 1071 and other input devices 1072. The touch panel 1071, also known as a touch screen, may collect touch operations on or near the touch panel 1071 by a user (e.g., operations of the user on or near the touch panel 1071 using any suitable object or accessory, such as a finger, stylus and the like), and drive the corresponding connection apparatus according to a preset program. The touch panel 1071 may include two parts, a touch detection device and a touch controller. In a possible implementation, a touch detection device detects a touch orientation of a user, detects a signal brought about by a touch operation, and transmits the signal to the touch controller; the touch controller receives touch information from the touch detection device, converts it into contact point coordinates, transmits same to the processor 110, and can receive commands sent from the processor 110 and execute same. Moreover, the touch panel 1071 may be implemented using various types of resistive, capacitive, infrared, and surface acoustic waves. In addition to the touch panel 1071, the user input unit 107 may also include other input devices 1072. In a possible implementation, the other input devices 1072 may include, but are not limited to, one or more of a physical keyboard, function keys (such as volume control keys, switch keys and the like), a trackball, a mouse, a joystick and the like and are not limited thereto.

In a possible implementation, the touch panel 1071 may overlay the display panel 1061 and, upon detecting a touch operation on or near the touch panel 1071, communicate with the processor 110 to determine the type of touch event, whereupon the processor 110 provides a corresponding visual output on the display panel 1061 according to the type of touch event. Although in FIG. 1, the touch panel 1071 and the display panel 1061 are implemented as two independent components to achieve the input and output functions of the terminal device, in some embodiments, the touch panel 1071 and the display panel 1061 may be integrated to achieve the input and output functions of the terminal device, and the details are not limited herein.

The interface unit 108 serves as an interface through which at least one external apparatus can be connected with the terminal device 100. For example, the external apparatus may include a wired or wireless headset port, an external power source (or battery charger) port, a wired or wireless data port, a memory card port, a port for connecting to an apparatus having an identification module, an audio input/output (I/O) port, a video I/O port, a headset port and the like. The interface unit 108 may be configured to receive input (e.g., data information, power and the like) from an external apparatus and transmit the received input to one or more elements within the terminal device 100 or may be configured to transmit data between the terminal device 100 and the external apparatus.

The memory 109 may be configured to store software programs as well as various data. The memory 109 may mainly include a program storage area and a storage data area, and in a possible implementation, the program storage area may store an operating system, an application program required by at least one function (such as a sound playing function, an image playing function and the like) and the like; the storage data area may store data (e.g., audio data, phonebook and the like) created according to the use of the handset and the like. Moreover, the memory 109 may include a high speed random access memory, and may also include a non-volatile memory, such as at least one magnetic disk storage device, flash memory device, or other volatile solid state storage device.

The processor 110 is a control center of the terminal device, connects various parts of the entire terminal device using various interfaces and lines, performs various functions of the terminal device and processes data by running or executing software programs and/or modules stored in the memory 109, and calls data stored in the memory 109, thereby monitoring the terminal device as a whole. The processor 110 may include one or more processing units; preferably, the processor 110 may integrate an application processor and a modem processor. In a possible implementation, the present application processor primarily handles operating systems, user interfaces, applications and the like and the modem processor primarily handles wireless communications. It will be appreciated that the modem processor described above may not be integrated into the processor 110.

The terminal device 100 may also include a power source 111 (e.g., a battery) to power the various components. Preferably, the power source 111 may be logically connected to the processor 110 through a power management system through which charging, discharging, and power consumption can be realized.

Although not shown in FIG. 1, the terminal device 100 may further include a Bluetooth module and the like, which will not be described in detail herein.

In order to facilitate an understanding of the embodiments of the present application, a communication network system on which the terminal device of the present application is based is described below.

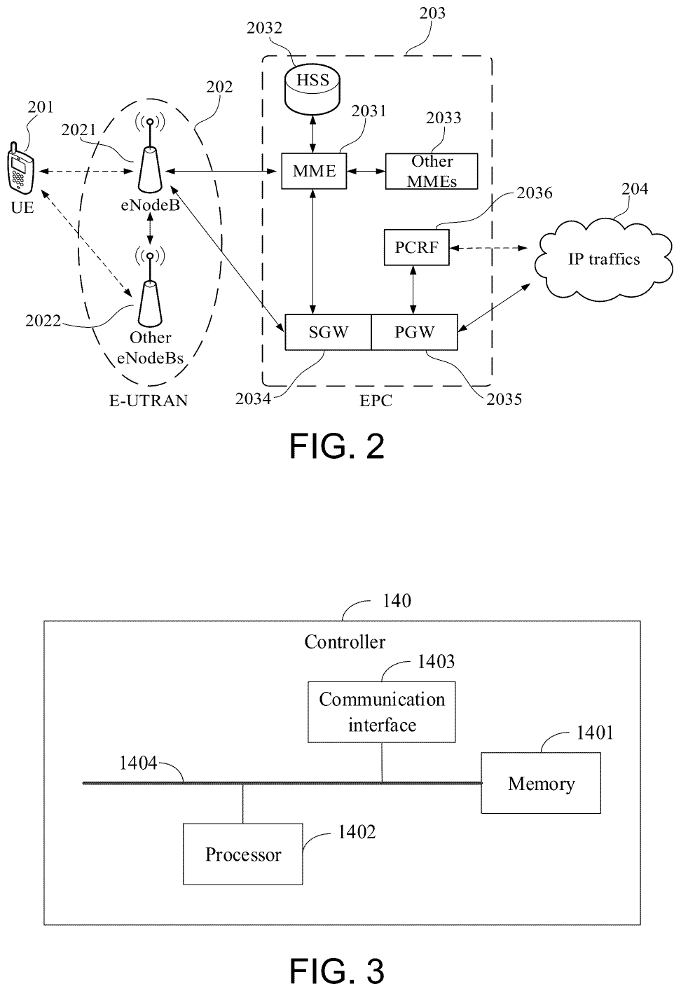

Referring to FIG. 2, which is a diagram showing a communication network system architecture provided in an embodiment of the present application, where the communication network system is an LTE system of universal mobile telecommunication technology, and the LTE system includes a UE (User Equipment) 201, an E-UTRAN (Evolved UMTS Terrestrial Radio Access Network) 202, an EPC (Evolved Packet Core) 203 and an IP traffic 204 of an operator which are communicatively connected successively.

In a possible implementation, the UE 201 may be the above-described terminal device 100, which will not be described in detail herein.

E-UTRAN 202 includes eNodeB 2021 and other eNodeB 2022 and the like. In a possible implementation, the eNodeB 2021 may be connected to other eNodeB 2022 through a backhaul (e.g., an X2 interface), the eNodeB 2021 is connected to the EPC 203, and the eNodeB 2021 may provide access for the UE 201 to the EPC 203.

The EPC 203 may include an MME (Mobility Management Entity) 2031, an HSS (Home Subscriber Server) 2032, other MME 2033s, an SGW (Serving Gate Way) 2034, a PGW (PDN Gate Way) 2035, and a PCRF (Policy and Charging Rules Function) 2036 and the like. In a possible implementation, MME 2031 is a control node that handles signaling between UE 201 and EPC 203, providing bearer and connection management. HSS 2032 is configured to provide registers to manage functions such as home location registers (not shown) and to hold user specific information about service characteristics, data rates and the like. All user data can be sent through SGW 2034, PGW 2035 can provide IP address allocation of UE 201 as well as other functions, and PCRF 2036 is a policy and charging control policy decision point for traffic data flow and IP bearer resources, and selects and provides available policy and charging control decisions for a policy and charging execution function unit (not shown).

IP traffics 204 may include the Internet, intranets, IMS (IP Multimedia Subsystem) or other IP traffics and the like.

Although the LTE system is described above as an example, a person skilled in the art would know that the present application is not only applicable to the LTE system, but also applicable to other wireless communication systems, such as GSM, CDMA2000, WCDMA, TD-SCDMA and future new network systems (such as 5G) and the like and is not limited thereto.

FIG. 3 is a schematic structural diagram showing hardware of a controller provided by an embodiment of the present application. The controller 140 includes: a memory 1401 used for storing program instructions and a processor 1402 used for calling the program instructions in the memory 1401 to execute the steps executed by the controller in the following method embodiments, and the implementation principles and advantageous effects thereof are similar, which will not be described in detail herein.

In a possible implementation, the controller also includes a communication interface 1403 which may be coupled to the processor 1402 via a bus 1404. The processor 1402 may control the communication interface 1403 to realize receiving and transmitting functions of the controller 140.

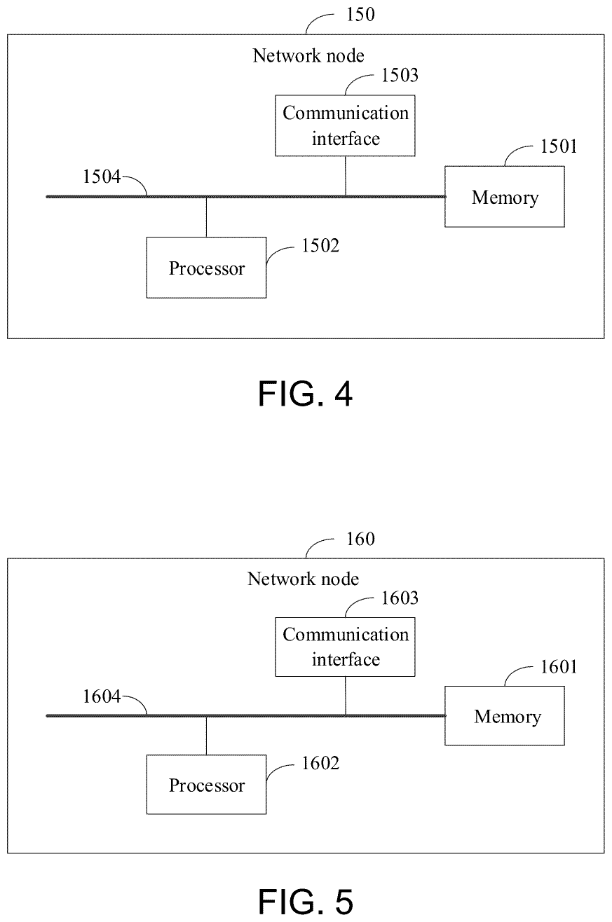

FIG. 4 is a schematic structural diagram showing hardware of a network node provided by an embodiment of the present application. The network node 150 includes: a memory 1501 used for storing program instructions, and a processor 1502 used for calling the program instructions in the memory 1501 to execute the steps executed by the network device in the following method embodiments, and the implementation principles and advantageous effects thereof are similar, which will not be described in detail herein.

In a possible implementation, the network node 150 further includes a communication interface 1503 which may be coupled to the processor 1502 via a bus 1504. The processor 1502 may control the communication interface 1503 to realize receiving and transmitting functions by the network node 150.

FIG. 5 is a schematic structural diagram showing hardware of a network node provided by an embodiment of the present application. The network node 160 includes: a memory 1601 used for storing program instructions, and a processor 1602 used for calling the program instructions in the memory 1601 to execute the steps executed by the network device in the following method embodiments, and the implementation principles and advantageous effects thereof are similar, which will not be described in detail herein.

In a possible implementation, the network node 160 further includes a communication interface 1603 which may be coupled to the processor 1602 via a bus 1604. The processor 1602 may control the communication interface 1603 to realize the receiving and transmitting functions by the network node 160.

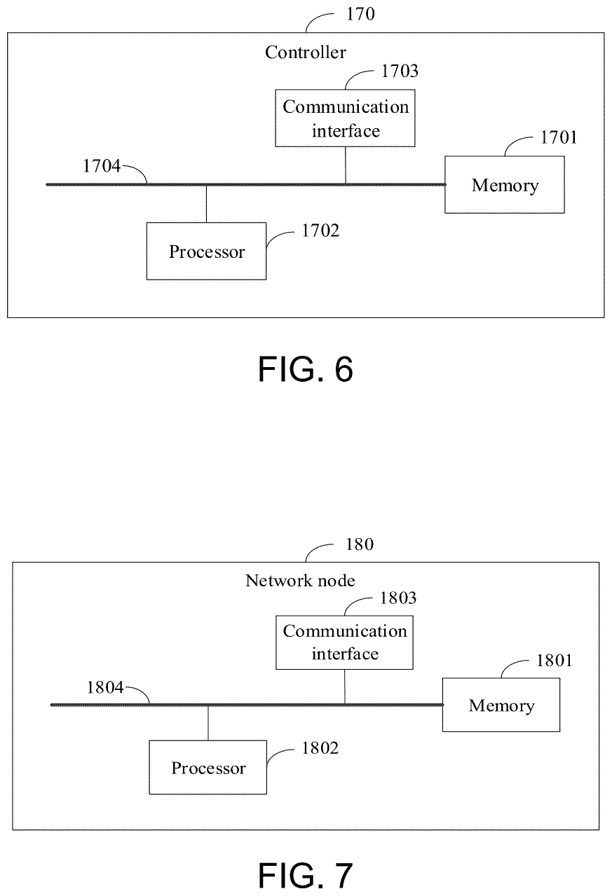

FIG. 6 is a schematic structural diagram showing hardware of a controller provided by an embodiment of the present application. The controller 170 includes: a memory 1701 used for storing program instructions and a processor 1702 used for calling the program instructions in the memory 1701 to execute the steps executed by the controller in the following method embodiments, and the implementation principles and advantageous effects thereof are similar, which will not be described in detail herein.

In a possible implementation, the controller 170 also includes a communication interface 1703 which may be coupled to the processor 1702 via a bus 1704. The processor 1702 may control the communication interface 1703 to realize receiving and transmitting functions of the controller 170.

FIG. 7 is a schematic structural diagram showing hardware of a network node provided by an embodiment of the present application. The network node 180 includes: a memory 1801 and a processor 1802, where the memory 1801 is used for storing program instructions, and the processor 1802 is used for calling the program instructions in the memory 1801 to execute the steps executed by the network device in the following method embodiments, and the implementation principle and beneficial effects thereof are similar, which will not be described in detail herein.

In a possible implementation, the network node 180 further includes a communication interface 1803 which may be coupled to the processor 1802 via a bus 1804. The processor 1802 may control the communication interface 1803 to realize receiving and transmitting functions by the network node 180.

The integrated modules, implemented in the form of software functional modules, may be stored in a computer-readable storage medium. The above-mentioned software functional modules are stored in a storage medium, and include several instructions to enable a computer device (which may be a personal computer, a server, or a network device and the like) or a processor to perform some steps of embodiments of the present application.

In the embodiments described above, they may be implemented in whole or in part by software, hardware, firmware, or any combination thereof. When implemented in software, it may be implemented in whole or in part as a computer program product. The computer program product includes one or more computer instructions. When the computer program instructions are loaded and executed on a computer, the processes or functions according to embodiments of the present application are generated in whole or in part. The computer may be a general-purpose computer, a special purpose computer, a computer network, or other programmable apparatuses. The computer instructions may be stored in a computer-readable storage medium or transmitted from one computer-readable storage medium to another computer-readable storage medium. For example, the computer instructions may be transmitted from one website, computer, server, or data center to another website, computer, server, or data center by wire (e.g., coaxial cable, optical fiber, digital subscriber line (DSL)) or wirelessly (e.g., infrared, wireless, microwave and the like). A computer-readable storage medium can be any available medium that can be accessed by a computer or a data storage device including one or more available mediums integrated, such as a server, data center, and the like. The available medium may be a magnetic medium (e.g., floppy disk, hard disk, magnetic tape), optical medium (e.g., DVD), or semiconductor medium (e.g., solid state disk (SSD)) and the like.

Based on the above-mentioned hardware structure of a terminal device and a communication network system, various embodiments of the present application are proposed.

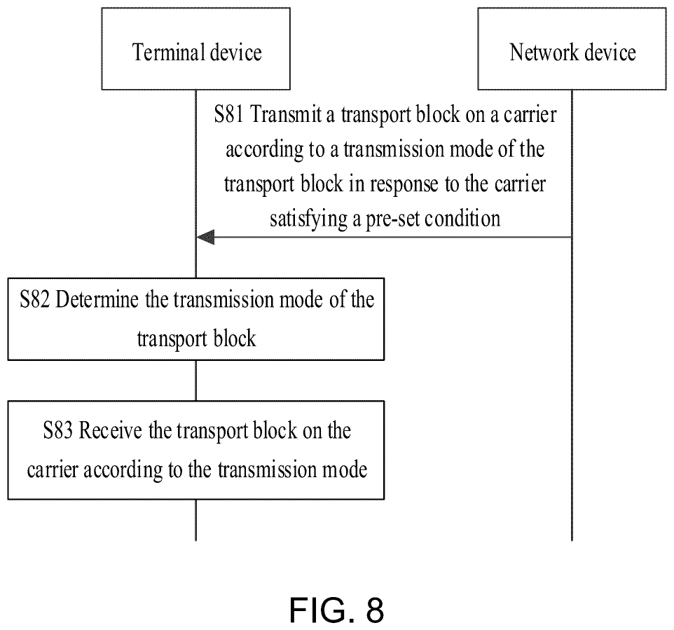

FIG. 8 is a first signaling schematic diagram showing a transmission method provided by an embodiment of the present application, and as shown in FIG. 8, the method includes:
S81: a network device transmits a transport block on a carrier according to a transmission mode of the transport block in response to the carrier satisfying a preset condition.

In a possible implementation, the number of carriers may be one or more.

The transmission mode of the transport block includes a complete transmission mode and a distributed transmission mode, and in a possible implementation, the complete transmission mode refers to that a transport block is completely transmitted on any one carrier. In contrast to a complete transmission mode, a distributed transmission mode refers to that for a transport block, only a partial Code Block Group (CBG) of the transport block is transmitted on any one carrier, i.e., when the distributed transmission mode is adopted, one transport block will be divided into at least one code block group, and different code block groups of the transport block are transmitted on different carriers, thereby realizing the transmission of all the code block groups of the transport block.

When the number of carriers is 1, the transport block can only be transmitted in a complete transmission mode on this carrier, and when the number of carriers is at least 2, the transport block can be transmitted in a complete transmission mode on at least one carrier or in a distributed transmission mode on at least one carrier.

When the carrier satisfies a preset condition, the network device may transmit the transport block to the terminal device on the carrier according to the transmission mode of the transport block, i.e., the network device may perform PDSCH transmission for downlink traffic.

In a possible implementation, the preset condition includes that the number of carriers is at least 2 and/or that the carriers are carries in the same logical cell. When the number of carriers is at least 2, the network device may transmit the transport block on the at least two carriers. The at least two carriers are carries in the same logical cell. When the network device transmits a transport block to the terminal device on the at least two carriers, the network device can select a complete transmission mode or a distributed transmission mode for transmission.

S82: the terminal device determines the transmission mode of the transport block.

Since the transmission mode of the transport block may be a complete transmission mode or a distributed transmission mode, the terminal device first determines the transmission mode of the transport block before receiving the transport block.

In a possible implementation, the terminal device determines the transmission mode of the transport block in response to the carrier satisfying a preset condition. In a possible implementation, the preset condition includes that the number of carriers is at least 2 and/or that the carriers are carries in the same logical cell.

In a possible implementation, the network device transmits a transmission mode indication parameter to the terminal device, the transmission mode indication parameter being used for indicating the transmission mode of the transport block.

In a possible implementation, the transmission mode indication parameter is carried in a system message and/or the transmission mode indication parameter is carried in first radio resource control signaling.

In a possible implementation, when the transmission mode indication parameter is carried in the system message, the network device transmits the system message to the terminal device, the system message including the transmission mode indication parameter. After receiving the system message from the network device, the terminal device acquires the transmission mode indication parameter according to the system message, and then determines the transmission mode of the transport block according to the transmission mode indication parameter.

In a possible implementation, the system message may be a system information block (SIB).

In a possible implementation, when the transmission mode indication parameter is carried in first radio resource control signaling, the network device transmits the first radio resource control signaling to the terminal device, where the first radio resource control signaling includes the transmission mode indication parameter. After receiving the first radio resource control signaling from the network device, the terminal device acquires the transmission mode indication parameter according to the first radio resource control signaling, and then determines the transmission mode of the transport block according to the transmission mode indication parameter.

In a possible implementation, the first radio resource control signaling may be a radio resource control (RRC) message.

S83: the terminal device receives the transport block on the carrier according to the transmission mode.

After determining the transmission mode of the transport block, the terminal device can receive the transport block transmitted by the network device on the carrier.

In a possible implementation, the terminal device determines a redundancy version of the transport block for transmission on at least one carrier and then receives the transport block on the carrier according to the redundancy version, the transmission mode of the transport block and the number of consecutive retransmissions of the transport block.

The redundancy version is used for implementing incremental redundancy hybrid automatic repeat request (HARQ) transmission. The channel-encoded data of a transport block includes three segments, where the first segment can be considered as basic data, and the remaining two segments are redundant data. The three segments of data are successively placed in a buffer, and the redundancy version indicates where the data is taken from the buffer.

When the number of carriers is 1, the network device may transmit a redundancy version identifier on the carrier to the terminal device, and then the terminal device determines the redundancy version of the transport block on the carrier according to the redundancy version identifier.

When the number of carriers is at least 2, the network device may transmit a redundancy version identifier of the first carrier of the at least one carrier to the terminal device. After receiving the redundancy version identifier of the first carrier of the at least one carrier, the terminal device determines the redundancy version of the transport block for transmission on the at least one carrier according to the redundancy version identifier of the first carrier, the number of consecutive retransmissions and the transmission mode. For example, when the number of carriers constituting a logical cell is 3, respectively being carrier 0, carrier 2 and carrier 4, where carrier 0 is the first carrier among the 3 carriers, the terminal device can receive the redundancy version identifier of carrier 0, and determine the redundancy versions of the transport block on carrier 0, carrier 2 and carrier 4 according to the redundancy version identifier of carrier 0, the number of consecutive retransmissions and the transmission mode. In the present embodiment, an example is taken where carrier 0 is the first carrier, the terminal device may receive the redundancy version identifier of the first carrier via carrier 0. In other embodiments, the first carrier may also be carrier 2 or carrier 4, for example, when the first carrier is carrier 2, the terminal device may receive the redundancy version identifier of the first carrier via carrier 2, and the same applies when the first carrier is carrier 4.

In a possible implementation, the redundancy version identifier of the first carrier is carried in first downlink resource control information. The network device transmits the first downlink resource control information to the terminal device on a first carrier, and after receiving the first downlink resource control information on the first carrier, the terminal device acquires the redundancy version identifier of the first carrier according to the first downlink resource control information.

When the number of carriers is at least 2, the network device may transmit a redundancy version identifier of at least one carrier to the terminal device. After receiving the redundancy version identifier of the at least one carrier, the terminal device determines the redundancy version of the transport block on the at least one carrier according to the redundancy version identifier of the at least one carrier. For example, when the number of carriers constituting one logical cell is 3, which are carrier 0, carrier 2 and carrier 4, respectively, the terminal device may receive redundancy version identifiers of carrier 0, carrier 2 and carrier 4. A redundancy version of the transport block for transmission on carrier 0 is determined according to the redundancy version identifier of carrier 0; a redundancy version of the transport block for transmission on carrier 2 is determined according to the redundancy version identifier of the carrier 2; and a redundancy version of the transport block for transmission on carrier 4 is determined according to the redundancy version identifier of carrier 4.

In a possible implementation, the redundancy version identifier of at least one carrier is carried in second downlink resource control information. The network device transmits the second downlink resource control information to the terminal device on at least one carrier, and after receiving the second downlink resource control information on the at least one carrier, the terminal device acquires a redundancy version identifier of the at least one carrier according to the second downlink resource control information.

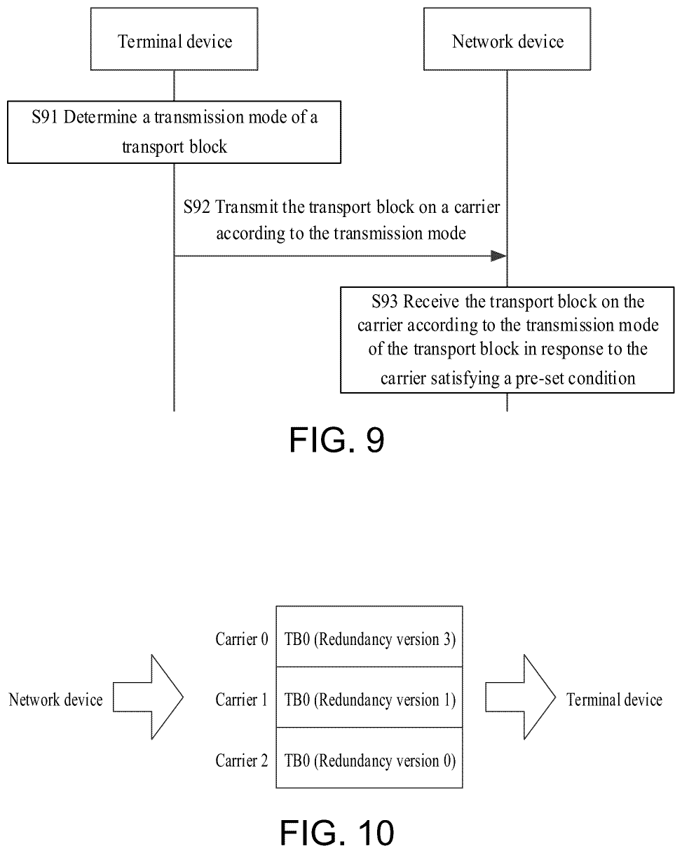

FIG. 9 is a second signaling schematic diagram showing a transmission method provided by an embodiment of the present application, and as shown in FIG. 9, the method includes:
S91: a terminal device determines a transmission mode of a transport block.

In a possible implementation, the number of carriers may be one or more.

The transmission mode of the transport block includes a complete transmission mode and a distributed transmission mode, and in a possible implementation, the complete transmission mode refers to that a transport block is completely transmitted on any one carrier. In contrast to a complete transmission mode, a distributed transmission mode refers to that for a transport block, only a partial code block group of the transport block is transmitted on any one carrier, i.e., when the distributed transmission mode is adopted, one transport block will be divided into at least one code block group, and different code block groups of the transport block are transmitted on different carriers, thereby realizing the transmission of all the code block groups of the transport block.

When the number of carriers is 1, the transport block can only be transmitted in a complete transmission mode on this carrier, and when the number of carriers is at least 2, the transport block can be transmitted in a complete transmission mode on at least one carrier or in a distributed transmission mode on at least one carrier.

Since the transmission mode of the transport block may be a complete transmission mode or a distributed transmission mode, the terminal device first determines the transmission mode of the transport block before receiving the transport block.

In a possible implementation, the terminal device determines the transmission mode of the transport block in response to the carrier satisfying a preset condition. In a possible implementation, the preset condition includes that the number of carriers is at least 2 and/or that the carriers are carries in the same logical cell.

In a possible implementation, the network device transmits a transmission mode indication parameter to the terminal device, the transmission mode indication parameter being used for indicating the transmission mode of the transport block.

In a possible implementation, the transmission mode indication parameter is carried in a system message and/or the transmission mode indication parameter is carried in first radio resource control signaling.

In a possible implementation, when the transmission mode indication parameter is carried in the system message, the network device transmits the system message to the terminal device, the system message including the transmission mode indication parameter. After receiving the system message from the network device, the terminal device acquires the transmission mode indication parameter according to the system message, and then determines the transmission mode of the transport block according to the transmission mode indication parameter.

In a possible implementation, the system message may be a SIB.

In a possible implementation, when the transmission mode indication parameter is carried in first radio resource control signaling, the network device transmits the first radio resource control signaling to the terminal device, where the first radio resource control signaling includes the transmission mode indication parameter. After receiving the first radio resource control signaling from the network device, the terminal device acquires the transmission mode indication parameter according to the first radio resource control signaling, and then determines the transmission mode of the transport block according to the transmission mode indication parameter.

In a possible implementation, the first radio resource control signaling may be an RRC message.

S92: the terminal device transmits the transport block on the carrier according to the transmission mode.

After determining the transmission mode of the transport block, the terminal device can transmit the transport block to the network device on the carrier.

In a possible implementation, the terminal device determines a redundancy version of the transport block for transmission on at least one carrier and then transmits the transport block on the carrier according to the redundancy version, the transmission mode of the transport block and the number of consecutive retransmissions of the transport block.

When the number of carriers is 1, the network device may transmit a redundancy version identifier on the carrier to the terminal device, and then the terminal device determines the redundancy version of the transport block on the carrier according to the redundancy version identifier.

When the number of carriers is at least 2, the network device may transmit a redundancy version identifier of the first carrier of the at least one carrier to the terminal device. After receiving the redundancy version identifier of the first carrier of the at least one carrier, the terminal device determines the redundancy version of the transport block for transmission on the at least one of the carriers according to the redundancy version identifier of the first carrier, the number of consecutive retransmissions and the transmission mode. For example, when the number of carriers constituting a logical cell is 3, respectively being carrier 0, carrier 2 and carrier 4, where carrier 0 is the first carrier among the 3 carriers, the terminal device can receive the redundancy version identifier of carrier 0, and determine the redundancy versions of the transport block on carrier 0, carrier 2 and carrier 4 according to the redundancy version identifier of carrier 0, the number of consecutive retransmissions and the transmission mode. In the present embodiment, an example is taken where carrier 0 is the first carrier, the terminal device may receive the redundancy version identifier of the first carrier via carrier 0. In other embodiments, the first carrier may also be carrier 2 or carrier 4, for example, when the first carrier is carrier 2, the terminal device may receive the redundancy version identifier of the first carrier via carrier 2, and the same applies when the first carrier is carrier 4.

In a possible implementation, the redundancy version identifier of the first carrier is carried in first downlink resource control information. The network device transmits the first downlink resource control information to the terminal device on a first carrier, and after receiving the first downlink resource control information on the first carrier, the terminal device acquires the redundancy version identifier of the first carrier according to the first downlink resource control information.

When the number of carriers is at least 2, the network device may transmit a redundancy version identifier of at least one carrier to the terminal device. After receiving the redundancy version identifier of the at least one carrier, the terminal device determines the redundancy version of the transport block on the at least one carrier according to the redundancy version identifier of the at least one carrier. For example, when the number of carriers constituting one logical cell is 3, which are carrier 0, carrier 2 and carrier 4, respectively, the terminal device may receive redundancy version identifiers of carrier 0, carrier 2 and carrier 4. A redundancy version of the transport block for transmission on carrier 0 is determined according to the redundancy version identifier of carrier 0; a redundancy version of the transport block for transmission on carrier 2 is determined according to the redundancy version identifier of the carrier 2; and a redundancy version of the transport block for transmission on carrier 4 is determined according to the redundancy version identifier of carrier 4.

In a possible implementation, the redundancy version identifier of the at least one carrier is carried in second downlink resource control information. The network device transmits second downlink resource control information to the terminal device on at least one carrier, and after receiving the second downlink resource control information on the at least one carrier, the terminal device acquires a redundancy version identifier of the at least one carrier according to the second downlink resource control information.

S93: the network device receives the transport block on the carrier according to the transmission mode of the transport block in response to the carrier satisfying a preset condition.

When a carrier satisfies a preset condition, a terminal device transmits a transport block to a network device according to a transmission mode of the transport block on the carrier, i.e., the terminal device performs PUSCH transmission for uplink traffic.

In a possible implementation, the preset condition includes that the number of carriers is at least 2 and/or that the carriers are carries in the same logical cell. When the number of carriers is at least 2, the network device may receive the transport block on the at least two carriers. The at least two carriers are carries in the same logical cell. When the network device receives the transport block on the at least two carriers, the network device may receive the transport block according to the transmission mode of the transport block.

In the embodiments described above, transmission of a transport block between a network device and a terminal device is described in connection with FIGS. 8 and 9. In the embodiments of the present application, transmission of a transport block on a carrier may mean transmitting the transport block on the carrier or receiving the transport block on the carrier. When “a terminal device transmitting a transport block on a carrier” represents receiving the transport block on the carrier, “a network device transmitting the transport block on the carrier” represents sending the transport block on the carrier (as illustrated in FIG. 8); when “a terminal device transmitting a transport block on a carrier” represents sending the transport block on the carrier, “a network device transmitting a transport block on a carrier” represents receiving the transport block on the carrier (as illustrated in FIG. 9). That is, the transmission method of the present application can be applied to both PDSCH transmission for downlink traffic and PUSCH transmission for uplink traffic. In the following embodiments, the PDSCH transmission for downlink traffic is described as an example, and it can be understood that the solution of the following embodiments can also be used for PUSCH transmission for uplink traffic.

Transmission of a transport block in different transmission modes will now be described with reference to the accompanying drawings.

First, the transmission of the transport block in the complete transmission mode is introduced.

When the transmission mode of the transport block is a complete transmission mode, for any one transmission slot, redundancy versions of the transport block for transmission on at least one carrier may be the same or different.

In a possible implementation, when the number of consecutive retransmissions is 1, redundancy versions of the transport block for transmission on at least one carrier are different. For example, when the number of carriers constituting the same logical cell is 3, in the same transmission slot, redundancy versions of the transport block for transmission on at least two carriers among the three carriers are different.

In a possible implementation, when the number of consecutive retransmissions is 1, the redundancy versions of the transport block for transmission on at least one carrier are the same. For example, when the number of carriers constituting the same logical cell is 3, in the same transmission slot, redundancy versions of the transport block for transmission on at least two carriers among the three carriers are the same.

In a possible implementation, when the number of consecutive retransmissions is greater than 1, the redundancy versions of the transport block for transmission on at least one carrier are different. For example, when the number of carriers is 3, in the same transmission slot, the redundancy versions of the transport block for transmission on at least two carriers among the three carriers are different.

These several possible implementations are described separately below.

Let the number of carriers constituting a logical cell be N, and N is a positive integer greater than or equal to 2. When the number of consecutive retransmissions is 1 (i.e., when the second radio resource control signaling includes an aggregation factor, and the aggregation factor pdsch-AggregationFactor=1, or when the second radio resource control signaling does not include an aggregation factor), a redundancy version of a transport block for transmission on at least one carrier satisfies a first preset condition.

In one implementation, the redundancy versions of the transport block for transmission on at least one carrier are different, and in this case, the first preset condition includes at least one of:
rv_{id}=0, if n mod 4=0, then rv1 is 0; if n mod 4=1, then the rv1 is 2; if n mod 4=2, then the rv1 is 3, and if n mod 4=3, then the rv1 is 1;
rv_{id}=2, if n mod 4=0, then the rv1 is 2; if n mod 4=1, then the rv1 is 3; if n mod 4=2, then the rv1 is 1, and if n mod 4=3, then the rv1 is 0;
rv_{id}=3, if n mod 4=0, then the rv1 is 3; if n mod 4=1, then the rv1 is 1; if n mod 4=2, then the rv1 is 0, and if n mod 4=3, then the rv1 is 2; and
rv_{id}=1, if n mod 4=0, then the rv1 is 1; if n mod 4=1, then the rv1 is 0; if n mod 4=2, then the rv1 is 2, and if n mod 4=3, then the rv1 is 3;
where rv_{id} is a redundancy version identifier of a first carrier of the at least one carrier, mod is a modulo operation, n is an integer greater than or equal to 0 and less than or equal to N−1, N is the number of carriers, and rv1 is a redundancy version of the transport block for transmission on carrier n.

The above-mentioned first preset condition may be expressed in the form of Table 1:

TABLE 1

| | |
|---|---|
| | Redundancy version of a transport |
| Redundancy version | block for transmission on carrier n |

| identifier rv_{id} of | n mod | n mod | n mod | n mod |
|---|---|---|---|---|
| the first carrier | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

When the transmission mode is a complete transmission mode and the number of consecutive retransmissions is 1, the transmission of a transport block can be achieved with only one transmission slot. In one implementation, the network device may transmit a redundancy version identifier, i.e., rv_{id}, of the first carrier of the N carriers to the terminal device. The terminal device then determines the redundancy version of the transport block for transmission on each carrier based on the redundancy version identifier rv_{id} of the first carrier. In another implementation, the network device may transmit the redundancy version identifiers of the N carriers to the terminal device, and the terminal device may then determine the redundancy versions of the transport block for transmission on the respective carriers based on the redundancy version identifier of each carrier.

When the transmission mode is a complete transmission mode and the number of consecutive retransmissions is 1, the network device may transmit a transport block to the terminal device on each carrier according to the redundancy version of the transport block for transmission on at least one carrier. The terminal device may receive the transport block transmitted by the network device on each carrier according to a redundancy version of the transport block for transmission on at least one carrier.

FIG. 10 is a first schematic diagram showing transmission of a transport block provided by an embodiment of the present application. As shown in FIG. 10, the number of carriers constituting a logical cell is 3, i.e., N=3, and these 3 carriers are carrier 0, carrier 1 and carrier 2, respectively. The number of consecutive retransmissions of a transport block is K=1, and the redundancy version identifier of the first carrier in DCI scheduling a PDSCH is rv_{id}=3.

According to rv_{id}=3, and Table 1, it can be determined that the transport block TB0 has a redundancy version of 3 for transmission on carrier 0 (0 mod 4=0), a redundancy version of 1 for transmission on carrier 1 (1 mod 4=1) and a redundancy version of 0 for transmission on carrier 2 (2 mod 4=2).

The case where rv_{id}=3 is illustrated in FIG. 10, and rv_{id} may have other values. For example, if rv_{id}=1, then transport block TB0 has a redundancy version of 1 for transmission on carrier 0, a redundancy version of 0 for transmission on carrier 1, and a redundancy version of 2 for transmission on carrier 2.

In a possible implementation, in another implementation, the transport block has the same redundancy version for transmission on at least one carrier, in which case the first preset condition is that the transport block has the same redundancy version for transmission on at least two carriers. For example, the carriers constituting a logical cell includes a carrier 0, a carrier 1 and a carrier 2, then redundancy versions of a transport block for transmission on the carrier 0 and the carrier 1 can be the same, and the redundancy version of the transport block for transmission on the carrier 2 is different from the redundancy versions for transmission on the carrier 0 and the carrier 1; for example, the redundancy versions of the transport block for transmission on carrier 1 and carrier 2 are the same; for example, the redundancy versions of the transport block for transmission on carrier 0 and carrier 2 are the same; for example, the redundancy versions of the transport block for transmission on carrier 0, carrier 1 and carrier 2 are the same.

In the solution of the embodiment of the present application, when the number of consecutive retransmissions is 1, since the number of carriers is at least 2, a transport block is repeatedly transmitted on different carriers on at least two carriers. By transmitting the transport block on each of the at least two carriers, the probability of successful transmission of the transport block can be increased, and thus the probability of HARQ retransmission of the transport block can be reduced, compared to transmitting the transport block on the carriers when the number of carriers is 1.

In the above-mentioned embodiment, a transmission solution of a transport block in the complete transmission mode when the number of consecutive retransmissions is 1 is described, and a transmission solution when the number of consecutive retransmissions is greater than 1 will be described below.

Let the number of carriers constituting a logical cell be N, and N is a positive integer greater than or equal to 2. When the number of consecutive retransmissions K is greater than 1 (i.e., when the second radio resource control signaling includes an aggregation factor, and the aggregation factor pdsch-AggregationFactor is greater than 1), according to the magnitude relationship between N and K, two cases would happen.

In the first case, if N is greater than or equal to K, then K repeated transmissions of a transport block would be achieved through only one transmission slot. In this case, the redundancy version of the transport block for transmission on the at least one carrier satisfies a second preset condition.

In a possible implementation, the second preset condition includes at least one of:
rv_{id}=0, if (n mod K) mod 4=0, then rv2 is 0; if (n mod K) mod 4=1, then the rv2 is 2; if (n mod K) mod 4=2, then the rv2 is 3, and (n mod K) mod 4=3, then the rv2 is 1;
rv_{id}=2, if (n mod K) mod 4=0, then the rv2 is 2; if (n mod K) mod 4=1, then the rv2 is 3; if (n mod K) mod 4=2, then the rv2 is 1, and if (n mod K) mod 4=3, then the rv2 is 0;
rv_{id}=3, if (n mod K) mod 4=0, then the rv2 is 3; if (n mod K) mod 4=1, then the rv2 is 1; if (n mod K) mod 4=2, then the rv2 is 0, and if (n mod K) mod 4=3, then the rv2 is 2; and
rv_{id}=1, if (n mod K) mod 4=0, then the rv2 is 1; if (n mod K) mod 4=1, then the rv2 is 0; if (n mod K) mod 4=2, then the rv2 is 2, and if (n mod K) mod 4, then the rv2 is 3;
where rv_{id} is a redundancy version identifier of a first carrier of the at least one carrier, mod is a modulo operation, and rv2 is a redundancy version of the transport block for transmission on carrier n;
n is an integer greater than or equal to 0 and less than or equal to N−1, or n is an integer greater than or equal to 0 and less than or equal to K−1.

The second preset condition may be expressed in the form of Table 2:

TABLE 2

| | Redundancy version of a transport | | | |
|---|---|---|---|---|
| Redundancy version | block for transmission on carrier n | | | |
| identifier rv_{id} of | (n mod K) | (n mod K) | (n mod K) | (n mod K) |
| the first carrier | mod 4 = 0 | mod 4 = 1 | mod 4 = 2 | mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Since when the number of consecutive retransmissions K is less than or equal to the number of carriers N, K retransmissions can be achieved by the first K carriers, and from the (K+1)^{th} carrier to the (N)^{th} carrier, the transport block can be retransmitted or not, for example, other transport block can be transmitted. When the (K+1)^{th} carrier to the (N)^{th} carrier are used for transmitting the transport block, the redundancy version(s) of the transport block for transmission on the (K+1)^{th} carrier to the (N)^{th} carrier may adopt the rule in Table 2 (i.e., satisfying the second preset condition), or may not adopt the rule in Table 2, for example, the redundancy version(s) of the transport block for transmission on the (K+1)^{th} carrier to the (N)^{th} carrier may be customized.

One implementation is to transmit a transport block on N carriers according to redundancy versions of the transport block for transmission on the N carriers, at this time, n in the second preset condition is an integer greater than or equal to 0 and less than or equal to N−1. In this implementation, the (K+1)^{th} carrier to the (N)^{th} carrier is/are also used for retransmitting the transport block, and the redundancy version(s) used for the (K+1)^{th} carrier to the (N)^{th} carrier transmission satisfies the rule shown in Table 2.

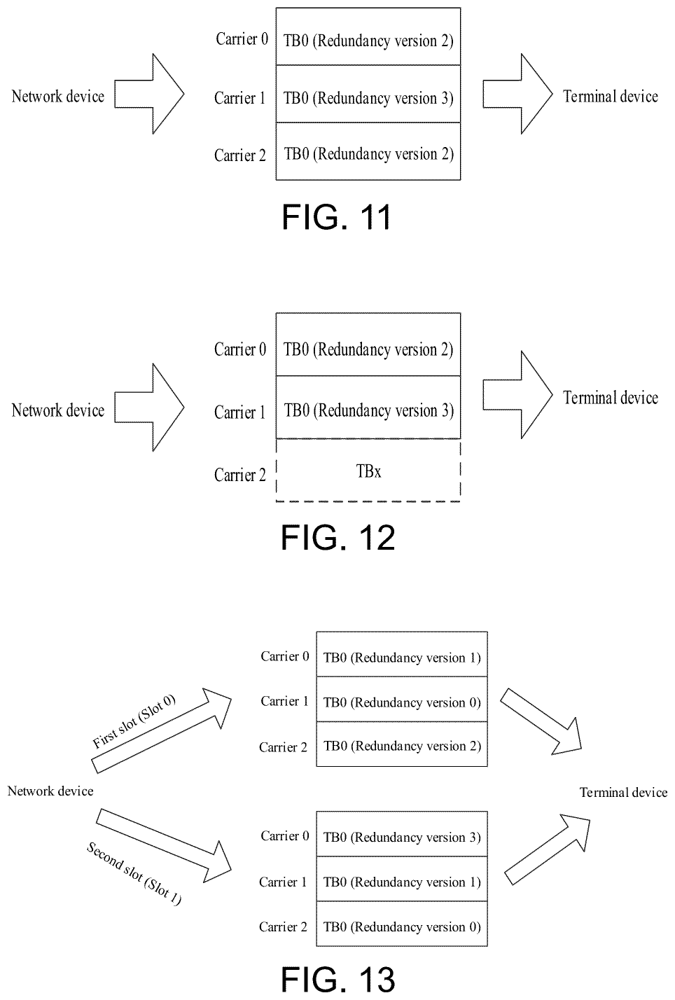

FIG. 11 is a second schematic diagram showing transmission of a transport block provided by an embodiment of the present application. As shown in FIG. 11, the number of carriers constituting a logical cell is 3, i.e., N=3, and these 3 carriers are carrier 0, carrier 1 and carrier 2, respectively. The number of consecutive retransmissions of a transport block is K=2, and the redundancy version identifier of the first carrier in DCI scheduling a PDSCH is rv_{id}=2.

From rv_{id}=2 and Table 2, it can be determined that transport block TB0 has a redundancy version of 2 for transmission on carrier 0 ((0 mod 2) mod 4=0), a redundancy version of 3 for transmission on carrier 1 ((1 mod 2) mod 4=1), and a redundancy version of 2 for transmission on carrier 2 ((2 mod 2) mod 4=0). Thus, the network device may transmit the TB0 on these 3 carriers to the terminal device, the redundancy version of the TB0 transmission on each carrier being as illustrated in FIG. 11.

The case where rv_{id}=2 is illustrated in FIG. 11, and rv_{id} may have other values. For example, if rv_{id}=1, then transport block TB0 has a redundancy version of 1 for transmission on carrier 0, a redundancy version of 0 for transmission on carrier 1, and a redundancy version of 2 for transmission on carrier 1.

The network device may transmit to the terminal device the redundancy version identifier of the first carrier among the 3 carriers, i.e., rv_{id}=2. Based on the redundancy version identifier of the first carrier, a redundancy version of the transport block for transmission on each carrier can be obtained. The network device may also transmit the redundancy version identifier of each carrier to the terminal device on each carrier, and the terminal device determines the redundancy version of the transport block on the corresponding carrier according to the redundancy version identifier of each carrier. No matter which of the above-mentioned two manners for indicating redundancy versions is selected by the network device, the redundancy version of the transport block for transmission on the carrier satisfies the above-mentioned second preset condition.

When the number of consecutive retransmissions is greater than 1, according to the provisions of the existing protocol, K times of transmission of a transport block needs to be achieved over K slots; and in a solution where multiple carriers constitute a logical cell and N is greater than or equal to K, K times of transmission of a transport block can be achieved by K or N carriers in one transmission slot, so that the number of repeated transmissions of a transport block is equally distributed over different carriers, thereby reducing the time length of repeated transmissions of a PDSCH on one carrier.

In a possible implementation, another implementation is to transmit a transport block on the first K carriers according to redundancy versions of the transport block for transmission on the first K carriers, at this time, n in the second preset condition is an integer greater than or equal to 0 and less than or equal to K−1. In this implementation, the (K+1)^{th} carrier to the N^{th} carrier is/are not used to retransmit the transport block. The (K+1)^{th} carrier to the N^{th} carrier may be used to transmit other transport block, or no transport block may be transmitted thereon, or any redundancy version of the transport block may be transmitted thereon.

FIG. 12 is a third schematic diagram showing transmission of a transport block provided by an embodiment of the present application. As shown in FIG. 12, the number of carriers constituting a logical cell is 3, i.e., N=3, and these 3 carriers are carrier 0, carrier 1 and carrier 2, respectively. The number of consecutive retransmissions of a transport block is K=2, and the redundancy version identifier of the first carrier in DCI scheduling a PDSCH is rv_{id}=2.

According to rv_{id}=2 and Table 2, it can be determined that the transport block TB0 has a redundancy version of 2 for transmission on carrier 0 and a redundancy version of 3 for transmission on carrier 1. Since K=2, i.e., the number of consecutive retransmissions is 2, two retransmissions can be achieved through carrier 0 and carrier 1 at this time. Thus, the network device may transmit the TB0 on these 2 carriers to the terminal device, the redundancy version of the TB0 transmission on each carrier being as illustrated in FIG. 12. Carrier 2 may not be used for transmitting the transport block TB0, e.g., may be used for transmitting other transport block, e.g., may not be used for transmitting any transport block, e.g., may also be used for transmitting the transport block TB0. As shown in FIG. 12, TBx may be transmitted on carrier 2, TBx may be TB0 or other transport block, and no transport block may be transmitted on carrier 2. When carrier 2 is used to transmit the transport block TB0, the redundancy version of TB0 for transmission on carrier 2 may be any one of redundancy version 1, redundancy version 2, redundancy version 3, and redundancy version 0.

When the number of consecutive retransmissions is greater than 1, K times of transmission of a transport block can be achieved through the first K carriers in one transmission slot, so that the number of repeated transmission times of a transport block is equally distributed over different carriers, thereby reducing the duration of repeated transmissions of a PDSCH on one carrier.

In the above-mentioned embodiments, a first case where the number of consecutive retransmissions is greater than 1 in a complete transmission mode, i.e., a case where N is greater than or equal to K, is described, and a second case where the number of consecutive retransmissions is greater than 1 in a complete transmission mode, i.e., a case where N is less than K, is described below.

In the second case, if N is less than K, K times of repeated transmission of the transport block needs to be achieved by using [K/N] transmission slots, and [K/N] represents a ceil of K/N (rounding up). For example, [3/2]=2, [8/3]=3 and the like. In this case, the redundancy version of the transport block for transmission on the at least one carrier satisfies a third preset condition.

In a possible implementation, the third preset condition includes at least one of.
rv_{id}=0, if (n+i*N) mod 4=0, then rv3 is 0; if (n+i*N) mod 4=1, then the rv3 is 2; if (n+i*N) mod 4=2, then the rv3 is 3, and (n+i*N) mod 4=3, then the rv3 is 1;
rv_{id}=2, if (n+i*N) mod 4=0, then rv3 is 2; if (n+i*N) mod 4=1, then the rv3 is 3; if (n+i*N) mod 4=2, then the rv3 is 1, and if (n+i*N) mod 4=3, then the rv3 is 0;
rv_{id}=3, if (n+i*N) mod 4=0, then rv3 is 3; if (n+i*N) mod 4=1, then rv3 is 1; if (n+i*N) mod 4=2, then the rv3 is 0, and if (n+i*N) mod 4=3, then the rv3 is 2; and
rv_{id}=1, if (n+i*N) mod 4=0, then rv3 is 1; if (n+i*N) mod 4=1, then the rv3 is 0; if (n+i*N) mod 4=2, then the rv3 is 2, and if (n+i*N) mod 4=3, then the rv3 is 3;
where rv_{id} is a redundancy version identifier of a first carrier of the at least one carrier, mod is a modulo operation, n is an integer greater than or equal to 0 and less than or equal to N−1, N is the number of carriers, and rv3 is a redundancy version of the transport block for transmission on carrier n in a transmission slot i;
when i is greater than or equal to 0 and less than or equal to ([K/N]−1), n is an integer greater than or equal to 0 and less than or equal to N−1; when i is equal to [K/N], n is an integer greater than or equal to 0 and less than or equal to N−1, or n is an integer greater than or equal to 0 and less than or equal to (K−[K/N]*N−1), [K/N] represents a ceil of K/N, [K/N] represents a floor of K/N (rounding down).

The third preset condition may be expressed in the form of Table 3:

TABLE 3

| | Redundancy version of a transport | | | |
|---|---|---|---|---|
| Redundancy version | block for transmission on carrier n | | | |
| identifier rv_{id} of | (n + i*N) | (n + i*N) | (n + i*N) | (n + i*N) |
| the first carrier | mod 4 = 0 | mod 4 = 1 | mod 4 = 2 | mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Since K retransmissions cannot be achieved in one transmission slot over N carriers when the number of consecutive retransmissions K is greater than the number of carriers N, at least [K/N] slots are required to achieve K retransmissions. When i is greater than or equal to 0 and less than or equal to ([K/N]−1), a transport block needs to be transmitted on N carriers, and n is an integer greater than or equal to 0 and less than or equal to N; when i is equal to [K/N], the transport block needs to be transmitted on the first (K−[K/N]*N) carriers or, on N carriers. That is, in the slot [K/N], from the (K−[K/N]*N+1)^{th} carrier (i.e., carrier (K−[K/N]*N)) to the N^{th} carrier (i.e., carrier (N−1)) may be used for retransmitting the transport block, or may not be used for retransmitting the transport block, for example, may be used for transmitting other transport block.

In the embodiment of the present application, transmission slot i is counted from 0. Taking K=8, N=3 as an example, 8 retransmissions are achieved over 3 carriers, for which at least [8/3]=3 slots are needed. When i is greater than or equal to 0 and less than or equal to 1 (i.e., ([K/N]−1)), the transport block needs to be transmitted on 3 carriers so that 6 retransmissions can be achieved on slot 0 and slot 1. When i is equal to 2 (i.e., [K/N]), the transport block may be transmitted on only the first (K−[K/N]*N)=2 carriers, i.e., carrier 0 to carrier 1 (i.e., K−[K/N]*N−1). The transport block may also be transmitted on N carriers when i equals 2 (i.e., [K/N]).

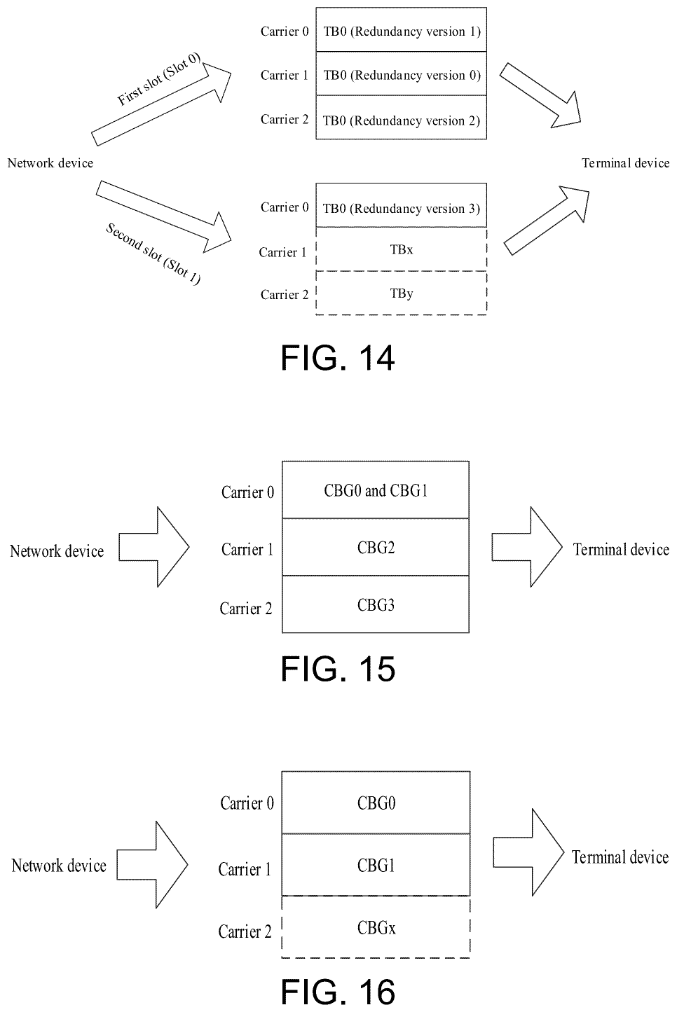

These two different implementations are described below with reference to FIGS. 13 and 14, and it is noted that the network device may transmit the redundancy version identifier of the first carrier among the N carriers to the terminal device, and the terminal device determines the redundancy version of the transport block on each carrier according to the redundancy version identifier of the first carrier. The network device may also transmit redundancy version identifiers of respective carriers to the terminal device on the respective carriers, and the terminal device determines the redundancy versions of the transport block on the respective carriers according to the redundancy version identifiers of the respective carriers. No matter which of the above-mentioned two indication manners is selected by the network device, the redundancy version of the transport block for transmission on the carrier satisfies the above-mentioned third preset condition. In the examples of FIG. 13 and FIG. 14, examples are taken where the network device transmits the redundancy version identifier of the first carrier.

One implementation is that for any one of [K/N] transmission slots, the transport block is transmitted on the N carriers according to a redundancy version of the transport block for transmission on at least one carrier in the transmission slot.

FIG. 13 is a fourth schematic diagram showing transmission of a transport block provided by an embodiment of the present application. As shown in FIG. 13, the number of carriers constituting a logical cell is 3, i.e., N=3, and these 3 carriers are carrier 0, carrier 1 and carrier 2, respectively. The number of consecutive retransmissions of a transport block is K=4, and the redundancy version identifier of the first carrier in DCI scheduling a PDSCH is rv_{id}=1.

According to rv_{id}=1 and Table 3, it can be determined that transport block TB0 has a redundancy version of 1 ((0+0*3) mod 4=0) for transmission in the first slot (i.e., slot 0) on carrier 0, a redundancy version of 0 ((1+0*3) mod 4=1) for transmission in the first slot on carrier 1, and a redundancy version of 2 ((2+0*3) mod 4=2) for transmission in the first slot on carrier 2. TB0 has a redundancy version of 3 ((0+1*3) mod 4=3) for transmission in the second slot (i.e., slot 1) on carrier 0, a redundancy version of 1 ((1+1*3) mod 4=0) for transmission in the second slot on carrier 1, and a redundancy version of 0 ((2+1*3) mod 4=1) for transmission in the second slot on carrier 2.

In a possible implementation, another implementation is that for any one of the first ([K/N]−1 transmission slots, the transport block is transmitted on the N carriers according to a redundancy version of the transport block for transmission on at least one carrier in the transmission slot; for the ([K/N])^{th} transmission slot, the transport block is transmitted on the first (K−[K/N]*N) carrier(s) according to redundancy version(s) of the transport block for transmission on the first (K−[K/N]*N) carrier(s) in the transmission slot.

FIG. 14 is a fifth schematic diagram showing transmission of a transport block provided by an embodiment of the present application. As shown in FIG. 14, the number of carriers constituting a logical cell is 3, i.e., N=3, and these 3 carriers are carrier 0, carrier 1 and carrier 2, respectively. The number of consecutive retransmissions of a transport block is K=4, and the redundancy version identifier of the first carrier in DCI scheduling a PDSCH is rv_{id}=1.

According to rv_{id}=1 and Table 3, it can be determined that transport block TB0 has a redundancy version of 1 ((0+0*3) mod 4=0) for transmission in the first slot (i.e., slot 0) on carrier 0, a redundancy version of 0 ((1+0*3) mod 4=1) for transmission in the first slot on carrier 1, and a redundancy version of 2 ((2+0*3) mod 4=2) for transmission in the first slot on carrier 2. TB0 has a redundancy version of 3 ((0+1*3) mod 4=3) for transmission in the second slot (i.e., slot 1) on carrier 0, and no TB0 is transmitted in the second slot on carrier 1 and in the second slot on carrier 2. In the second slot, carrier 1 and carrier 2 may or may not be used to transmit other transport block(s).

For example, in FIG. 14, in the second slot, carrier 1 may be used for transmitting a TBx, or may not be used for transmitting any transport block, TBx may be TB0, and may also be other transport block, and the redundancy version of TBx for transmission on carrier 1 may be any one of redundancy version 1, redundancy version 2, redundancy version 3 and redundancy version 0; in the second slot, carrier 2 may be used for transmitting TBy or may not be used for transmitting any transport block, TBy may be TB0 or other transport block, and the redundancy version of TBy for transmission on carrier 1 may be any one of redundancy version 1, redundancy version 2, redundancy version 3 and redundancy version 0.

In order to achieve 4 repeated transmissions on a single carrier, 4 transmission slots are required; and in the solution of the present application, compared with a solution of transmitting a transport block on a single carrier, the number of repeated transmissions is equally distributed over different carriers, so that only 2 transmission slots are required to achieve 4 repeated transmissions.

When the number of consecutive retransmissions is greater than 1, K slots are needed to achieve K transmissions on a single carrier, and in the solution of the present application, for N carriers constituting a logical cell, K transmissions of a transport block can be achieved via N carriers, so that the number of repeated transmissions of a transport block is equally distributed over different carriers, thereby reducing the time length of repeated transmissions of a PDSCH on a carrier.

In the above embodiment, the transmission solution of the transport block when the transmission mode is the complete transmission mode is described, and the transmission solution when the transmission mode is the distributed transmission mode will be described below.

When the transmission mode is a distributed transmission mode, the terminal device may determine index(es) of code block group(s) for transmission on at least one carrier according to the number of code block groups and the number of carriers included in the transport block.

In a possible implementation, the number of code block groups included in the transport block is a smaller one of a real number of code blocks in the transport block and the maximum number of code block groups in the transport block permitted by a protocol.

For any one of K transmission slots, transmitting at least one code block group of the transport block on at least one carrier according to the redundancy version of the transport block for transmission on the at least one carrier and the index of the code block group.

In a possible implementation, the transmission mode is the distributed transmission mode; the redundancy version of the transport block for transmission on at least one carrier and a transmission slot i satisfy a fourth preset condition.

In a possible implementation, the fourth preset condition includes at least one of:
rv_{id}=0, if i mod 4=0, then rv4 is 0; if i mod 4=1, then the rv4 is 2; if i mod 4=2, then the rv4 is 3, and if i mod 4=3, then the rv4 is 1;
rv_{id}=2, if i mod 4=0, then rv4 is 2; if i mod 4=1, then the rv4 is 3; if i mod 4=2, then the rv4 is 1, and if i mod 4=3, then the rv4 is 0;
rv_{id}=3, if i mod 4=0, then rv4 is 3; if i mod 4=1, then the rv4 is 1; if i mod 4=2, then the rv4 is 0, and if i mod 4=3, then the rv4 is 2; and
rv_{id}=1, if i mod 4=0, then rv4 is 1; if i mod 4=1, then the rv4 is 0; if i mod 4=2, then the rv4 is 2, and if i mod 4=3, then the rv4 is 3;
where rv_{id} is a redundancy version identifier of a first carrier in at least one carrier, mod is a modulo operation, i is an integer greater than or equal to 0 and less than or equal to K−1, K is the number of consecutive retransmissions, and rv4 is a redundancy version of a transport block for transmission on the at least one carrier in a transmission slot i.

The fourth preset condition may be expressed in the form of Table 4:

TABLE 4

| | Redundancy version of a transport block for | | | |
|---|---|---|---|---|
| Redundancy version | transmission on each carrier in a transmission slot i | | | |
| identifier rv_{id} of | i mod | i mod | i mod | i mod |
| the first carrier | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Since a transport block can be divided into at least one code block group for transmission, only one transmission of the transport block can be achieved over one transmission slot. If the number of consecutive retransmissions is greater than 1, for example, when the number of consecutive retransmissions is K, K slots are needed to achieve the transmission of a transport block. In a possible implementation, for any one transmission slot i, the redundancy version of the transport block for transmission on the carrier in the transmission slot i is determined according to a fourth preset condition.

In a possible implementation, the index of the code block group for transmission on at least one carrier satisfies a fifth preset condition.

In a possible implementation, the fifth preset condition includes:
when M is greater than N, n∈{0, 1, . . . , T₁−1}, an index of a code block group for transmission on carrier n is (n*N₁+k₁), k₁=0, 1, . . . , N₁−1; when n∈{T₁, T₁+1, . . . , N−1}, an index of a code block group for transmission on carrier n is (T₁*N₁+(n−T₁)N₂+k₂), k₂=0, . . . , N₂−1, where n is greater than or equal to 0 and less than or equal to N−1; and/or,
when M is less than or equal to N, an index of a code block group for transmission on carrier n is n, and n is greater than or equal to 0 and less than M;
where M is the number of code block groups included in the transport block, M is a positive integer greater than or equal to 1, N is the number of carriers, and N is a positive integer greater than or equal to 2, T₁=M mod N, N₁=[M/N], N₂=[M/N], [M/N] represents a ceil of M/N, and [M/N] represents a floor of M/N.

FIG. 15 is a sixth schematic diagram showing transmission of a transport block provided by an embodiment of the present application. As shown in FIG. 15, the number of carriers constituting a logical cell is 3, i.e., N=3, the 3 carriers are divided into carrier 0, carrier 1 and carrier 2, the real number of code blocks included in TB0 is 7, and the maximum number of CBGs configured by a high layer parameter maxCodeBlockGroupPerTransportBlock is 4, then the number of CBGs that can be transmitted by one TB is M=min (N, C)=4.

T₁=4 mod 3=1, N₁=[M/N]=2, N₂=[M/N]=1. According to the fifth preset condition, when n∈{0, 1, . . . , T₁−1} (i.e., n∈{0}), the index of the code block group for transmission on carrier 0 is (n*N₁+k₁)=(0*2+k₁), k₁=0, 1, . . . , N₁−1=0, 1, then CBG 0 and CBG 1 for constituting TB0 are transmitted on carrier 0. When n∈{T₁, T₁+1, . . . , N−1} (i.e., n∈{1, 2}), the index of the code block group for transmission on carrier n is (T₁*N₁+(n−T₁)N₂+k₂)=(1*2+(n−1)1+0)=n+1, CBG 2 for constituting TB0 is transmitted on carrier 1, and CBG3 for constituting TB0 is transmitted on carrier 2, as shown in FIG. 15.

FIG. 16 is a seventh schematic diagram showing transmission of a transport block provided by an embodiment of the present application. As shown in FIG. 16, the number of carriers constituting a logical cell is 3, i.e., N=3, the 3 carriers are divided into carrier 0, carrier 1 and carrier 2, the real number of code blocks included in TB0 is 7, and the maximum number of CBGs configured by a high layer parameter maxCodeBlockGroupsPerTransportBlock is 2, then the number of CBGs that can be transmitted by one TB is M=min(N, C)=2.

According to the fifth preset condition, if an index of a code block group for transmission on carrier n is n, then CBG 0 for constituting TB0 is transmitted on carrier 0, CBG 1 for constituting TB0 is transmitted on carrier 1, and TB0 may not be transmitted on carrier 2, for example, carrier 2 may be used for transmitting other TB, for example, carrier 2 may not be used for transmitting any transport block. As shown in FIG. 16, carrier 2 may be used for transmitting CBGx, or may not be used for transmitting any code block group, CBGx may be CBG0 or CBG1 for constituting TB0, or CBG for constituting other transport block.

In the solution of an embodiment of the present application, a transport block with an excessive number of bits can be split and transmitted on different carriers to reduce the transmission bit rate on each carrier, thereby improving the success rate of the terminal device demodulating data of the code block group and successfully receiving the transport block.

If the number of carriers is 1, then the transmission mode of the transport block is a complete transmission mode, and the redundancy version of the transport block for transmission on the carrier is as shown in Table 5:

TABLE 5

| | Redundancy version of a transport block for | | | |
|---|---|---|---|---|
| Redundancy version | transmission on the i^{th} transmission slot | | | |
| identifier rv_{id} of | i mod | i mod | i mod | i mod |
| carrier | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

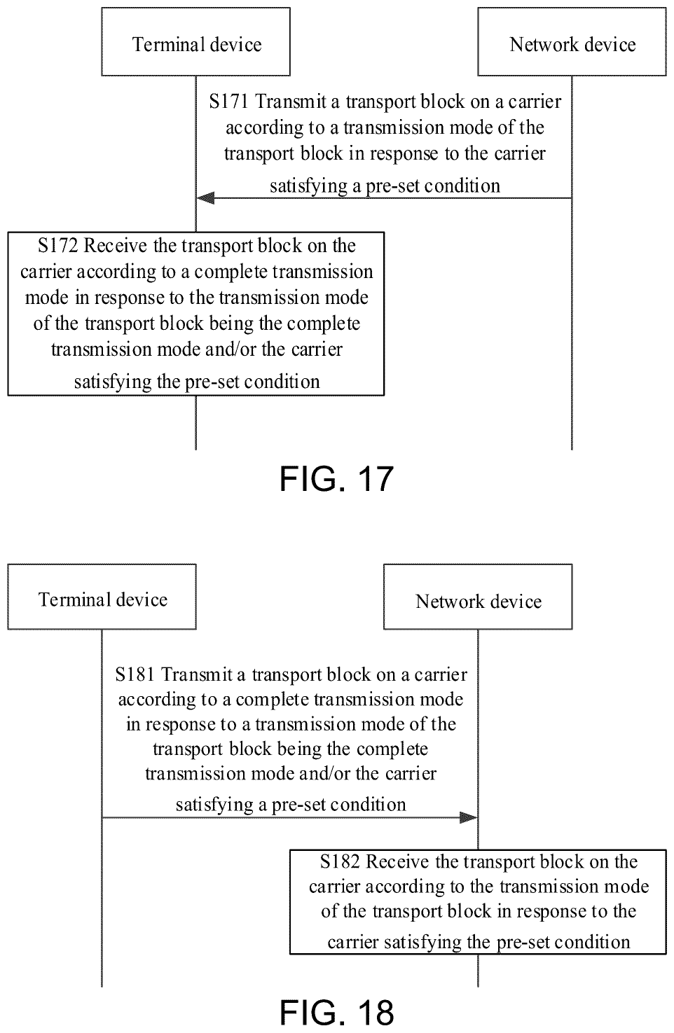

FIG. 17 is a third signaling schematic diagram showing a transmission method provided by an embodiment of the present application, and as shown in FIG. 17, the method includes:
S171: a network device transmits a transport block on a carrier according to a transmission mode of the transport block in response to the carrier satisfying a preset condition.

In a possible implementation, the number of carriers may be one or more.

The transmission mode of the transport block includes a complete transmission mode and a distributed transmission mode, and in a possible implementation, the complete transmission mode refers to that a transport block is completely transmitted on any one carrier. In contrast to a complete transmission mode, a distributed transmission mode refers to that for a transport block, only a partial code block group of the transport block is transmitted on any one carrier, i.e., when the distributed transmission mode is adopted, one transport block will be divided into at least one code block group, and different code block groups of the transport block are transmitted on different carriers, thereby realizing the transmission of all the code block groups of the transport block.

When the number of carriers is 1, the transport block can only be transmitted in a complete transmission mode on this carrier, and when the number of carriers is at least 2, the transport block can be transmitted in a complete transmission mode on at least one carrier or in a distributed transmission mode on at least one carrier.

When the carrier satisfies a preset condition, the network device may transmit the transport block to the terminal device on the carrier according to the transmission mode of the transport block, i.e., the network device may perform PDSCH transmission for downlink traffic.

In a possible implementation, the preset condition includes that the number of carriers is at least 2 and/or that the carriers are carriers in the same logical cell. When the number of carriers is at least 2, the network device may transmit the transport block on the at least two carriers. The at least two carriers are carriers in the same logical cell. When the network device transmits a transport block to the terminal device on the at least two carriers, the network device can select a complete transmission mode or a distributed transmission mode for transmission.

S172: the terminal device receives the transport block on the carrier according to the complete transmission mode in response to the transmission mode of the transport block being the complete transmission mode and/or the carrier satisfying the preset condition.

Since the transmission mode of the transport block may be a complete transmission mode or a distributed transmission mode, the terminal device first determines the transmission mode of the transport block before receiving the transport block.

In a possible implementation, the terminal device determines the transmission mode of the transport block in response to the carrier satisfying a preset condition. In a possible implementation, the preset condition includes that the number of carriers is at least 2 and/or that the carriers are carries in the same logical cell.

In a possible implementation, the network device transmits a transmission mode indication parameter to the terminal device, the transmission mode indication parameter being used for indicating the transmission mode of the transport block.

In a possible implementation, the transmission mode indication parameter is carried in a system message and/or the transmission mode indication parameter is carried in first radio resource control signaling.

In a possible implementation, the system message may be a SIB.

In a possible implementation, the first radio resource control signaling may be an RRC message.

In a possible implementation, when the transmission mode indication parameter is carried in the system message, the network device transmits the system message to the terminal device, the system message including the transmission mode indication parameter. After receiving the system message from the network device, the terminal device acquires the transmission mode indication parameter according to the system message, and then determines the transmission mode of the transport block according to the transmission mode indication parameter.

In a possible implementation, when the transmission mode indication parameter is carried in first radio resource control signaling, the network device transmits the first radio resource control signaling to the terminal device, where the first radio resource control signaling includes the transmission mode indication parameter. After receiving the first radio resource control signaling from the network device, the terminal device acquires the transmission mode indication parameter according to the first radio resource control signaling, and then determines the transmission mode of the transport block according to the transmission mode indication parameter.

In a possible implementation, in an embodiment of the present application, the transmission mode is a complete transmission mode.

FIG. 18 is a fourth signaling schematic diagram showing a transmission method provided by an embodiment of the present application, and as shown in FIG. 18, the method includes:
S181: a terminal device transmits a transport block on a carrier according to a complete transmission mode in response to a transmission mode of the transport block being the complete transmission mode and/or the carrier satisfying a preset condition.

In a possible implementation, the number of carriers may be one or more.

The transmission mode of the transport block includes a complete transmission mode and a distributed transmission mode, and in a possible implementation, the complete transmission mode refers to that a transport block is completely transmitted on any one carrier. In contrast to a complete transmission mode, a distributed transmission mode refers to that for a transport block, only a partial code block group of the transport block is transmitted on any one carrier, i.e., when the distributed transmission mode is adopted, one transport block will be divided into at least one code block group, and different code block groups of the transport block are transmitted on different carriers, thereby realizing the transmission of all the code block groups of the transport block.

When the number of carriers is 1, the transport block can only be transmitted in a complete transmission mode on this carrier, and when the number of carriers is at least 2, the transport block can be transmitted in a complete transmission mode on at least one carrier or in a distributed transmission mode on at least one carrier.

Since the transmission mode of the transport block may be a complete transmission mode or a distributed transmission mode, the terminal device first determines the transmission mode of the transport block before transmitting the transport block.

In a possible implementation, the terminal device determines the transmission mode of the transport block in response to the carrier satisfying a preset condition. In a possible implementation, the preset condition includes that the number of carriers is at least 2 and/or that the carriers are carries in the same logical cell.

In a possible implementation, the network device transmits a transmission mode indication parameter to the terminal device, the transmission mode indication parameter being used for indicating the transmission mode of the transport block.

In a possible implementation, the transmission mode indication parameter is carried in a system message and/or the transmission mode indication parameter is carried in first radio resource control signaling.

In a possible implementation, the system message may be a SIB.

In a possible implementation, the first radio resource control signaling may be an RRC message.

In a possible implementation, when the transmission mode indication parameter is carried in the system message, the network device transmits the system message to the terminal device, the system message including the transmission mode indication parameter. After receiving the system message from the network device, the terminal device acquires the transmission mode indication parameter according to the system message, and then determines the transmission mode of the transport block according to the transmission mode indication parameter.

In a possible implementation, when the transmission mode indication parameter is carried in first radio resource control signaling, the network device transmits the first radio resource control signaling to the terminal device, where the first radio resource control signaling includes the transmission mode indication parameter. After receiving the first radio resource control signaling from the network device, the terminal device acquires the transmission mode indication parameter according to the first radio resource control signaling, and then determines the transmission mode of the transport block according to the transmission mode indication parameter.

In a possible implementation, in an embodiment of the present application, the transmission mode is a complete transmission mode.

S182: the network device receives the transport block on the carrier according to the transmission mode of the transport block in response to the carrier satisfying the preset condition.

When the carrier satisfies a preset condition, the network device may receive the transport block on the carrier according to the transmission mode of the transport block, i.e., the network device may perform PUSCH transmission for uplink traffic.

In a possible implementation, the preset condition includes that the number of carriers is at least 2 and/or that the carriers are carries in the same logical cell. When the number of carriers is at least 2, the network device may receive the transport block on the at least two carriers. The at least two carriers are carries in the same logical cell. When the network device receives the transport block on the at least two carriers, the network device can select a complete transmission mode or a distributed transmission mode for the reception.

The transmission of a transport block between a network device and a terminal device via a complete transmission mode is described in connection with the embodiments of FIGS. 17 and 18. In the embodiments of the present application, transmission of a transport block on a carrier may mean transmitting the transport block on the carrier or receiving the transport block on the carrier. When “a terminal device transmitting a transport block on a carrier” represents receiving the transport block on the carrier, “a network device transmitting the transport block on the carrier” represents sending the transport block on the carrier (as illustrated in FIG. 17); when “a terminal device transmitting a transport block on a carrier” represents sending the transport block on the carrier, “a network device transmitting a transport block on a carrier” represents receiving the transport block on the carrier (as illustrated in FIG. 18). That is, the transmission method of the present application can be applied to both PDSCH transmission for downlink traffic and PUSCH transmission for uplink traffic. In the following embodiments, the PDSCH transmission for downlink traffic is described as an example, and it can be understood that the solution of the following embodiments can also be used for PUSCH transmission for uplink traffic.

In a possible implementation, the terminal device determines a redundancy version of the transport block for transmission on at least one carrier and then receives the transport block on the carrier according to the redundancy version, the transmission mode of the transport block and the number of consecutive retransmissions of the transport block.

When the number of carriers is 1, the network device may transmit a redundancy version identifier to the terminal device on the carrier, and then the terminal device determines the redundancy version of the transport block on the carrier according to the redundancy version identifier.

When the number of carriers is at least 2, the network device may transmit a redundancy version identifier of the first carrier of the at least one carrier to the terminal device. After receiving the redundancy version identifier of the first carrier of the at least one carrier, the terminal device determines the redundancy version of the transport block for transmission on the at least one carrier according to the redundancy version identifier of the first carrier, the number of consecutive retransmissions and the transmission mode. For example, when the number of carriers constituting a logical cell is 3, respectively being carrier 0, carrier 2 and carrier 4, where carrier 0 is the first carrier among the 3 carriers, the terminal device can receive the redundancy version identifier of carrier 0, and determine the redundancy versions of the transport block on carrier 0, carrier 2 and carrier 4 according to the redundancy version identifier of carrier 0, the number of consecutive retransmissions and the transmission mode. In the present embodiment, an example is taken where carrier 0 is the first carrier, the terminal device may receive the redundancy version identifier of the first carrier via carrier 0. In other embodiments, the first carrier may also be carrier 2 or carrier 4, for example, when the first carrier is carrier 2, the terminal device may receive the redundancy version identifier of the first carrier via carrier 2, and the same applies when the first carrier is carrier 4.

In a possible implementation, the redundancy version identifier of the first carrier is carried in first downlink resource control information. The network device transmits the first downlink resource control information to the terminal device on a first carrier, and after receiving the first downlink resource control information on the first carrier, the terminal device acquires the redundancy version identifier of the first carrier according to the first downlink resource control information.

When the number of carriers is at least 2, the network device may transmit a redundancy version identifier of at least one carrier to the terminal device. After receiving the redundancy version identifier of the at least one carrier, the terminal device determines the redundancy version of the transport block on the at least one carrier according to the redundancy version identifier of the at least one carrier. For example, when the number of carriers constituting one logical cell is 3, which are carrier 0, carrier 2 and carrier 4, respectively, the terminal device may receive redundancy version identifiers of carrier 0, carrier 2 and carrier 4. A redundancy version of the transport block for transmission on carrier 0 is determined according to the redundancy version identifier of carrier 0; a redundancy version of the transport block for transmission on carrier 2 is determined according to the redundancy version identifier of the carrier 2; and a redundancy version of the transport block for transmission on carrier 4 is determined according to the redundancy version identifier of carrier 4.

In a possible implementation, the redundancy version identifier of at least one carrier is carried in second downlink resource control information. The network device transmits the second downlink resource control information to the terminal device on at least one carrier, and after receiving the second downlink resource control information on the at least one carrier, the terminal device acquires a redundancy version identifier of the at least one carrier according to the second downlink resource control information.

When the transmission mode of the transport block is a complete transmission mode, for any one transmission slot, redundancy versions of the transport block for transmission on at least one carrier may be the same or different.

In a possible implementation, when the number of consecutive retransmissions is 1, redundancy versions of the transport block for transmission on at least one carrier are different. For example, when the number of carriers constituting the same logical cell is 3, in the same transmission slot, redundancy versions of the transport block for transmission on at least two carriers among the three carriers are different.

In a possible implementation, when the number of consecutive retransmissions is 1, the redundancy versions of the transport block for transmission on at least one carrier are the same. For example, when the number of carriers constituting the same logical cell is 3, in the same transmission slot, redundancy versions of the transport block for transmission on at least two carriers among the three carriers are the same.

In a possible implementation, when the number of consecutive retransmissions is greater than 1, the redundancy versions of the transport block for transmission on at least one carrier are different. For example, when the number of carriers is 3, in the same transmission slot, the redundancy versions of the transport block for transmission on at least two carriers among the three carriers are different.

These several possible implementations are described separately below.

Let the number of carriers constituting a logical cell be N, and N is a positive integer greater than or equal to 2. When the number of consecutive retransmissions is 1 (i.e., when the second radio resource control signaling includes an aggregation factor, and the aggregation factor pdsch-AggregationFactor=1, or when the second radio resource control signaling does not include an aggregation factor), a redundancy version of a transport block for transmission on at least one carrier satisfies a first preset condition.

In one implementation, the redundancy versions of the transport block for transmission on the at least one carrier are different, and in this case, the first preset condition includes at least one of:
rv_{id}=0, if n mod 4=0, then rv1 is 0; if n mod 4=1, then the rv1 is 2; if n mod 4=2, then the rv1 is 3, and if n mod 4=3, then the rv1 is 1;
rv_{id}=2, if n mod 4=0, then the rv1 is 2; if n mod 4=1, then the rv1 is 3; if n mod 4=2, then the rv1 is 1, and if n mod 4=3, then the rv1 is 0;
rv_{id}=3, if n mod 4=0, then rv1 is 3; if n mod 4=1, then the rv1 is 1; if n mod 4=2, then the rv1 is 0, and if n mod 4=3, then the rv1 is 2; and
rv_{id}=1, if n mod 4=0, then rv1 is 1; if n mod 4=1, then the rv1 is 0; if n mod 4=2, then the rv1 is 2, and if n mod 4=3, then the rv1 is 3;
where rv_{id} is a redundancy version identifier of a first carrier of the at least one carrier, mod is a modulo operation, the n is an integer greater than or equal to 0 and less than or equal to N−1, N is the number of the carriers, and the rv1 is a redundancy version of the transport block for transmission on carrier n.

When the transmission mode is a complete transmission mode and the number of consecutive retransmissions is 1, the transmission of a transport block can be achieved with only one transmission slot. In one implementation, the network device may transmit a redundancy version identifier, i.e., rv_{id}, of the first carrier of the N carriers to the terminal device. The terminal device then determines the redundancy version of the transport block for transmission on each carrier based on the redundancy version identifier rv_{id} of the first carrier. In another implementation, the network device may transmit the redundancy version identifiers of the N carriers to the terminal device, and the terminal device may then determine the redundancy versions of the transport block for transmission on the respective carriers based on the redundancy version identifier of each carrier.

When the transmission mode is a complete transmission mode and the number of consecutive retransmissions is 1, the network device may transmit a transport block to the terminal device on each carrier according to the redundancy version of the transport block for transmission on at least one carrier. The terminal device may receive the transport block transmitted by the network device on each carrier according to a redundancy version of the transport block for transmission on at least one carrier.

For example, in FIG. 10, a case where the number of carriers constituting the logical cell is 3, i.e., N=3, and the 3 carriers are divided into carrier 0, carrier 1, and carrier 2 is illustrated. The number of consecutive retransmissions of a transport block is K=1, and the redundancy version identifier of the first carrier in DCI scheduling a PDSCH is rv_{id}=3.

According to rv_{id}=3 and Table 1, it can be determined that the transport block TB0 has a redundancy version of 3 for transmission on carrier 0 (0 mod 4=0), a redundancy version of 1 for transmission on carrier 1 (1 mod 4=1) and a redundancy version of 0 for transmission on carrier 2 (2 mod 4=2).

In a possible implementation, in another implementation, the transport block has the same redundancy version for transmission on at least one carrier, in which case the first preset condition is that the transport block has the same redundancy version for transmission on at least two carriers. For example, the carriers constituting a logical cell includes a carrier 0, a carrier 1 and a carrier 2, then redundancy versions of a transport block for transmission on the carrier 0 and the carrier 1 can be the same, and the redundancy version of the transport block for transmission on the carrier 2 is different from the redundancy versions for transmission on the carrier 0 and the carrier 1; for example, the redundancy versions of the transport block for transmission on carrier 1 and carrier 2 are the same; for example, the redundancy versions of the transport block for transmission on carrier 0 and carrier 2 are the same; for example, the redundancy versions of the transport block for transmission on carrier 0, carrier 1 and carrier 2 are the same.

In the solution of the embodiment of the present application, when the number of consecutive retransmissions is 1, since the number of carriers is at least 2, a transport block is repeatedly transmitted on different carriers on at least two carriers. By transmitting the transport block on each of the at least two carriers, the probability of successful transmission of the transport block can be increased, and thus the probability of HARQ retransmission of the transport block can be reduced, compared to transmitting the transport block on the carriers when the number of carriers is 1.

In the above-mentioned embodiment, a transmission solution of a transport block in the complete transmission mode when the number of consecutive retransmissions is 1 is described, and a transmission solution when the number of consecutive retransmissions is greater than 1 will be described below.

Let the number of carriers constituting a logical cell be N, and N is a positive integer greater than or equal to 2. When the number of consecutive retransmissions K is greater than 1 (i.e., when the second radio resource control signaling includes an aggregation factor, and the aggregation factor pdsch-AggregationFactor is greater than 1), according to the magnitude relationship between N and K, two cases would happen.

In the first case, if N is greater than or equal to K, then K repeated transmissions of a transport block would be achieved through only one transmission slot. In this case, the redundancy version of the transport block for transmission on the at least one carrier satisfies a second preset condition.

In a possible implementation, the second preset condition includes at least one of:
rv_{id}=0, if (n mod K) mod 4=0, then rv2 is 0; if (n mod K) mod 4=1, then the rv2 is 2; if (n mod K) mod 4=2, then the rv2 is 3, and (n mod K) mod 4=3, then the rv2 is 1;
rv_{id}=2, if (n mod K) mod 4=0, then the rv2 is 2; if (n mod K) mod 4=1, then the rv2 is 3; if (n mod K) mod 4=2, then the rv2 is 1, and if (n mod K) mod 4=3, then the rv2 is 0;
rv_{id}=3, if (n mod K) mod 4=0, then the rv2 is 3; if (n mod K) mod 4=1, then the rv2 is 1; if (n mod K) mod 4=2, then the rv2 is 0, and if (n mod K) mod 4=3, then the rv2 is 2; and
rv_{id}=1, if (n mod K) mod 4=0, then the rv2 is 1; if (n mod K) mod 4=1, then the rv2 is 0; if (n mod K) mod 4=2, then the rv2 is 2, and if (n mod K) mod 4, then the rv2 is 3;
where rv_{id} is a redundancy version identifier of a first carrier of the at least one carrier, mod is a modulo operation, and rv2 is a redundancy version of the transport block for transmission on carrier n;
n is an integer greater than or equal to 0 and less than or equal to N−1, or n is an integer greater than or equal to 0 and less than or equal to K−1.

Since when the number of consecutive retransmissions K is less than or equal to the number of carriers N, K retransmissions can be achieved by the first K carriers, and from the (K+1)^{th} carrier to the (N)^{th} carrier, the transport block can be retransmitted or not, for example, other transport block can be transmitted. When the (K+1)^{th} carrier to the (N)^{th} carrier is/are used for transmitting the transport block, the redundancy version(s) of the transport block for transmission on the (K+1)^{th} carrier to the (N)^{th} carrier may adopt the rule in Table 2 (i.e., satisfying the second preset condition), or may not adopt the rule in Table 2, for example, the redundancy version(s) of the transport block for transmission on the (K+1)^{th} carrier to the (N)^{th} carrier may be customized.

One implementation is to transmit a transport block on N carriers according to redundancy versions of the transport block for transmission on the N carriers, at this time, n in the second preset condition is an integer greater than or equal to 0 and less than or equal to N−1. In this implementation, the (K+1)^{th} carrier to the (N)^{th} carrier is/are also used for retransmitting the transport block, and the redundancy version(s) used for the (K+1)^{th} carrier to the (N)^{th} carrier transmission satisfies the rule shown in Table 2.

For example, in FIG. 11, the number of carriers constituting one logical cell is 3, i.e., N=3, and the 3 carriers are divided into carrier 0, carrier 1, and carrier 2. The number of consecutive retransmissions of a transport block is K=2, and the redundancy version identifier of the first carrier in the DCI scheduling the PDSCH is rv_{id}=2.

From rv_{id}=2 and Table 2, it can be determined that transport block TB0 has a redundancy version of 2 for transmission on carrier 0 ((0 mod 2) mod 4=0), a redundancy version of 3 for transmission on carrier 1 ((1 mod 2) mod 4=1), and a redundancy version of 2 for transmission on carrier 2 ((2 mod 2) mod 4=0). Thus, the network device may transmit the TB0 on these 3 carriers to the terminal device, the redundancy version of the TB0 transmission on each carrier being as illustrated in FIG. 11.

The case where rv_{id}=2 is illustrated in FIG. 11, and rv_{id} may have other values. For example, if rv_{id}=1, then transport block TB0 has a redundancy version of 1 for transmission on carrier 0, a redundancy version of 0 for transmission on carrier 1, and a redundancy version of 2 for transmission on carrier 1.

The network device may transmit to the terminal device the redundancy version identifier of the first carrier among the 3 carriers, i.e., rv_{id}=2. Based on the redundancy version identifier of the first carrier, a redundancy version of the transport block for transmission on each carrier can be obtained. The network device may also transmit the redundancy version identifier of each carrier to the terminal device on each carrier, and the terminal device determines the redundancy version of the transport block on the corresponding carrier according to the redundancy version identifier of each carrier. No matter which of the above-mentioned two manners for indicating redundancy versions is selected by the network device, the redundancy version of the transport block for transmission on the carrier satisfies the above-mentioned second preset condition.

In a possible implementation, another implementation is to transmit a transport block on the first K carriers according to redundancy versions of the transport block for transmission on the first K carriers, at this time, n in the second preset condition is an integer greater than or equal to 0 and less than or equal to K−1. In this implementation, the (K+1)^{th} carrier to the N^{th} carrier is/are not used to retransmit the transport block. The (K+1)^{th} carrier to the N^{th} carrier may be used to transmit other transport block, or no transport block may be transmitted thereon, or any redundancy version of the transport block may be transmitted thereon.

When the number of consecutive retransmissions is greater than 1, according to the provisions of the existing protocol, K times of transmission of a transport block needs to be achieved over K slots; and in a solution where multiple carriers constitute a logical cell, K times of transmission of a transport block can be achieved by N carriers in one transmission slot, so that the number of repeated transmissions of a transport block is equally distributed over different carriers, thereby reducing the time length of repeated transmissions of a PDSCH on one carrier.

For example, in FIG. 12, the number of carriers constituting one logical cell is 3, i.e., N=3, and the 3 carriers are divided into carrier 0, carrier 1, and carrier 2. The number of consecutive retransmissions of a transport block is K=2, and the redundancy version identifier of the first carrier in DCI scheduling a PDSCH is rv_{id}=2.

According to rv_{id}=2 and Table 2, it can be determined that the transport block TB0 has a redundancy version of 2 for transmission on carrier 0 and a redundancy version of 3 for transmission on carrier 1. Since K=2, i.e., the number of consecutive retransmissions is 2, two retransmissions can be achieved through carrier 0 and carrier 1 at this time. Thus, the network device may transmit the TB0 on these 2 carriers to the terminal device, the redundancy version of the TB0 transmission on each carrier being as illustrated in FIG. 12. Carrier 2 may not be used for transmitting the transport block TB0, e.g., may be used for transmitting other transport block, e.g., may not be used for transmitting any transport block, e.g., may also be used for transmitting the transport block TB0. As shown in FIG. 12, TBx may be transmitted on carrier 2, TBx may be TB0 or other transport block, and no transport block may be transmitted on carrier 2. When carrier 2 is used to transmit the transport block TB0, the redundancy version of TB0 for transmission on carrier 2 may be any one of redundancy version 1, redundancy version 2, redundancy version 3, and redundancy version 0.

When the number of consecutive retransmissions is greater than 1, K times of transmission of a transport block can be achieved through the first K carriers in one transmission slot, so that the number of repeated transmission times of a transport block is equally distributed over different carriers, thereby reducing the duration of repeated transmissions of a PDSCH on one carrier.

In the above-mentioned embodiments, a first case where the number of consecutive retransmissions is greater than 1 in a complete transmission mode, i.e., a case where N is greater than or equal to K, is described, and a second case where the number of consecutive retransmissions is greater than 1 in a complete transmission mode, i.e., a case where N is less than K, is described below.

In the second case, if N is less than K, K times of repeated transmission of the transport block needs to be achieved by using [K/N] transmission slots, and [K/N] represents a ceil of K/N (rounding up). For example, [3/2]=2, [8/3]=3 and the like. In this case, the redundancy version of the transport block for transmission on the at least one carrier satisfies a third preset condition.

In a possible implementation, the third preset condition includes at least one of.
rv_{id}=0, if (n+i*N) mod 4=0, then rv3 is 0; if (n+i*N) mod 4=1, then the rv3 is 2; if (n+i*N) mod 4=2, then the rv3 is 3, and (n+i*N) mod 4=3, then the rv3 is 1;
rv_{id}=2, if (n+i*N) mod 4=0, then rv3 is 2; if (n+i*N) mod 4=1, then the rv3 is 3; if (n+i*N) mod 4=2, then the rv3 is 1, and if (n+i*N) mod 4=3, then the rv3 is 0;
rv_{id}=3, if (n+i*N) mod 4=0, then rv3 is 3; if (n+i*N) mod 4=1, then rv3 is 1; if (n+i*N) mod 4=2, then the rv3 is 0, and if (n+i*N) mod 4=3, then the rv3 is 2; and
rv_{id}=, if (n+i*N) mod 4=0, then rv3 is 1; if (n+i*N) mod 4=1, then the rv3 is 0; if (n+i*N) mod 4=2, then the rv3 is 2, and if (n+i*N) mod 4=3, then the rv3 is 3;
where rv_{id} is a redundancy version identifier of a first carrier of the at least one carrier, mod is a modulo operation, n is an integer greater than or equal to 0 and less than or equal to N−1, N is the number of carriers, and rv3 is a redundancy version of the transport block for transmission on carrier n in a transmission slot i;
when i is greater than or equal to 0 and less than or equal to ([K/N]−1), n is an integer greater than or equal to 0 and less than or equal to N−1; when i is equal to [K/N], n is an integer greater than or equal to 0 and less than or equal to N−1, or n is an integer greater than or equal to 0 and less than or equal to (K−[K/N]*N−1), [K/N] represents a ceil of K/N, [K/N] represents a floor of K/N (rounding down).

Since K retransmissions cannot be achieved in one transmission slot over N carriers when the number of consecutive retransmissions K is greater than the number of carriers N, at least [K/N] slots are required to achieve K retransmissions. When i is greater than or equal to 0 and less than or equal to ([K/N]−1), a transport block needs to be transmitted on N carriers, and n is an integer greater than or equal to 0 and less than or equal to N−1; when i is equal to [K/N], the transport block needs to be transmitted on the first (K−[K/N]*N) carriers or, on N carriers. That is, in the slot [K/N], from the (K−[K/N]*N+1)^{th} carrier (i.e., carrier (K−[K/N]*N)) to the N^{th} carrier (i.e., carrier (N−1)) may be used for retransmitting the transport block, or may not be used for retransmitting the transport block, for example, may be used for transmitting other transport block.

In the embodiment of the present application, the transmission slot i is counted from 0. Taking K=8, N=3 as an example, 8 retransmissions are achieved over 3 carriers, for which at least [8/3]=3 slots are needed. When i is greater than or equal to 0 and less than or equal to 1 (i.e., ([K/N]−1)), the transport block needs to be transmitted on 3 carriers so that 6 retransmissions can be achieved on slot 0 and slot 1. When i is equal to 2 (i.e., [K/N]), the transport block may be transmitted on only the first (K−[K/N]*N)=2 carriers, i.e., carrier 0 to carrier 1 (i.e., K−[K/N]*N−1). The transport block may also be transmitted on N carriers when i equals 2 (i.e., [K/N]).

These two different implementations are described below with reference to FIGS. 13 and 14, and it is noted that the network device may transmit the redundancy version identifier of the first carrier among the N carriers to the terminal device, and the terminal device determines the redundancy version of the transport block on each carrier according to the redundancy version identifier of the first carrier. The network device may also transmit redundancy version identifiers of respective carriers to the terminal device on the respective carriers, and the terminal device determines the redundancy versions of the transport block on the respective carriers according to the redundancy version identifiers of the respective carriers. No matter which of the above-mentioned two indication manners is selected by the network device, the redundancy version of the transport block for transmission on the carrier satisfies the above-mentioned third preset condition. In the examples of FIG. 13 and FIG. 14, examples are taken where the network device transmits the redundancy version identifier of the first carrier.

One implementation is that for any one transmission of [K/N] transmission slots, the transport block is transmitted on the N carriers according to a redundancy version of the transport block for transmission on at least one carrier in the transmission slot.

For example, in FIG. 13, the number of carriers constituting one logical cell is 3, i.e., N=3, and the 3 carriers are divided into carrier 0, carrier 1, and carrier 2. The number of consecutive retransmissions of a transport block is K=4, and the redundancy version identifier of the first carrier in DCI scheduling a PDSCH is rv_{id}=1.

According to rv_{id}=1 and Table 3, it can be determined that transport block TB0 has a redundancy version of 1 ((0+0*3) mod 4=0) for transmission in the first slot (i.e., slot 0) on carrier 0, a redundancy version of 0 ((1+0*3) mod 4=1) for transmission in the first slot on carrier 1, and a redundancy version of 2 ((2+0*3) mod 4=2) for transmission in the first slot on carrier 2. TB0 has a redundancy version of 3 ((0+1*3) mod 4=3) for transmission in the second slot (i.e., slot 1) on carrier 0, a redundancy version of 1 ((1+1*3) mod 4=0) for transmission in the second slot on carrier 1, and a redundancy version of 0 ((2+1*3) mod 4=1) for transmission in the second slot on carrier 2.

In a possible implementation, another implementation is that for any one of the first ([K/N]−1 transmission slots, the transport block is transmitted on the N carriers according to a redundancy version of the transport block for transmission on at least one carrier in the transmission slot; for the ([K/N])^{th} transmission slot, the transport block is transmitted on the first (K−[K/N]*N) carrier(s) according to redundancy version(s) of the transport block for transmission on the first (K−[K/N]*N) carrier(s) in the transmission slot.

For example, in FIG. 14, the number of carriers constituting one logical cell is 3, i.e., N=3, and the 3 carriers are divided into carrier 0, carrier 1, and carrier 2. The number of consecutive retransmissions of a transport block is K=4, and the redundancy version identifier of the first carrier in DCI scheduling a PDSCH is rv_{id}=1.

According to rv_{id}=1 and Table 3, it can be determined that transport block TB0 has a redundancy version of 1 ((0+0*3) mod 4=0) for transmission in the first slot (i.e., slot 0) on carrier 0, a redundancy version of 0 ((1+0*3) mod 4=1) for transmission in the first slot on carrier 1, and a redundancy version of 2 ((2+0*3) mod 4=2) for transmission in the first slot on carrier 2. TB0 has a redundancy version of 3 ((0+1*3) mod 4=3) for transmission in the second slot (i.e., slot 1) on carrier 0, and no TB0 is transmitted in the second slot on carrier 1 and in the second slot on carrier 2. In the second slot, carrier 1 and carrier 2 may or may not be used to transmit other transport block(s).

For example, in FIG. 14, in the second slot, carrier 1 may be used for transmitting a TBx, or may not be used for transmitting any transport block, TBx may be TB0, and may also be other transport block, and the redundancy version of TBx for transmission on carrier 1 may be any one of redundancy version 1, redundancy version 2, redundancy version 3 and redundancy version 0; in the second slot, carrier 2 may be used for transmitting TBy or may not be used for transmitting any transport block, TBy may be TB0 or other transport block, and the redundancy version of TBy for transmission on carrier 1 may be any one of redundancy version 1, redundancy version 2, redundancy version 3 and redundancy version 0.

In order to achieve 4 repeated transmissions on a single carrier, 4 transmission slots are required; and in the solution of the present application, compared with a solution of transmitting a transport block on a single carrier, the number of repeated transmissions is equally distributed over different carriers, so that only 2 transmission slots are required to achieve 4 repeated transmissions.

When the number of consecutive retransmissions is greater than 1, K slots are needed to achieve K transmissions on a single carrier, and in the solution of the present application, for N carriers constituting a logical cell, K transmissions of a transport block can be achieved via N carriers, so that the number of repeated transmissions of a transport block is equally distributed over different carriers, thereby reducing the time length of repeated transmissions of a PDSCH on a carrier.

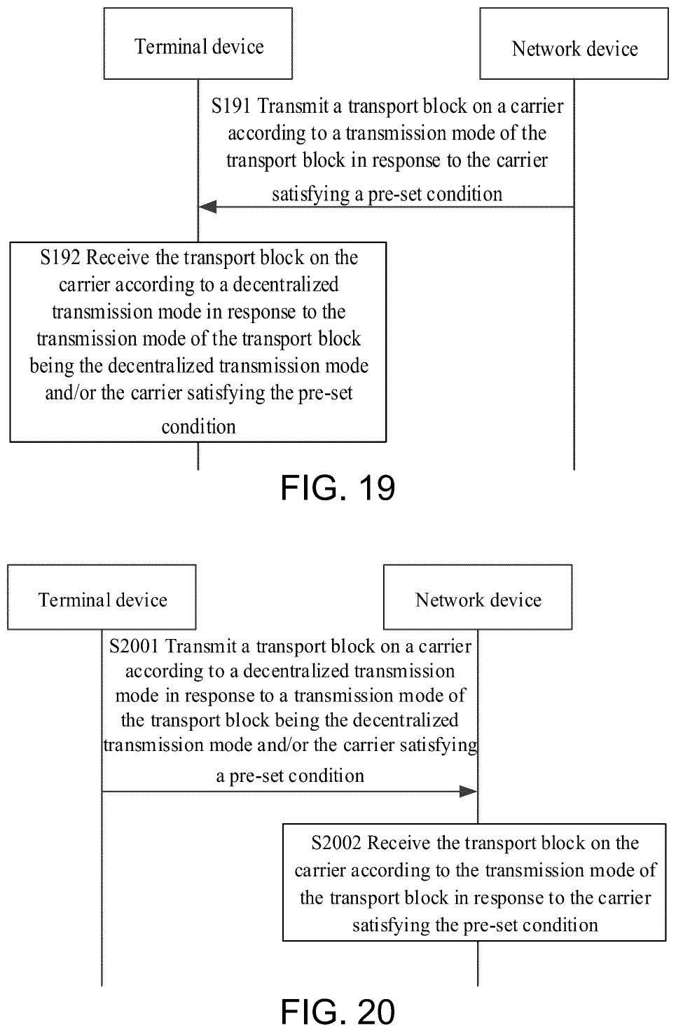

FIG. 19 is a fifth signaling schematic diagram showing a transmission method provided by an embodiment of the present application, and as shown in FIG. 19, the method includes:
S191: a network device transmits a transport block on a carrier according to a transmission mode of the transport block in response to the carrier satisfying a preset condition.

In a possible implementation, the number of carriers may be one or more.

The transmission mode of the transport block includes a complete transmission mode and a distributed transmission mode, and in a possible implementation, the complete transmission mode refers to that a transport block is completely transmitted on any one carrier. In contrast to a complete transmission mode, a distributed transmission mode refers to that for a transport block, only a partial code block group of the transport block is transmitted on any one carrier, i.e., when the distributed transmission mode is adopted, one transport block will be divided into at least one code block group, and different code block groups of the transport block are transmitted on different carriers, thereby realizing the transmission of all the code block groups of the transport block.

When the number of carriers is 1, the transport block can only be transmitted in a complete transmission mode on this carrier, and when the number of carriers is at least 2, the transport block can be transmitted in a complete transmission mode on at least one carrier or in a distributed transmission mode on at least one carrier.

When the carrier satisfies a preset condition, the network device may transmit the transport block to the terminal device on the carrier according to the transmission mode of the transport block, i.e., the network device may perform PDSCH transmission for downlink traffic.

In a possible implementation, the preset condition includes that the number of carriers is at least 2 and/or that the carriers are carriers in the same logical cell. When the number of carriers is at least 2, the network device may transmit the transport block on the at least two carriers. The at least two carriers are carriers in the same logical cell. When the network device transmits a transport block to the terminal device on the at least two carriers, the network device can select a complete transmission mode or a distributed transmission mode for transmission.

S192: the terminal device receives the transport block on the carrier according to the distributed transmission mode in response to the transmission mode of the transport block being the distributed transmission mode and/or the carrier satisfying the preset condition.

Since the transmission mode of the transport block may be a complete transmission mode or a distributed transmission mode, the terminal device first determines the transmission mode of the transport block before receiving the transport block.

In a possible implementation, the terminal device determines the transmission mode of the transport block in response to the carrier satisfying a preset condition. In a possible implementation, the preset condition includes that the number of carriers is at least 2 and/or that the carriers are carries in the same logical cell.

In a possible implementation, the network device transmits a transmission mode indication parameter to the terminal device, the transmission mode indication parameter being used for indicating the transmission mode of the transport block.

In a possible implementation, the transmission mode indication parameter is carried in a system message and/or the transmission mode indication parameter is carried in first radio resource control signaling.

In a possible implementation, the system message may be a SIB.

In a possible implementation, the first radio resource control signaling may be an RRC message.

In a possible implementation, when the transmission mode indication parameter is carried in the system message, the network device transmits the system message to the terminal device, the system message including the transmission mode indication parameter. After receiving the system message from the network device, the terminal device acquires the transmission mode indication parameter according to the system message, and then determines the transmission mode of the transport block according to the transmission mode indication parameter.

In a possible implementation, when the transmission mode indication parameter is carried in first radio resource control signaling, the network device transmits the first radio resource control signaling to the terminal device, where the first radio resource control signaling includes the transmission mode indication parameter. After receiving the first radio resource control signaling from the network device, the terminal device acquires the transmission mode indication parameter according to the first radio resource control signaling, and then determines the transmission mode of the transport block according to the transmission mode indication parameter.

In a possible implementation, in an embodiment of the present application, the transmission mode is a distributed transmission mode.

FIG. 20 is a sixth signaling schematic diagram showing a transmission method provided by an embodiment of the present application, and as shown in FIG. 20, the method includes:
S2001: a terminal device transmits a transport block on a carrier according to a distributed transmission mode in response to a transmission mode of the transport block being the distributed transmission mode and/or the carrier satisfying a preset condition.

In a possible implementation, the number of carriers may be one or more.

The transmission mode of the transport block includes a complete transmission mode and a distributed transmission mode, and in a possible implementation, the complete transmission mode refers to that a transport block is completely transmitted on any one carrier. In contrast to a complete transmission mode, a distributed transmission mode refers to that for a transport block, only a partial code block group of the transport block is transmitted on any one carrier, i.e., when the distributed transmission mode is adopted, one transport block will be divided into at least one code block group, and different code block groups of the transport block are transmitted on different carriers, thereby realizing the transmission of all the code block groups of the transport block.

When the number of carriers is 1, the transport block can only be transmitted in a complete transmission mode on this carrier, and when the number of carriers is at least 2, the transport block can be transmitted in a complete transmission mode on at least one carrier or in a distributed transmission mode on at least one carrier.

Since the transmission mode of the transport block may be a complete transmission mode or a distributed transmission mode, the terminal device first determines the transmission mode of the transport block before transmitting the transport block.

In a possible implementation, the terminal device determines the transmission mode of the transport block in response to the carrier satisfying a preset condition. In a possible implementation, the preset condition includes that the number of carriers is at least 2 and/or that the carriers are carries in the same logical cell.

In a possible implementation, the network device transmits a transmission mode indication parameter to the terminal device, the transmission mode indication parameter being used for indicating the transmission mode of the transport block.

In a possible implementation, the transmission mode indication parameter is carried in a system message and/or the transmission mode indication parameter is carried in first radio resource control signaling.

In a possible implementation, the system message may be a SIB.

In a possible implementation, the first radio resource control signaling may be an RRC message.

In a possible implementation, when the transmission mode indication parameter is carried in the system message, the network device transmits the system message to the terminal device, the system message including the transmission mode indication parameter. After receiving the system message from the network device, the terminal device acquires the transmission mode indication parameter according to the system message, and then determines the transmission mode of the transport block according to the transmission mode indication parameter.

In a possible implementation, when the transmission mode indication parameter is carried in first radio resource control signaling, the network device transmits the first radio resource control signaling to the terminal device, where the first radio resource control signaling includes the transmission mode indication parameter. After receiving the first radio resource control signaling from the network device, the terminal device acquires the transmission mode indication parameter according to the first radio resource control signaling, and then determines the transmission mode of the transport block according to the transmission mode indication parameter.

In a possible implementation, in an embodiment of the present application, the transmission mode is a distributed transmission mode.

S2002: the network device receives the transport block on the carrier according to the transmission mode of the transport block in response to the carrier satisfying the preset condition.

When the carrier satisfies a preset condition, the network device may receive the transport block on the carrier according to the transmission mode of the transport block, i.e., the network device may perform PUSCH transmission for uplink traffic.

In a possible implementation, the preset condition includes that the number of carriers is at least 2 and/or that the carriers are carries in the same logical cell. When the number of carriers is at least 2, the network device may receive the transport block on the at least two carriers. The at least two carriers are carries in the same logical cell. When the network device receives the transport block on the at least two carriers, the network device can select a complete transmission mode or a distributed transmission mode for the reception. The transmission of a transport block between a network device and a terminal device via a distributed transmission mode is described in connection with the embodiments of FIGS. 19 and 20. In the embodiments of the present application, transmission of a transport block on a carrier may mean transmitting the transport block on the carrier or receiving the transport block on the carrier. When “a terminal device transmitting a transport block on a carrier” represents receiving the transport block on the carrier, “a network device transmitting the transport block on the carrier” represents sending the transport block on the carrier (as illustrated in FIG. 19); when “a terminal device transmitting a transport block on a carrier” represents sending the transport block on the carrier, “a network device transmitting a transport block on a carrier” represents receiving the transport block on the carrier (as illustrated in FIG. 20). That is, the transmission method of the present application can be applied to both PDSCH transmission for downlink traffic and PUSCH transmission for uplink traffic. In the following embodiments, the PDSCH transmission for downlink traffic is described as an example, and it can be understood that the solution of the following embodiments can also be used for PUSCH transmission for uplink traffic.

In a possible implementation, the terminal device determines a redundancy version of the transport block for transmission on at least one carrier and then receives the transport block on the carrier according to the redundancy version, the transmission mode of the transport block and the number of consecutive retransmissions of the transport block.

When the number of carriers is 1, the network device may transmit a redundancy version identifier on the carrier to the terminal device, and then the terminal device determines the redundancy version of the transport block on the carrier according to the redundancy version identifier.

When the number of carriers is at least 2, the network device may transmit a redundancy version identifier of the first carrier of the at least one carrier to the terminal device. After receiving the redundancy version identifier of the first carrier of the at least one carrier, the terminal device determines the redundancy version of the transport block for transmission on the at least one carrier according to the redundancy version identifier of the first carrier, the number of consecutive retransmissions and the transmission mode.

In a possible implementation, the redundancy version identifier of the first carrier is carried in first downlink resource control information. The network device transmits the first downlink resource control information to the terminal device on a first carrier, and after receiving the first downlink resource control information on the first carrier, the terminal device acquires the redundancy version identifier of the first carrier according to the first downlink resource control information.

When the number of carriers is at least 2, the network device may transmit a redundancy version identifier of at least one carrier to the terminal device. After receiving the redundancy version identifier of the at least one carrier, the terminal device determines the redundancy version of the transport block on the at least one carrier according to the redundancy version identifier of the at least one carrier.

In a possible implementation, the redundancy version identifier of the at least one carrier is carried in second downlink resource control information. The network device transmits the second downlink resource control information to the terminal device on at least one carrier, and after receiving the second downlink resource control information on the at least one carrier, the terminal device acquires a redundancy version identifier of the at least one carrier according to the second downlink resource control information.

When the transmission mode is a distributed transmission mode, the terminal device may determine index(es) of code block group(s) for transmission on at least one carrier according to the number of code block groups and the number of carriers included in the transport block.

In a possible implementation, the number of code block groups included in the transport block is a smaller one of a real number of code blocks in the transport block and a maximum number of code block groups in the transport block permitted by a protocol.

For any one of K transmission slots, transmitting at least one code block group of the transport block on at least one carrier according to the redundancy version of the transport block for transmission on the at least one carrier and the index of the code block group.

In a possible implementation, the transmission mode is the distributed transmission mode; the redundancy version of the transport block for transmission on at least one carrier and a transmission slot i satisfy a fourth preset condition.

In a possible implementation, the fourth preset condition includes at least one of:
rv_{id}=0, if i mod 4=0, then rv4 is 0; if i mod 4=1, then the rv4 is 2; if i mod 4=2, then the rv4 is 3, and if i mod 4=3, then the rv4 is 1;
rv_{id}=2, if i mod 4=0, then rv4 is 2; if i mod 4=1, then the rv4 is 3; if i mod 4=2, then the rv4 is 1, and if i mod 4=3, then the rv4 is 0;
rv_{id}=3, if i mod 4=0, then rv4 is 3; if i mod 4=1, then the rv4 is 1; if i mod 4=2, then the rv4 is 0, and if i mod 4=3, then the rv4 is 2; and
rv_{id}=1, if i mod 4=0, then rv4 is 1; if i mod 4=1, then the rv4 is 0; if i mod 4=2, then the rv4 is 2, and if i mod 4=3, then the rv4 is 3;
where rv_{id} is a redundancy version identifier of a first carrier in at least one carrier, mod is a modulo operation, i is an integer greater than or equal to 0 and less than or equal to K−1, K is the number of consecutive retransmissions, and rv4 is a redundancy version of a transport block for transmission on the at least one carrier in a transmission slot i.

Since a transport block can be divided into at least one code block group for transmission, only one transmission of the transport block can be achieved over one transmission slot. If the number of consecutive retransmissions is greater than 1, for example, when the number of consecutive retransmissions is K, K slots are needed to achieve the transmission of a transport block. In a possible implementation, for any one transmission slot i, the redundancy version of the transport block for transmission on the carrier in the transmission slot i is determined according to a fourth preset condition.

In a possible implementation, the index of the code block group for transmission on at least one carrier satisfies a fifth preset condition.

In a possible implementation, the fifth preset condition includes:
when M is greater than N, n∈{0, 1, . . . , T₁−1}, an index of a code block group for transmission on carrier n is (n*N₁+k₁), k₁=0, 1, . . . , N₁−1; when n∈{T₁, T₁+1, . . . , N−1}, an index of a code block group for transmission on carrier n is (T₁*N₁+(n−T₁)N₂+k₂), k₂=0, . . . , N₂−1, where the n is greater than or equal to 0 and less than or equal to N−1; and/or,
when M is less than or equal to N, an index of a code block group for transmission on carrier n is n, and n is greater than or equal to 0 and less than M;
where M is the number of code block groups included in the transport block, M is a positive integer greater than or equal to 1, N is the number of the carriers, and N is a positive integer greater than or equal to 2, T₁=M mod N, N₁=[M/N], N₂=[M/N], [M/N] represents a ceil of M/N, and [M/N] represents a floor of M/N.

For example, in FIG. 15, the number of carriers constituting a logical cell is 3, i.e., N=3, the 3 carriers are divided into carrier 0, carrier 1 and carrier 2, the real number of code blocks included in TB0 is 7, and the maximum number of CBGs configured by a high layer parameter maxCodeBlockGroupPerTransportBlock is 4, then the number of CBGs that can be transmitted by one TB is M=min (N, C)=4.

T₁=4 mod 3=1, N₁=[M/N]=2, N₂=[M/N]=1. According to the fifth preset condition, when n∈{0, 1, . . . , T₁−1} (i.e., n∈{0}) the index of the code block group for transmission on carrier 0 is (n*N₁+k₁)=(0*2+k₁), k₁=0, 1, . . . , N₁−1=0, 1, then CBG 0 and CBG 1 for constituting TB0 are transmitted on carrier 0. When n∈{T₁, T₁+1, . . . , N−1} (i.e., n∈{1, 2}), the index of the code block group for transmission on carrier n is (T₁*N₁+(n−T₁)N₂+k₂)=(1*2+(n−1)1+0)=n+1, CBG 2 for constituting TB0 is transmitted on carrier 1, and CBG3 for constituting TB0 is transmitted on carrier 2, as shown in FIG. 15.

For example, in FIG. 16, the number of carriers constituting a logical cell is 3, i.e., N=3, the 3 carriers are divided into carrier 0, carrier 1 and carrier 2, the real number of code blocks included in TB0 is 7, and the maximum number of CBGs configured by a high layer parameter maxCodeBlockGroupsPerTransportBlock is 2, then the number of CBGs that can be transmitted by one TB is M=min(N, C)=2.

According to the fifth preset condition, if an index of a code block group for transmission on carrier n is n, then CBG 0 for constituting TB0 is transmitted on carrier 0, CBG 1 for constituting TB0 is transmitted on carrier 1, and TB0 may not be transmitted on carrier 2, for example, carrier 2 may be used for transmitting other TB, for example, carrier 2 may not be used for transmitting any transport block. As shown in FIG. 16, carrier 2 may be used for transmitting CBGx, or may not be used for transmitting any code block group, CBGx may be CBG0 or CBG1 for constituting TB0, or CBG for constituting other transport block.

In the solution of an embodiment of the present application, a transport block with an excessive number of bits can be split and transmitted on different carriers to reduce the transmission bit rate on each carrier, thereby improving the success rate of the terminal device demodulating data of the code block group and successfully receiving the transport block.

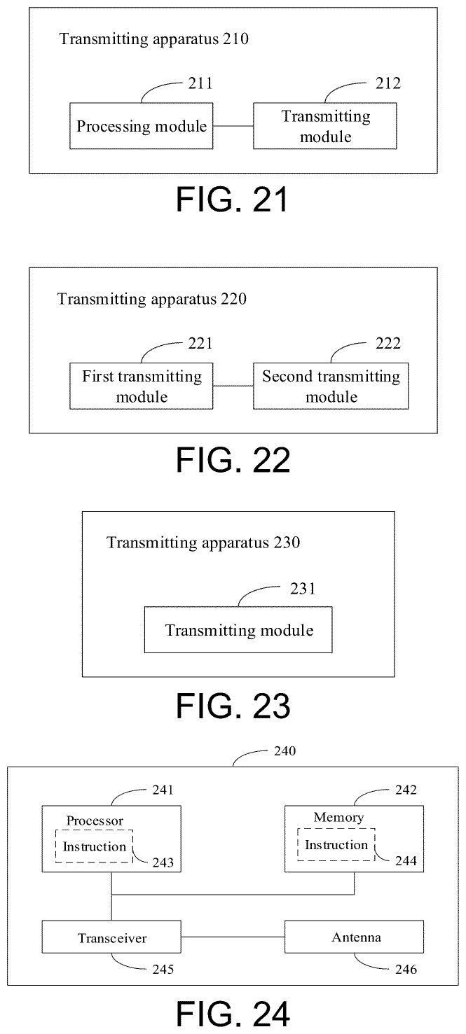

FIG. 21 is a schematic structural diagram showing a transmitting apparatus provided by an embodiment of the present application, and as shown in FIG. 21, the transmitting apparatus 210 includes:
a processing module 211, configured to determine a transmission mode of a transport block; and
a transmitting module 212, configured to transmit the transport block on carrier according to the transmission mode.

In a possible implementation, the processing module 211 is specifically configured to: determine the transmission mode in response to the carrier satisfying a preset condition.

In a possible implementation, the preset condition includes:
the number of carriers being at least two; and/or, carriers being carries in the same logical cell.

In a possible implementation, the transmitting module 212 is specifically configured to:
determine a redundancy version of the transport block for transmission on at least one of the carriers; and
transmit the transport block on the carriers according to the redundancy version, the transmission mode and/or the number of consecutive retransmissions of the transport block.

In a possible implementation, the transmitting module 212 is specifically configured to:
acquire a redundancy version identifier of a first carrier of the at least one of the carriers, and determine the redundancy version for transmission on the at least one of the carriers according to the redundancy version identifier of the first carrier, the number of consecutive retransmissions and the transmission mode; and/or,
acquire a redundancy version identifier of the at least one of the carriers, and determine the redundancy version for transmission on the at least one of the carriers according to the redundancy version identifier of the at least one of the carriers.

In a possible implementation, the transmitting module 212 is specifically configured to: receive first downlink resource control information on the first carrier, and acquire the redundancy version identifier of the first carrier according to the first downlink resource control information; and/or,
the transmitting module 212 is specifically configured to: receive second downlink resource control information on the at least one of the carriers, and acquire the redundancy version identifier corresponding to the at least one of the carriers according to the second downlink resource control information.

In a possible implementation, for any transmission slot, the redundancy version satisfies at least one of:
the transmission mode being a complete transmission mode, the number of consecutive retransmissions being 1, and redundancy versions of the transport block for transmission on the at least one of the carriers being different;
the transmission mode being the complete transmission mode, the number of consecutive retransmissions being 1, and the redundancy versions of the transport block for transmission on the at least one of the carriers being the same;
the transmission mode being the complete transmission mode, the number of consecutive retransmissions being greater than 1, and the redundancy versions of the transport block for transmission on the at least one of the carriers being different; and
the transmission mode being a distributed transmission mode, and the redundancy versions of the transport block for transmission on the at least one of the carriers being the same.

In a possible implementation, the transmission mode is the complete transmission mode, the number of consecutive retransmissions is 1, and the redundancy version of the transport block for transmission on the at least one of the carriers satisfies a first preset condition.

In a possible implementation, the first preset condition includes at least one of:
rv_{id}=0, if n mod 4=0, then rv1 is 0; if n mod 4=1, then the rv1 is 2; if n mod 4=2, then the rv1 is 3, and if n mod 4=3, then the rv1 is 1;
rv_{id}=2, if n mod 4=0, then the rv1 is 2; if n mod 4=1, then the rv1 is 3; if n mod 4=2, then the rv1 is 1, and if n mod 4=3, then the rv1 is 0;
rv_{id}=3, if n mod 4=0, then the rv1 is 3; if n mod 4=1, then the rv1 is 1; if n mod 4=2, then the rv1 is 0, and if n mod 4=3, then the rv1 is 2; and
rv_{id}=1, if n mod 4=0, then the rv1 is 1; if n mod 4=1, then the rv1 is 0; if n mod 4=2, then the rv1 is 2, and if n mod 4=3, then the rv1 is 3;
where rv_{id} is a redundancy version identifier of a first carrier of the at least one of the carriers, mod is a modulo operation, n is an integer greater than or equal to 0 and less than or equal to N−1, N is the number of the carriers, and rv1 is a redundancy version of the transport block for transmission on carrier n.

In a possible implementation, the first preset condition is that redundancy versions for transmission on the at least one of the carriers are the same.

In a possible implementation, the transmitting module 212 is specifically configured to:
transmit the transport block on each carrier according to the redundancy version of the transport block for transmission on the at least one of the carriers.

In a possible implementation, the transmission mode is the complete transmission mode, the number of consecutive retransmissions K is greater than 1, and the number of the carriers N is greater than or equal to K; the redundancy version of the transport block for transmission on the at least one of the carriers satisfies a second preset condition.

In a possible implementation, the second preset condition includes at least one of:
rv_{id}=0, if (n mod K) mod 4=0, then rv2 is 0; if (n mod K) mod 4=1, then rv2 is 2; if (n mod K) mod 4=2, then the rv2 is 3, and (n mod K) mod 4=3, then the rv2 is 1;
rv_{id}=2, if (n mod K) mod 4=0, then the rv2 is 2; if (n mod K) mod 4=1, then rv2 is 3; if (n mod K) mod 4=2, then the rv2 is 1, and if (n mod K) mod 4=3, then the rv2 is 0;
rv_{id}=3, if (n mod K) mod 4=0, then the rv2 is 3; if (n mod K) mod 4=1, then rv2 is 1; if (n mod K) mod 4=2, then the rv2 is 0, and if (n mod K) mod 4=3, then the rv2 is 2; and
rv_{id}=1, if (n mod K) mod 4=0, then the rv2 is 1; if (n mod K) mod 4=1, then rv2 is 0; if (n mod K) mod 4=2, then the rv2 is 2, and if (n mod K) mod 4, then the rv2 is 3;
where rv_{id} is a redundancy version identifier of a first carrier of the at least one of the carriers, mod is a modulo operation, and rv2 is a redundancy version of the transport block for transmission on carrier n;
n is an integer greater than or equal to 0 and less than or equal to N−1, or n is an integer greater than or equal to 0 and less than or equal to K−1.

In a possible implementation, the transmitting module 212 is specifically configured to:
transmit the transport block on first K carriers according to redundancy versions of the transport block for transmission on the first K carriers; or,
transmit the transport block on the N carriers according to redundancy versions of the transport block for transmission on the N carriers.

In a possible implementation, the transmission mode is the complete transmission mode, the number of consecutive retransmissions K is greater than 1, the number of the carriers N is less than K, and the redundancy version of the transport block for transmission on the at least one of the carriers and a transmission slot i satisfy a third preset condition.

In a possible implementation, the third preset condition includes at least one of:
rv_{id}=0, if (n+i*N) mod 4=0, then rv3 is 0; if (n+i*N) mod 4=1, then the rv3 is 2; if (n+i*N) mod 4=2, then the rv3 is 3, and (n+i*N) mod 4=3, then the rv3 is 1;
rv_{id}=2, if (n+i*N) mod 4=0, then the rv3 is 2; if (n+i*N) mod 4=1, then rv3 is 3; if (n+i*N) mod 4=2, then the rv3 is 1, and if (n+i*N) mod 4=3, then the rv3 is 0;
rv_{id}=3, if (n+i*N) mod 4=0, then rv3 is 3; if (n+i*N) mod 4=1, then the rv3 is 1; if (n+i*N) mod 4=2, then the rv3 is 0, and if (n+i*N) mod 4=3, then the rv3 is 2; and
rv_{id}=1, if (n+i*N) mod 4=0, then the rv3 is 1; if (n+i*N) mod 4=1, then rv3 is 0; if (n+i*N) mod 4=2, then the rv3 is 2, and if n (n+i*N) mod 4=3, then the rv3 is 3;
where rv_{id} is a redundancy version identifier of a first carrier of the at least one of the carriers, mod is a modulo operation, n is an integer greater than or equal to 0 and less than or equal to N−1, N is the number of the carriers, and rv3 is a redundancy version of the transport block for transmission on carrier n in a transmission slot i;
when i is greater than or equal to 0 and less than or equal to (([K/N]−1), n is an integer greater than or equal to 0 and less than or equal to N−1; when the i is equal to [K/N], n is an integer greater than or equal to 0 and less than or equal to N−1, or n is an integer greater than or equal to 0 and less than or equal to (K−[K/N]*N−1), [K/N] represents a ceil of K/N, [K/N] represents a floor of K/N.

In a possible implementation, the transmitting module 212 is specifically configured to:
for any one of [K/N] transmission slots, transmit the transport block on the N carriers according to the redundancy version of the transport block for transmission on the at least one of the carriers in the transmission slot; or,
for any one of first ([K/N]−1 transmission slots, transmit the transport block on the N carriers according to the redundancy version of the transport block for transmission on the at least one of the carriers in the transmission slot; for a ([K/N])-th transmission slot, transmit the transport block on first (K−[K/N]*N) carriers according to redundancy versions of the transport block for the transmission on the first (K−[K/N]*N) carriers in the transmission slot.

In a possible implementation, the transmission mode is the distributed transmission mode; the redundancy version of the transport block for transmission on the at least one of the carriers and a transmission slot i satisfy a fourth preset condition.

In a possible implementation, the fourth preset condition includes at least one of:
rv_{id}=0, if i mod 4=0, then rv4 is 0; if i mod 4=1, then the rv4 is 2; if i mod 4=2, then the rv4 is 3, and if i mod 4=3, then the rv4 is 1;
rv_{id}=2, if i mod 4=0, then the rv4 is 2; if i mod 4=1, then the rv4 is 3; if i mod 4=2, then the rv4 is 1, and if i mod 4=3, then the rv4 is 0;
rv_{id}=3, if i mod 4=0, then the rv4 is 3; if i mod 4=1, then the rv4 is 1; if i mod 4=2, then the rv4 is 0, and if i mod 4=3, then the rv4 is 2; and
rv_{id}=1, if i mod 4=0, then the rv4 is 1; if i mod 4=1, then the rv4 is 0; if i mod 4=2, then the rv4 is 2, and if i mod 4=3, then the rv4 is 3;
where rv_{id} is a redundancy version identifier of a first carrier of the at least one of the carriers, mod is a modulo operation, i is an integer greater than or equal to 0 and less than or equal to (K−1), K is the number of consecutive retransmissions, and rv4 is a redundancy version of a transport block for transmission on the at least one of the carriers on a transmission slot i.

In a possible implementation, the transmitting module 212 is specifically configured to:
determine an index of a code block group for transmission on the at least one of the carriers according to the number of code block groups included in the transport block and the number of the carriers;
for any one of K transmission slots, transmit at least one code block group of the transport block on the at least one of the carriers according to the redundancy version of the transport block for transmission on the at least one of the carriers and the index of the code block group.

In a possible implementation, the number of code block groups included in the transport block is a smaller one of a real number of code blocks in the transport block and a maximum number of code block groups in the transport block permitted by a protocol.

In a possible implementation, the index of the code block group for transmission on the at least one of the carriers satisfies a fifth preset condition.

In a possible implementation, the fifth preset condition includes at least one of:
when M is greater than N, n∈{0, 1, . . . , T₁−1}, an index of a code block group for transmission on carrier n is (n*N₁+k₁), k₁=0, 1, . . . , N₁−1; when n∈{T₁, T₁+1, . . . , N−1}, an index of a code block group for transmission on carrier n is (T₁*N₁+(n−T₁)N₂+k₂), k₂=0, 1, . . . , N₂−1, where n is greater than or equal to 0 and less than or equal to N−1; and/or,
when M is less than or equal to the N, the index of the code block group transmitted on carrier n is n, and the n is greater than or equal to 0 and less than M;
where M is the number of code block groups included in the transport block, M is a positive integer greater than or equal to 1, N is the number of the carriers, and N is a positive integer greater than or equal to 2, T₁=M mod N, N₁=[M/N], N₂=[M/N], [M/N] represents a ceil of M/N, and [M/N] represents a floor of M/N.

In a possible implementation, the processing module 211 is specifically configured to:
receive a transmission mode indication parameter;
determine the transmission mode according to the transmission mode indication parameter.

In a possible implementation,
the transmission mode indication parameter is carried in a system message; and/or,
the transmission mode indication parameter is carried in first radio resource control signaling.

In a possible implementation, the processing module 211 is specifically configured to:
receive second radio resource control signaling; and
acquire the number of consecutive retransmissions according to the second radio resource control signaling.

In a possible implementation, the second radio resource control signaling includes an aggregation factor, and the number of consecutive retransmissions is the number of times indicated by the aggregation factor; and/or,
the second radio resource control signaling does not include the aggregation factor, and the number of consecutive retransmissions is 1.

The transmitting apparatus provided by the embodiments of the present application can perform the technical solution shown by the embodiments of the above-mentioned method, and the implementation principles and advantageous effects thereof are similar and will not be described in detail herein.

FIG. 22 is a schematic structural diagram showing a transmitting apparatus provided by an embodiment of the present application, and as shown in FIG. 22, the transmitting apparatus 220 includes:
a first transmitting module 221, configured to transmit a transport block on a carrier according to a complete transmission mode in response to a transmission mode of the transport block being the complete transmission mode and/or the carrier satisfying a preset condition; and/or, and
a second transmitting module 222, configured to transmit a transport block on a carrier according to a distributed transmission mode in response to a transmission mode of the transport block being the distributed transmission mode and/or a carrier satisfying the preset condition.

In a possible implementation, the preset condition includes:
the number of carriers being at least two; and/or,
carriers being carries in the same logical cell.

In a possible implementation, the first transmitting module 221 is specifically configured to:
transmit the transport block on the carrier according to the complete transmission mode, a redundancy version of the transport block for transmission on the at least one of the carriers and/or the number of consecutive retransmissions of the transport block.

In a possible implementation, for any transmission slot, a redundancy version of the transport block for transmission on the at least one of the carriers satisfies at least one of:
the number of consecutive retransmissions being 1, and redundancy versions of the transport block for transmission on the at least one of the carriers being different;
the number of consecutive retransmissions being 1, and the redundancy versions of the transport block for transmission on the at least one of the carriers are the same; and
the number of consecutive retransmissions being greater than 1, and the redundancy versions of the transport block for transmission on the at least one of the carriers being different.

In a possible implementation, the number of consecutive retransmissions is 1, and the redundancy version of the transport block for transmission on the at least one of the carriers satisfies a first preset condition.

In a possible implementation, the first preset condition includes at least one of:
rv_{id}=0, if n mod 4=0, then rv1 is 0; if n mod 4=1, then the rv1 is 2; if n mod 4=2, then the rv1 is 3, and if n mod 4=3, then the rv1 is 1;
rv_{id}=2, if n mod 4=0, then the rv1 is 2; if n mod 4=1, then the rv1 is 3; if n mod 4=2, then the rv1 is 1, and if n mod 4=3, then the rv1 is 0;
rv_{id}=3, if n mod 4=0, then the rv1 is 3; if n mod 4=1, then the rv1 is 1; if n mod 4=2, then the rv1 is 0, and if n mod 4=3, then the rv1 is 2; and
rv_{id}=1, if n mod 4=0, then the rv1 is 1; if n mod 4=1, then the rv1 is 0; if n mod 4=2, then the rv1 is 2, and if n mod 4=3, then the rv1 is 3;
where rv_{id} is a redundancy version identifier of a first carrier of the at least one of the carriers, mod is a modulo operation, n is an integer greater than or equal to 0 and less than or equal to N−1, N is the number of the carriers, and rv1 is a redundancy version of the transport block for transmission on carrier n.

In a possible implementation, the first preset condition is that redundancy versions for transmission on the at least one of the carriers are the same.

In a possible implementation, the first transmitting module 221 is specifically configured to:
transmit the transport block on each carrier according to the redundancy version of the transport block for transmission on the at least one of the carriers.

In a possible implementation, the number of consecutive retransmissions K is greater than 1, and the number of the carriers N is greater than or equal to K; the redundancy version of the transport block for transmission on the at least one of the carriers satisfies a second preset condition.

In a possible implementation, the second preset condition includes at least one of:
rv_{id}=0, if (n mod K) mod 4=0, then rv2 is 0; if (n mod K) mod 4=1, then rv2 is 2; if (n mod K) mod 4=2, then the rv2 is 3, and (n mod K) mod 4=3, then the rv2 is 1;
rv_{id}=2, if (n mod K) mod 4=0, then the rv2 is 2; if (n mod K) mod 4=1, then rv2 is 3; if (n mod K) mod 4=2, then the rv2 is 1, and if (n mod K) mod 4=3, then the rv2 is 0;
rv_{id}=3, if (n mod K) mod 4=0, then the rv2 is 3; if (n mod K) mod 4=1, then rv2 is 1; if (n mod K) mod 4=2, then the rv2 is 0, and if (n mod K) mod 4=3, then the rv2 is 2; and
rv_{id}=1, if (n mod K) mod 4=0, then the rv2 is 1; if (n mod K) mod 4=1, then rv2 is 0; if (n mod K) mod 4=2, then the rv2 is 2, and if (n mod K) mod 4, then the rv2 is 3;
where rv_{id} is a redundancy version identifier of a first carrier of the at least one of the carriers, mod is a modulo operation, and rv2 is a redundancy version of the transport block for transmission on carrier n;
n is an integer greater than or equal to 0 and less than or equal to N−1, or n is an integer greater than or equal to 0 and less than or equal to K−1.

In a possible implementation, the first transmitting module 221 is specifically configured to:
transmit the transport block on first K carriers according to redundancy versions of the transport block for transmission on the first K carriers; or,
transmit the transport block on the N carriers according to redundancy versions of the transport block for transmission on the N carriers.

In a possible implementation, the number of consecutive retransmissions K is greater than 1, the number of the carriers N is less than K; and the redundancy version of the transport block for transmission on the at least one of the carriers and a transmission slot i satisfy a third preset condition.

In a possible implementation, the third preset condition includes at least one of:
rv_{id}=0, if (n+i*N) mod 4=0, then rv3 is 0; if (n+i*N) mod 4=1, then the rv3 is 2; if (n+i*N) mod 4=2, then the rv3 is 3, and (n+i*N) mod 4=3, then the rv3 is 1;
rv_{id}=2, if (n+i*N) mod 4=0, then the rv3 is 2; if (n+i*N) mod 4=1, then rv3 is 3; if (n+i*N) mod 4=2, then the rv3 is 1, and if (n+i*N) mod 4=3, then the rv3 is 0;
rv_{id}=3, if (n+i*N) mod 4=0, then rv3 is 3; if (n+i*N) mod 4=1, then the rv3 is 1; if (n+i*N) mod 4=2, then the rv3 is 0, and if (n+i*N) mod 4=3, then the rv3 is 2; and
rv_{id}=1, if (n+i*N) mod 4=0, then the rv3 is 1; if (n+i*N) mod 4=1, then rv3 is 0; if (n+i*N) mod 4=2, then the rv3 is 2, and if n (n+i*N) mod 4=3, then the rv3 is 3;
where rv_{id} is a redundancy version identifier of a first carrier of the at least one of the carriers, mod is a modulo operation, n is an integer greater than or equal to 0 and less than or equal to N−1, N is the number of the carriers, and rv3 is a redundancy version of the transport block for transmission on carrier n in a transmission slot i;
when i is greater than or equal to 0 and less than or equal to (([K/N]−1), n is an integer greater than or equal to 0 and less than or equal to N−1; when i is equal to [K/N], n is an integer greater than or equal to 0 and less than or equal to N−1, or n is an integer greater than or equal to 0 and less than or equal to (K−[K/N]*N−1), [K/N] represents a ceil of K/N, [K/N] represents a floor of K/N.

In a possible implementation, the first transmitting module 221 is specifically configured to:
for any one of [K/N] transmission slots, transmit the transport block on the N carriers according to the redundancy version of the transport block for transmission on the at least one of the carriers in the transmission slot; or,
for any one of first ([K/N]−1 transmission slots, transmit the transport block on the N carriers according to the redundancy version of the transport block for transmission on the at least one of the carriers in the transmission slot; for a ([K/N])-th transmission slot, transmit the transport block on first (K−[K/N]*N) carriers according to redundancy versions of the transport block for the transmission on the first (K−[K/N]*N) carriers in the transmission slot.

In a possible implementation, the second transmitting module 222 is specifically configured to:
transmit the transport block on the carrier according to the distributed transmission mode, a redundancy version of the transport block for transmission on the at least one of the carriers and/or the number of consecutive retransmissions of the transport block.

In a possible implementation, for any transmission slot, redundancy versions of the transport block for transmission on the at least one of the carriers are the same.

In a possible implementation, a redundancy version of the transport block for transmission on the at least one of the carriers in a transmission slot i satisfies a fourth preset condition.

In a possible implementation, the fourth preset condition includes at least one of:
rv_{id}=0, if i mod 4=0, then rv4 is 0; if i mod 4=1, then the rv4 is 2; if i mod 4=2, then the rv4 is 3, and if i mod 4=3, then the rv4 is 1;
rv_{id}=2, if i mod 4=0, then the rv4 is 2; if i mod 4=1, then the rv4 is 3; if i mod 4=2, then the rv4 is 1, and if i mod 4=3, then the rv4 is 0;
rv_{id}=3, if i mod 4=0, then the rv4 is 3; if i mod 4=1, then the rv4 is 1; if i mod 4=2, then the rv4 is 0, and if i mod 4=3, then the rv4 is 2; and
rv_{id}=1, if i mod 4=0, then the rv4 is 1; if i mod 4=1, then the rv4 is 0; if i mod 4=2, then the rv4 is 2, and if i mod 4=3, then the rv4 is 3;
where rv_{id} is a redundancy version identifier of a first carrier of the at least one of the carriers, mod is a modulo operation, i is an integer greater than or equal to 0 and less than or equal to (K−1), K is the number of consecutive retransmissions, and rv4 is a redundancy version of a transport block for transmission on the at least one of the carriers on a transmission slot i.

In a possible implementation, the second transmitting module 222 is specifically configured to:
determine an index of a code block group for transmission on the at least one of the carriers according to the number of code block groups included in the transport block and the number of the carriers;
for any one of K transmission slots, transmit at least one code block group of the transport block on the at least one of the carriers according to the redundancy version of the transport block for transmission on the at least one of the carriers and the index of the code block group.

In a possible implementation, the number of code block groups included in the transport block is a smaller one of a real number of code blocks in the transport block and a maximum number of code block groups in the transport block permitted by a protocol.

In a possible implementation, the index of the code block group for transmission on the at least one of the carriers satisfies a fifth preset condition.

In a possible implementation, the fifth preset condition includes at least one of:
when M is greater than N, n∈{0, 1, . . . , T₁−1}, an index of a code block group for transmission on carrier n is (n*N₁+k₁), k₁=0, 1, . . . , N₁−1; when n∈{T₁, T₁+1, . . . , N−1}, an index of a code block group for transmission on carrier n is (T₁*N₁+(n−T₁)N₂+k₂), k₂=0, 1, . . . , N₂−1, where n is greater than or equal to 0 and less than or equal to N−1; and/or,
when M is less than or equal to the N, the index of the code block group transmitted on carrier n is n, and n is greater than or equal to 0 and less than M;
where M is the number of code block groups included in the transport block, M is a positive integer greater than or equal to 1, N is the number of the carriers, and N is a positive integer greater than or equal to 2, T₁=M mod N, N₁=[M/N], N₂=[M/N], [M/N] represents a ceil of M/N, and [M/N] represents a floor of M/N.

In a possible implementation, the transmitting apparatus further includes a transceiving module configured to:
acquire a redundancy version identifier corresponding to a first carrier of the at least one of the carriers, and determine the redundancy version of the transport block for transmission on the at least one of the carriers according to the redundancy version identifier corresponding to the first carrier, the number of consecutive retransmissions and the transmission mode; and/or,
acquire a redundancy version identifier corresponding to the at least one of the carriers, and determine the redundancy version of the transport block for transmission on the at least one of the carriers according to the redundancy version identifier corresponding to the at least one of the carriers.

In a possible implementation, the transmitting apparatus further includes a transceiving module configured to:
receive first downlink resource control information on the first carrier, and acquire the redundancy version identifier corresponding to the first carrier according to the first downlink resource control information; and/or,
the transmitting apparatus further includes a transceiving module configured to:
receive second downlink resource control information on the at least one of the carriers, and acquire the redundancy version identifier corresponding to the at least one of the carriers according to the second downlink resource control information.

In a possible implementation, the transceiving module is configured to:
receive second radio resource control signaling; and
acquire the number of consecutive retransmissions according to the second radio resource control signaling.

In a possible implementation, the second radio resource control signaling includes an aggregation factor, and the number of consecutive retransmissions is the number of times indicated by the aggregation factor; and/or,
the second radio resource control signaling does not include the aggregation factor, and the number of consecutive retransmissions is 1.

The transmitting apparatus provided by the embodiments of the present application can perform the technical solution shown by the embodiments of the above-mentioned method, and the implementation principles and advantageous effects thereof are similar and will not be described in detail herein.

FIG. 23 is a schematic structural diagram showing a transmitting apparatus provided by an embodiment of the present application, and as shown in FIG. 23, the transmitting apparatus 230 includes:
a transmitting module 231, configured to transmit a transport block on a carrier according to a transmission mode of the transport block in response to the carrier satisfying a preset condition.

In a possible implementation, the preset condition includes:
the number of carriers being at least two; and/or,
carriers being carries in the same logical cell.

In a possible implementation, the transmitting module 231 is specifically configured to: transmit the transport block on the carriers according to a redundancy version of the transport block for transmission on at least one of the carriers, the number of consecutive retransmissions of the transport block and the transmission mode.

In a possible implementation, for any transmission slot, the redundancy version satisfies at least one of:
the transmission mode being a complete transmission mode, the number of consecutive retransmissions being 1, and redundancy versions of the transport block for transmission on the at least one of the carriers being different;
the transmission mode being the complete transmission mode, the number of consecutive retransmissions being 1, and the redundancy versions of the transport block for transmission on the at least one of the carriers being the same;
the transmission mode being the complete transmission mode, the number of consecutive retransmissions being greater than 1, and the redundancy versions of the transport block for transmission on the at least one of the carriers being different; and the transmission mode being a distributed transmission mode, and the redundancy versions of the transport block for transmission on the at least one of the carriers being the same.

In a possible implementation, the transmission mode is the complete transmission mode, the number of consecutive retransmissions is 1, and the redundancy version of the transport block for transmission on the at least one of the carriers satisfies a first preset condition.

In a possible implementation, the first preset condition includes at least one of:
rv_{id}=0, if n mod 4=0, then rv1 is 0; if n mod 4=1, then the rv1 is 2; if n mod 4=2, then the rv1 is 3, and if n mod 4=3, then the rv1 is 1;
rv_{id}=2, if n mod 4=0, then the rv1 is 2; if n mod 4=1, then the rv1 is 3; if n mod 4=2, then the rv1 is 1, and if n mod 4=3, then the rv1 is 0;
rv_{id}=3, if n mod 4=0, then the rv1 is 3; if n mod 4=1, then the rv1 is 1; if n mod 4=2, then the rv1 is 0, and if n mod 4=3, then the rv1 is 2; and
rv_{id}=1, if n mod 4=0, then the rv1 is 1; if n mod 4=1, then the rv1 is 0; if n mod 4=2, then the rv1 is 2, and if n mod 4=3, then the rv1 is 3;
where rv_{id} is a redundancy version identifier of a first carrier of the at least one of the carriers, mod is a modulo operation, n is an integer greater than or equal to 0 and less than or equal to N−1, N is the number of the carriers, and rv1 is a redundancy version of the transport block for transmission on carrier n.

In a possible implementation, the first preset condition is that redundancy versions for transmission on the at least one of the carriers are the same.

In a possible implementation, the transmitting module 231 is specifically configured to:
transmit the transport block on each carrier according to the redundancy version of the transport block for transmission on the at least one of the carriers.

In a possible implementation, the transmission mode is the complete transmission mode, the number of consecutive retransmissions K is greater than 1, and the number of the carriers N is greater than or equal to K; the redundancy version of the transport block for transmission on the at least one of the carriers satisfies a second preset condition.

In a possible implementation, the second preset condition includes at least one of:
rv_{id}=0, if (n mod K) mod 4=0, then rv2 is 0; if (n mod K) mod 4=1, then rv2 is 2; if (n mod K) mod 4=2, then the rv2 is 3, and (n mod K) mod 4=3, then the rv2 is 1;
rv_{id}=2, if (n mod K) mod 4=0, then the rv2 is 2; if (n mod K) mod 4=1, then rv2 is 3; if (n mod K) mod 4=2, then the rv2 is 1, and if (n mod K) mod 4=3, then the rv2 is 0;
rv_{id}=3, if (n mod K) mod 4=0, then the rv2 is 3; if (n mod K) mod 4=1, then rv2 is 1; if (n mod K) mod 4=2, then the rv2 is 0, and if (n mod K) mod 4=3, then the rv2 is 2; and
rv_{id}=1, if (n mod K) mod 4=0, then the rv2 is 1; if (n mod K) mod 4=1, then rv2 is 0; if (n mod K) mod 4=2, then the rv2 is 2, and if (n mod K) mod 4, then the rv2 is 3;
where rv_{id} is a redundancy version identifier of a first carrier of the at least one of the carriers, mod is a modulo operation, and rv2 is a redundancy version of the transport block for transmission on carrier n;
n is an integer greater than or equal to 0 and less than or equal to N−1, or n is an integer greater than or equal to 0 and less than or equal to K−1.

In a possible implementation, the transmitting module 231 is specifically configured to:
transmit the transport block on first K carriers according to redundancy versions of the transport block for transmission on the first K carriers; or,
transmit the transport block on the N carriers according to redundancy versions of the transport block for transmission on the N carriers.

In a possible implementation, the transmission mode is the complete transmission mode, the number of consecutive retransmissions K is greater than 1, the number of the carriers N is less than K, and the redundancy version of the transport block for transmission on the at least one of the carriers and a transmission slot i satisfy a third preset condition.

In a possible implementation, the third preset condition includes at least one of:
rv_{id}=0, if (n+i*N) mod 4=0, then rv3 is 0; if (n+i*N) mod 4=1, then the rv3 is 2; if (n+i*N) mod 4=2, then the rv3 is 3, and (n+i*N) mod 4=3, then the rv3 is 1;
rv_{id}=2, if (n+i*N) mod 4=0, then the rv3 is 2; if (n+i*N) mod 4=1, then rv3 is 3; if (n+i*N) mod 4=2, then the rv3 is 1, and if (n+i*N) mod 4=3, then the rv3 is 0;
rv_{id}=3, if (n+i*N) mod 4=0, then rv3 is 3; if (n+i*N) mod 4=1, then the rv3 is 1; if (n+i*N) mod 4=2, then the rv3 is 0, and if (n+i*N) mod 4=3, then the rv3 is 2; and
rv_{id}=1, if (n+i*N) mod 4=0, then the rv3 is 1; if (n+i*N) mod 4=1, then rv3 is 0; if (n+i*N) mod 4=2, then the rv3 is 2, and if n (n+i*N) mod 4=3, then the rv3 is 3;
where rv_{id} is a redundancy version identifier of a first carrier of the at least one of the carriers, mod is a modulo operation, n is an integer greater than or equal to 0 and less than or equal to N−1, N is the number of the carriers, and rv3 is a redundancy version of the transport block for transmission on carrier n in a transmission slot i;
when i is greater than or equal to 0 and less than or equal to (([K/N]−1), n is an integer greater than or equal to 0 and less than or equal to N−1; when i is equal to [K/N], n is an integer greater than or equal to 0 and less than or equal to N−1, or n is an integer greater than or equal to 0 and less than or equal to (K−[K/N]*N−1), [K/N] represents a ceil of K/N, [K/N] represents a floor of K/N.

In a possible implementation, the transmitting module 231 is specifically configured to:
for any one of [K/N] transmission slots, transmit the transport block on the N carriers according to the redundancy version of the transport block for transmission on the at least one of the carriers in the transmission slot; or,
for any one of first ([K/N]−1 transmission slots, transmit the transport block on the N carriers according to the redundancy version of the transport block for transmission on the at least one of the carriers in the transmission slot; for a ([K/N])-th transmission slot, transmit the transport block on first (K−[K/N]*N) carriers according to redundancy versions of the transport block for the transmission on the first (K−[K/N]*N) carriers in the transmission slot.

In a possible implementation, the transmission mode is the distributed transmission mode; the redundancy version of the transport block for transmission on the at least one of the carriers and a transmission slot i satisfy a fourth preset condition.

In a possible implementation, the fourth preset condition includes at least one of:
rv_{id}=0, if i mod 4=0, then rv4 is 0; if i mod 4=1, then the rv4 is 2; if i mod 4=2, then the rv4 is 3, and if i mod 4=3, then the rv4 is 1;
rv_{id}=2, if i mod 4=0, then the rv4 is 2; if i mod 4=1, then the rv4 is 3; if i mod 4=2, then the rv4 is 1, and if i mod 4=3, then the rv4 is 0;
rv_{id}=3, if i mod 4=0, then the rv4 is 3; if i mod 4=1, then the rv4 is 1; if i mod 4=2, then the rv4 is 0, and if i mod 4=3, then the rv4 is 2; and
rv_{id}=1, if i mod 4=0, then the rv4 is 1; if i mod 4=1, then the rv4 is 0; if i mod 4=2, then the rv4 is 2, and if i mod 4=3, then the rv4 is 3;
where rv_{id} is a redundancy version identifier of a first carrier of the at least one of the carriers, mod is a modulo operation, i is an integer greater than or equal to 0 and less than or equal to (K−1), K is the number of consecutive retransmissions, and rv4 is a redundancy version of a transport block for transmission on the at least one of the carriers on a transmission slot i.

In a possible implementation, the transmitting module 231 is specifically configured to:
determine an index of a code block group for transmission on the at least one of the carriers according to the number of code block groups included in the transport block and the number of the carriers;
for any one of K transmission slots, transmit at least one code block group of the transport block on the at least one of the carriers according to the redundancy version of the transport block for transmission on the at least one of the carriers and the index of the code block group.

In a possible implementation, the number of code block groups included in the transport block is a smaller one of a real number of code blocks in the transport block and a maximum number of code block groups in the transport block permitted by a protocol.

In a possible implementation, the index of the code block group for transmission on the at least one of the carriers satisfies a fifth preset condition.

In a possible implementation, the fifth preset condition includes at least one of:
when M is greater than N, n∈{0, 1, . . . , T₁−1}, an index of a code block group for transmission on carrier n is (n*N₁+k₁), k₁=0, 1, . . . , N₁−1; when n∈{T₁, T₁+1, . . . , N−1}, an index of a code block group for transmission on carrier n is (T₁*N₁+(n−T₁)N₂+k₂), k₂=0, 1, . . . , N₂−1, where n is greater than or equal to 0 and less than or equal to N−1; and/or,
when M is less than or equal to the N, the index of the code block group transmitted on carrier n is n, and n is greater than or equal to 0 and less than M;
where M is the number of code block groups included in the transport block, M is a positive integer greater than or equal to 1, N is the number of the carriers, and N is a positive integer greater than or equal to 2, T₁=M mod N, N₁=[M/N], N₂=[M/N], [M/N] represents a ceil of M/N, and [M/N] represents a floor of M/N.

In a possible implementation, the transmitting module 231 is further configured to:
transmit a redundancy version identifier, where the redundancy version identifier is configured to indicating the redundancy version.

In a possible implementation, the transmitting module 231 is further configured to:
transmit first downlink resource control information on a first carrier of the at least one of the carriers, where the first downlink resource control information includes a redundancy version identifier corresponding to the first carrier; and/or,
transmit second downlink resource control information on the at least one of the carriers, where the second downlink resource control information includes a redundancy version identifier corresponding to the at least one of the carriers.

In a possible implementation, the transmitting module 231 is further configured to:
transmit a transmission mode indication parameter, where the transmission mode indication parameter is used for indicating the transmission mode.

In a possible implementation, the transmission mode indication parameter is carried in a system message; and/or,
the transmission mode indication parameter is carried in first radio resource control signaling.

In a possible implementation, the transmitting module 231 is further configured to: transmit second radio resource control signaling.

In a possible implementation, the second radio resource control signaling includes an aggregation factor, and the number of consecutive retransmissions is the number of times indicated by the aggregation factor; and/or,
the second radio resource control signaling does not include the aggregation factor, and the number of consecutive retransmissions is 1.

The transmitting apparatus provided by the embodiments of the present application can perform the technical solution shown by the embodiments of the above-mentioned method, and the implementation principles and advantageous effects thereof are similar and will not be described in detail herein.

FIG. 24 is a schematic structural diagram showing a communication device according to an embodiment of the present application. As shown in FIG. 24, the communication device 240 described in the present embodiment may be a terminal device (or a component usable for a terminal device) or a network device (or a component usable for a network device) mentioned in the aforementioned method embodiments. The communication device 240 may be configured to implement a method corresponding to the terminal device or the network device as described in the above method embodiments, reference may be made to the description of the above method embodiments for details.

The communication device 240 may include one or more processors 241 (which may also be referred to as processing units) that may realize certain control or processing functions. The processor 241 may be a general-purpose processor or a special purpose processor and the like. It may be, for example, a baseband processor, or a central processor. The baseband processor may be configured to process communication protocols and communication data, and the central processor may be configured to control the communication device, execute software programs, and process data for the software programs.

In a possible implementation, the processor 241 may also store instructions 243 or data (e.g., intermediate data). In a possible implementation, the instructions 243 may be executed by the processor 241 to cause the communication device 240 to perform a method corresponding to a terminal device or a network device as described in the above method embodiments.

In a possible implementation, the communication device 240 may include circuitry that may perform the functions of transmitting or receiving or communicating in the foregoing method embodiments.

In a possible implementation, the communication device 240 may include one or more memories 242 having stored thereon instructions 244 that may be executed on the processor 241 to cause the communication device 240 to perform the methods described in the above method embodiments.

In a possible implementation, data may be stored in the memory 242. The processor 241 and the memory 242 may be provided separately or integrated together.

In a possible implementation, the communication device 240 may also include a transceiver 245 and/or an antenna 246. The processor 241, which may be referred to as a processing unit, controls the communication device 240 (either a terminal device or a core network device or a radio access network device). The transceiver 245 may be referred to as a transceiving unit, transceiver, transceiving circuit, or transceiver and the like, for implementing the transceiving functions of the communication device 240.

In a possible implementation, the processor 241 and the transceiver 245 may be implemented as described above with respect to the various embodiments and will not be described in detail herein.

In a possible implementation, if the communication device 240 is configured to implement operations corresponding to the network device in the various embodiments described above, for example, the transport block may be transmitted on the carrier by the transceiver 245 according to the transmission mode of the transport block in response to the carrier satisfying a preset condition.

In a possible implementation, the processor 241 and the transceiver 245 may be implemented as described above with respect to the various embodiments and will not be described in detail herein.

The processor 241 and the transceiver 245 described in the present application may be implemented on an IC (Integrated Circuit), an analog integrated circuit, an RFIC (Radio Frequency Integrated Circuit), a mixed signal integrated circuit, an ASIC (Application Specific Integrated Circuit), a PCB (Printed Circuit Board), an electronic device and the like. The processor 241 and the transceiver 245 may also be fabricated using various integrated circuit processing techniques, such as CMOS (Complementary Metal Oxide Semiconductor), NMOS (N Metal-Oxide-Semiconductor), PMOS (Positive Channel Metal Oxide Semiconductor), BJT (Bipolar Junction Transistor), BiCMOS (bipolar CMOS), silicon germanium (SiGe), gallium arsenide (GaAs) and the like.

In the present application, the communication device can be a terminal device or a network device (such as a base station), which may need to be determined according to the context; in addition, the terminal device can be implemented in various forms. For example, the terminal devices described in the present application may include mobile terminals such as a cell phone, tablet PC, notebook computer, palmtop, personal digital assistant (PDA), portable media player (PMP), navigation apparatus, wearable device, smart bracelet, pedometer and the like and fixed terminals such as a digital TV, a desktop computer and the like.

Although in the above embodiment description, the communication device is described by taking a terminal device or a network device as an example, the scope of the communication device described in the present application is not limited to the above terminal device or network device, and the structure of the communication device may not be limited by FIG. 24. The communication device may be a stand-alone device or may be part of a larger device.

An embodiment of the present application also provides a communication system including: the terminal device as described in any one of the above method embodiments; and a network device as described in any of the method embodiments above.

An embodiment of the present application also provides a terminal device including: a memory, a processor; where a computer program is stored on the memory, and when the computer program is executed by a processor, the steps of the transmission methods in any of the embodiments described above are implemented.

An embodiment of the present application also provides a network device including: a memory, a processor; where a computer program is stored on the memory, and when the computer program is executed by a processor, the steps of the transmission methods in any of the embodiments described above are implemented.

An embodiment of the present application also provides a computer-readable storage medium having stored thereon a computer program, when the computer program is executed by a processor, the steps of the transmission methods in any of the embodiments described above are implemented.

In the embodiments of the terminal device, the network device and the computer-readable storage medium provided in the embodiments of the present application, all the technical features of any one of the above-mentioned transmission method embodiments can be contained, and the extensions and explanations in the description are substantially the same as the various embodiments of the above-mentioned method, and will not be described again.

An embodiment of the present application also provides a computer program product including computer program codes which, when run on a computer, cause the computer to perform the methods of the various possible implementations described above.

An embodiment of the present application also provides a chip including a memory for storing a computer program and a processor for invoking and running the computer program from the memory such that the device on which the chip is mounted performs the method as in the various possible implementations above.

It is to be understood that the above-mentioned scenarios are merely examples and do not constitute a limitation on the application scenarios of the technical solutions provided by the embodiments of the present application, and the technical solutions of the present application can also be applied to other scenarios. For example, it can be seen by a person skilled in the art that, with the evolution of a system architecture and the appearance of a new traffic scenario, the technical solutions provided by the embodiments of the present application are also applicable to similar technical problems.

The above-mentioned serial numbers in the embodiments of the present application are merely for the purpose of description and do not represent the advantages and disadvantages of the embodiments.

The steps in the methods of the embodiments of the present application can be sequentially adjusted, combined and deleted according to actual needs.

The units in the device in the embodiments of the present application can be combined, divided and deleted according to actual needs.

In the present application, for the description of the same or similar term concept, technical solution and/or application scenario, a detailed description is generally provided only when it appears for the first time, and when it appears again later, for the sake of brevity, a detailed description is not generally provided again. In understanding the content of the technical solution of the present application and the like, for the description of the same or similar term concept, technical solution and/or application scenario which is not described in detail later, reference can be made to the relevant detailed description prior thereto.

In the present application, various embodiments are described with emphasis, for those that are not specifically illustrated or described in certain embodiments, reference can be made to the description of other embodiments.

Technical features of the technical solutions of the present application can be combined in any combination, and in order to make the description concise, not all the possible combinations of the technical features in the above-mentioned embodiments are described; however, as long as there is no contradiction in the combinations of these technical features, they should be considered as within the scope of the present application.

From the description of the embodiments given above, it will be clear to a person skilled in the art that the methods of the embodiments described above can be implemented by means of software plus a necessary general hardware platform, but of course also by means of hardware, but in many cases the former is a better implementation. Based on such an understanding, the technical solution of the present application, in essence or in a contribution to the prior art, can be embodied in the form of a software product, where the computer software product is stored in a storage medium as above (such as a ROM/RAM, a magnetic disk, an optical disk), and includes a plurality of instructions for enabling a terminal device (which can be a mobile phone, a computer, a server, a controlled terminal, or a network device) to execute the method of each embodiment of the present application.

The embodiments described above may be implemented in whole or in part by software, hardware, firmware, or any combination thereof. When implemented in software, it may be implemented in whole or in part as a computer program product. The computer program product includes one or more computer instructions. When the computer program instructions are loaded and executed on a computer, the processes or functions according to embodiments of the present application are generated in whole or in part. The computer may be a general-purpose computer, a special purpose computer, a computer network, or other programmable apparatuses. The computer instructions may be stored in a computer-readable storage medium or transmitted from one computer-readable storage medium to another computer-readable storage medium. For example, the computer instructions may be transmitted from one website, computer, server, or data center to another website, computer, server, or data center by wire (e.g., coaxial cable, optical fiber, and digital subscriber line) or wirelessly (e.g., infrared, wireless, microwave and the like). A computer-readable storage medium can be any available medium that can be accessed by a computer or a data storage device including one or more available mediums integrated into a server, data center, and the like. The available medium may be a magnetic medium (e.g., floppy disk, storage disk, magnetic tape), optical medium (e.g., DVD), or semiconductor medium (e.g., Solid State Disk (SSD)) and the like.

The above-mentioned embodiments are merely preferred embodiments of the present application, and do not limit the scope of the patent of the present application. Any equivalent structural or process changes made by using the contents of the description and the drawings of the present application, or directly or indirectly used in other relevant technical fields, are also included in the protection scope of the patent of the present application.

What is claimed is:

1. A transmission method, comprising steps of:
receiving second downlink resource control information on at least one of N carriers, wherein N is a positive integer greater than or equal to 2;
determining, according to the second downlink resource control information, a redundancy version of a transport block to be transmitted on the at least one carrier.

2. The method according to claim 1, further comprising:
transmitting the transport block according to the redundancy version of the transport block transmitted on the at least one carrier.

3. The method according to claim 2, wherein transmitting the transport block according to the redundancy version of the transport block transmitted on the at least one carrier comprises:
performing K transmissions of the transport block on the at least one carrier according to redundancy versions of the transport block in R transmission slots on the at least one carrier, wherein R is determined based on K, and K is a number of consecutive retransmissions of the transport block.

4. The method according to claim 3, further comprising:
receiving second radio resource control signaling;
acquiring the number of consecutive retransmissions K according to the second radio resource control signaling.

5. The method according to claim 4, wherein
if the second radio resource control signaling comprises an aggregation factor, the number of consecutive retransmissions K is a number of times indicated by the aggregation factor; and/or,
if the second radio resource control signaling does not comprise an aggregation factor, the number of consecutive retransmissions K is 1.

6. The method according to claim 3, wherein when the transport block is completely transmitted on each of the N carriers, the number of consecutive retransmissions K is greater than 1, and the number of the carriers N is less than K, the redundancy version of the transport block transmitted on the at least one carrier and a transmission slot i satisfy a third preset condition.

7. The method according to claim 3, wherein
a redundancy version of the transport block in remaining R−1 transmission slots of the R transmission slots is determined by a redundancy version of the transport block in a first transmission slot among the R transmission slots.

8. A transmission method, comprising:
sending second downlink resource control information on at least one of N carriers, wherein N is a positive integer greater than or equal to 2, and the second downlink resource control information is used for determining a redundancy version of a transport block for transmission on the at least one carrier.

9. The method according to claim 8, further comprising:
transmitting the transport block according to the redundancy version of the transport block for transmission on the at least one carrier.

10. The method according to claim 9, wherein transmitting the transport block according to the redundancy version of the transport block for transmission on the at least one carrier comprises:
performing K transmissions of the transport block on the at least one carrier according to redundancy versions of the transport block in R transmission slots on the at least one carrier, wherein R is determined based on K, and K is a number of consecutive retransmissions of the transport block.

11. The method according to claim 10, further comprising:
transmitting second radio resource control signaling, wherein the second radio resource control signaling is used for indicating the number of consecutive retransmissions K.

12. The method according to claim 11, wherein
if the second radio resource control signaling comprises an aggregation factor, the number of consecutive retransmissions K is a number of times indicated by the aggregation factor; and/or,
if the second radio resource control signaling does not comprise an aggregation factor, the number of consecutive retransmissions K is 1.

13. The method according to claim 10, wherein when the transport block is completely transmitted on each of the N carriers, the number of consecutive retransmissions K is greater than 1, and the number of the carriers N is less than K, the redundancy version of the transport block transmitted on the at least one carrier and a transmission slot i satisfy a third preset condition.

14. The method according to claim 10, wherein
a redundancy version of the transport block in remaining R−1 transmission slots of the R transmission slots is determined by a redundancy version of the transport block in a first transmission slot among the R transmission slots.

15. A communication device, comprising: a memory and a processor;
wherein the memory is configured to store program instructions; and
the processor is configured to call the program instructions in the memory to:
control an input interface to receive second downlink resource control information on at least one of N carriers, wherein N is a positive integer greater than or equal to 2;
determine a redundancy version of a transport block for transmission on the at least one carrier according to the second downlink resource control information.

16. A non-transitory computer-readable storage medium having a computer program stored thereon, wherein when the computer program is executed, the method according to claim 1 is implemented.

17. A non-transitory computer-readable storage medium having a computer program stored thereon, wherein when the computer program is executed, the method according to claim 8 is implemented.
